(19) United States
(12) Patent Application Publication
(10) Pub. No.: US 2026/0330395 A1
(43) Pub. Date: Oct. 22, 2026

(54) MANAGEMENT SYSTEM, MANAGEMENT DEVICE, AND MANAGEMENT METHOD

(71) Applicant: HONDA MOTOR CO., LTD., MINATO-KU, TOKYO (JP)

(72) Inventor: Kentaro HAYASHI, MINATO-KU, TOKYO (JP)

(21) Appl. No.: 19/104,409

(22) PCT Filed: Sep. 27, 2023
(86) PCT No.: PCT/JP2023/035141

§ 371 Date: Feb. 18, 2025

(30) Foreign Application Priority Data
Sep. 29, 2022 (JP) 2022-155660

(51) Int. Cl. G06Q 10/083

(52) U.S. Cl. CPC G06Q 10/083

(57) ABSTRACT

A management system includes a management device; a mobile terminal carried by a user; and a terminal device carried by a delivery person. The management system further comprises: a position information acquisition unit which is provided to the management device and which acquires delivery person position information; an information generation unit that generates delivery person information, which is information regarding a delivery person who can deliver a mobile battery to the user, on the basis of user position and the delivery person position; and an information provision unit which is provided to the mobile terminal and which provides the delivery person information to the user.

### TECHNICAL FIELD

The present invention relates to a management system, a management device, and a management method.

### BACKGROUND ART

In JP 2016-012291 A, a moving body sharing system is disclosed that includes a plurality of bicycles that are available for sharing, a plurality of bicycle parking areas in which a predetermined number of the bicycles can be accommodated, and respective management devices that are installed in each of the bicycle parking areas.

### SUMMARY OF THE INVENTION

In recent times, there has been a demand for a technology that is capable of satisfactorily managing mobile batteries that are shared by a plurality of users.

The present invention has the object of solving the aforementioned problem.

A first aspect of the present invention is characterized by a management system that manages a delivery of a mobile battery configured to be shared by a plurality of users, including a management device, a mobile terminal configured to communicate with the management device and be possessed by each of the users, and a terminal device configured to communicate with the management device and be possessed by a delivery person who carries out the delivery of the mobile battery, wherein the management system includes a position information acquisition unit provided in the management device and configured to acquire delivery person position information which is information indicating a delivery person position which is a position of the delivery person, an information generating unit configured to generate, based on a user position which is a position of at least one of the users, and the delivery person position, delivery person information, which is information concerning the delivery person who is capable of carrying out the delivery of the mobile battery to the one of the users, and an information providing unit provided in the mobile terminal and configured to provide to the one of the users the delivery person information generated by the information generating unit.

A second aspect of the present invention is characterized by a management device configured to manage a delivery of a mobile battery configured to be shared by a plurality of users, the management device including a position information acquisition unit configured to acquire user position information which is information indicating a user position which is a position of at least one of the users, and delivery person position information which is information indicating a delivery person position which is a position of a delivery person who carries out the delivery of the mobile battery, an information generating unit configured to generate, based on the user position information and the delivery person position information, delivery person information, which is information concerning the delivery person who is capable of carrying out the delivery of the mobile battery to the one of the users, and a communication unit configured to communicate with a mobile terminal possessed by each of the users, and communicate with a terminal device possessed by the delivery person, wherein the communication unit transmits to the mobile terminal the delivery person information generated by the information generating unit.

A third aspect of the present invention is characterized by a management method of managing a delivery of a mobile battery configured to be shared by a plurality of users, the management method including a step of acquiring delivery person position information which is information indicating a delivery person position which is a position of a delivery person who carries out the delivery of the mobile battery, a step of generating, based on information indicating a user position which is a position of at least one of the users, and the delivery person position information, delivery person information, which is information concerning the delivery person who is capable of carrying out the delivery of the mobile battery to the one of the users, and a step of providing the delivery person information to the one of the users using a mobile terminal possessed by the one of the users.

According to the present invention, a mobile battery or mobile batteries that are shared by a plurality of users can be satisfactorily managed.

### BRIEF DESCRIPTION OF THE DRAWINGS

FIG. 1 is a block diagram illustrating a sharing system according to an embodiment;

FIG. 2 is a block diagram illustrating an example of a mobile battery;

FIG. 3 is a block diagram illustrating an example of a user terminal;

FIG. 4 is a block diagram illustrating an example of a collection and delivery person terminal;

FIG. 5 is a block diagram illustrating an example of a management device;

FIG. 6 is a flowchart illustrating an example of operations of a management system;

FIG. 7 is a flowchart illustrating an example of operations of the management system;

FIG. 8 is a diagram illustrating an example of a display on a display unit of the user terminal;

FIG. 9 is a diagram illustrating an example of a display on the display unit of the user terminal;

FIG. 10 is a flowchart illustrating an example of operations of the management system;

FIG. 11 is a diagram illustrating an example of a display on a display unit of the collection and delivery person terminal;

FIG. 12 is a flowchart illustrating an example of operations of the management system;

FIG. 13 is a diagram illustrating an example of a display on the display unit of the collection and delivery person terminal;

FIG. 14 is a flowchart illustrating an example of operations of the management system;

FIG. 15 is a flowchart illustrating an example of operations of the management system;

FIG. 16 is a diagram illustrating an example of a display on the display unit of the user terminal;

FIG. 17 is a flowchart illustrating an example of operations of the management system;

FIG. 18 is a diagram illustrating an example of a display on the display unit of the collection and delivery person terminal;

FIG. 19 is a flowchart illustrating an example of operations of the management system;

FIG. 20 is a diagram illustrating an example of a display on the display unit of the collection and delivery person terminal;

FIG. 21 is a flowchart illustrating an example of operations of the management system;

FIG. 22 is a diagram illustrating an example of a display on the display unit of the user terminal;

FIG. 23 is a flowchart illustrating an example of operations of the management system;

FIG. 24 is a flowchart illustrating an example of operations of the management system;

FIG. 25 is a flowchart illustrating an example of operations of the management system;

FIG. 26 is a diagram illustrating an example of a display on the display unit of the user terminal;

FIG. 27 is a flowchart illustrating an example of operations of the management system;

FIG. 28 is a diagram illustrating an example of a display on the display unit of the user terminal;

FIG. 29 is a flowchart illustrating an example of operations of the management system;

FIG. 30 is a flowchart illustrating an example of operations of the management system;

FIG. 31 is a flowchart illustrating an example of operations of the management system;

FIG. 32 is a flowchart illustrating an example of operations of the management system;

FIG. 33 is a diagram illustrating a flow of people arriving within a predetermined region, and installation positions of battery holders;

FIG. 34 is a flowchart illustrating an example of operations of the management system;

FIG. 35 is a flowchart illustrating an example of operations of the management system;

FIG. 36 is a flowchart illustrating an example of operations of the management system;

FIG. 37 is a block diagram showing a user terminal according to an exemplary modification 1; and

FIG. 38 is a block diagram showing a collection and delivery person terminal according to an exemplary modification 2.

### DESCRIPTION OF THE INVENTION

### Embodiment

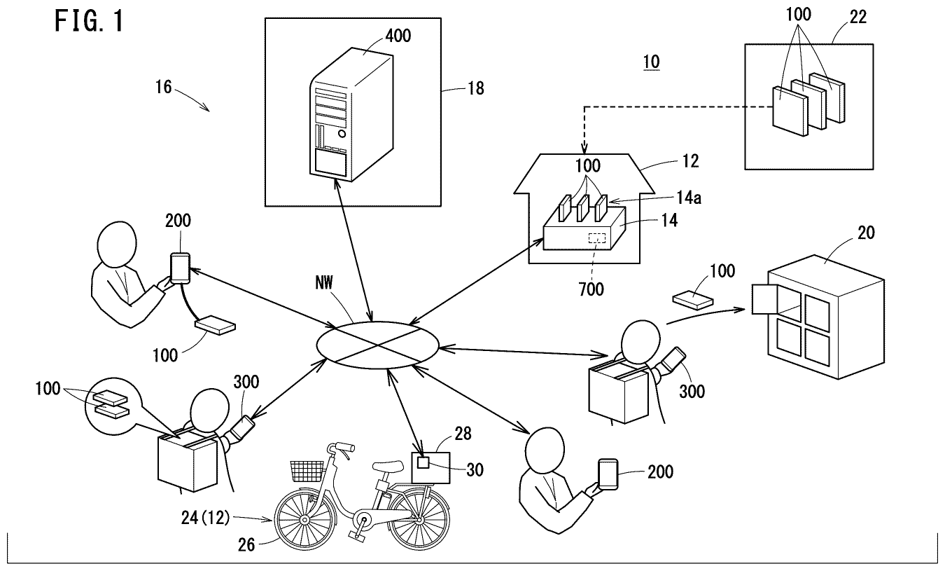

FIG. 1 is a configuration diagram of a sharing system 10 according to an embodiment.

The sharing system 10 is a system for the purpose of sharing a mobile battery or batteries 100 that is or are used by a plurality of users. The sharing system 10 may include a battery station 12. Moreover, it should be noted that a person who has completed a user registration process, which will be described later, may be considered a user according to the present embodiment, although the present invention is not necessarily limited to this feature.

The battery station 12 is a facility in which a plurality of mobile batteries 100 are capable of being placed. The battery station 12 is installed, for example, by an operating business entity that operates the sharing system 10. A plurality of the battery stations 12 may be installed throughout a city. Stated otherwise, the sharing system 10 may include a plurality of the battery stations 12. A user can rent the mobile battery or batteries 100 that are placed in the battery station 12. Further, by placing the mobile battery or batteries 100 in the battery station 12, the user is capable of returning the rented mobile battery or batteries 100 to the aforementioned operating business entity. The battery station 12 may be installed in commercial facilities, stores and the like within the city, although the present invention is not necessarily limited to this feature.

A charger (charging equipment, a charging device) 14 may be provided in the battery station 12. The charger 14 is capable of charging the mobile battery or batteries 100. A battery port 14a may be provided in the charger 14. The number of the battery ports 14a may be one battery port, or may be a plurality of battery ports. The mobile battery or batteries 100 may be placed in the battery ports 14a. The charger 14 is capable of charging the mobile battery or batteries 100 that are placed in the battery ports 14a. In the battery station 12, there may further be provided a non-illustrated control computer. The control computer, for example, is equipped with the charger 14. The control computer includes a processor, a memory, an input/output interface, and the like. Further, the control computer is also connected to a network NW. The network NW, for example, is a communication network such as the Internet or the like. The control computer may communicate with a management device 400, which will be described later. Furthermore, the control computer is capable of acquiring battery information from the mobile battery or batteries 100 that are placed in the battery station 12 in which the control computer is provided.

Identification information for identifying the mobile battery or batteries 100 may be included in the battery information. Further, information indicating an SoC (State of Charge) of the mobile battery or batteries 100 may be included in the battery information. More specifically, in the battery information, there may be included information indicating a residual capacity of the mobile battery or batteries 100. The control computer of the battery station 12 is capable of transmitting the battery information that was acquired to the management device 400, which will be described later.

The operating business entity of the sharing system 10 can collect and deliver, via a collection and delivery person, the mobile battery or batteries 100 with respect to the user. In accordance with this feature, the user is capable of renting from the collection and delivery person the mobile battery or batteries 100 that are placed in the battery station 12. Further, the user, without necessarily visiting the battery station 12, can return the mobile battery or batteries 100 to the collection and delivery person. In the following description, the collection and delivery person who is capable of delivering the mobile battery or batteries 100 to the user is also referred to as a delivery person. In the following description, the collection and delivery person who is capable of collecting the mobile battery or batteries 100 from the user is also referred to as a collection person. The collection person who collects the mobile battery or batteries 100 from the user may return the mobile battery or batteries 100 to the battery station 12, or may deliver the mobile battery or batteries 100, as the delivery person, to another user. Moreover, it should be noted that a person who has completed a collection and delivery registration process, which will be described later, may be considered a collection and delivery person according to the present embodiment, although the present invention is not necessarily limited to this feature.

The sharing system 10 further includes a management system 16. The management system 16 is a system that manages the mobile battery or batteries 100 that are shared by a plurality of users. The management system 16 is a system that is capable of managing the collection and delivery of the mobile battery or batteries 100 that are shared by the plurality of users. More specifically, the management system 16 is capable of managing the delivery of the mobile battery or batteries 100 with respect to the plurality of users, and the collection of the mobile battery or batteries 100 with respect to the plurality of users. A mobile terminal 200, a terminal device 300, and the management device 400 are included in the management system 16. The mobile terminal 200, the terminal device 300, and the management device 400 may be connected to the network NW.

The mobile terminal 200 is a terminal possessed by the user. In the following description, the mobile terminal 200 is also referred to as a user terminal 200. The user terminal 200, for example, is a smart phone. Although the number of the user terminals 200 illustrated in FIG. 1 is two, the number of the user terminals 200 is not necessarily limited to being two. A more detailed description of the user terminal 200 will be given later.

The terminal device 300 is a terminal possessed by the collection and delivery person. In the following description, the terminal device 300 is also referred to as a collection and delivery person terminal 300. The collection and delivery person terminal 300, for example, is a smart phone. Although the number of collection and delivery person terminals 300 shown in FIG. 1 is two, the number of the collection and delivery person terminals 300 is not necessarily limited to being two. A more detailed description of the collection and delivery person terminal 300 will be given later.

The management device 400 is a computer (a server) in order to manage the mobile battery or batteries 100 that are shared by the plurality of users. The management device 400 is provided, for example, in a data center 18 that is managed by an operating business entity that operates the management system 16. The management device 400 is capable of communicating with the user terminal 200 via the network NW. The management device 400 is capable of communicating with the collection and delivery person terminal 300 via the network NW. A more detailed description of the management device 400 will be given later.

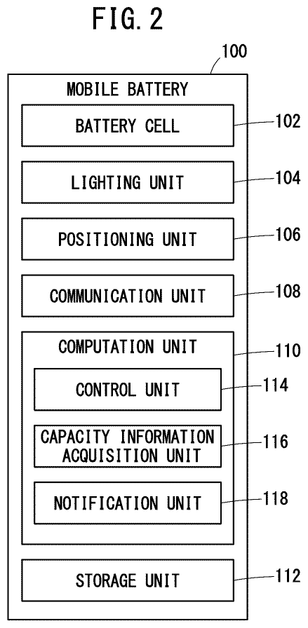

FIG. 2 is a block diagram illustrating an example of the mobile battery or batteries 100.

Each of the mobile batteries 100 is equipped with battery cells (or a battery cell) 102, a lighting unit 104, a positioning unit 106, a communication unit 108, a computation unit 110, and a storage unit (a battery storage unit) 112. The mobile battery or batteries 100 may be equipped with a speaker. A program for causing a management method according to the present embodiment to be executed by a computer may be installed beforehand in the mobile battery or batteries 100. A more detailed description of the management method will be given later.

An electric charge is capable of being stored in the battery cells 102. An amount of the electric charge that is stored in the battery cells 102 is the residual capacity of the mobile battery or batteries 100.

The lighting unit 104, for example, is equipped with an LED (a light emitting diode) lamp. By emitting light, the lighting unit 104 is capable of allowing people in the surrounding vicinity of the mobile battery or batteries 100 to recognize the position of the mobile battery or batteries 100.

The positioning unit 106 may be equipped with a GNSS (Global Navigation Satellite System) sensor. The GNSS sensor uses a satellite positioning system, and thereby acquires position information indicating a current position of the mobile battery or batteries 100.

The communication unit 108 is constituted, for example, by a communication device for wireless communication. The communication unit 108 is capable of carrying out wireless communications via the network NW. The communication unit 108 may also carry out communications using a wireless LAN (a Local Area Network). Further, the communication unit 108 may also carry out communications (short-range communications) using the Bluetooth (registered trademark) standard. The communication unit 108 is capable of communicating with the user terminal 200, a collection and delivery person terminal 300, and the management device 400. Further, the communication unit 108 is also capable of communicating with the control computer of the battery station 12.

The computation unit 110 may be constituted by a processor such as a CPU (Central Processing Unit), a GPU (Graphics Processing Unit), or the like. More specifically, the computation unit 110 can be constituted by a processing circuitry.

The storage unit 112 may be equipped with a non-illustrated volatile memory and a non-illustrated nonvolatile memory. As an example of the volatile memory, there may be cited a RAM (Random Access Memory) or the like. As an example of the nonvolatile memory, there may be cited a ROM (Read Only Memory), a flash memory, or the like. Data and the like may be stored, for example, in the volatile memory. Programs, tables, maps, and the like may be stored, for example, in the nonvolatile memory. At least a portion of the storage unit 112 may be provided in the aforementioned processor, an integrated circuit, or the like.

The computation unit 110 may be equipped with a control unit 114, a capacity information acquisition unit 116, and a notification unit 118. The control unit 114, the capacity information acquisition unit 116, and the notification unit 118 can be realized by the computation unit 110 executing a program that is stored in the storage unit 112.

Moreover, at least a portion of the control unit 114, the capacity information acquisition unit 116, and the notification unit 118 may be realized by an integrated circuit such as an ASIC (Application Specific Integrated Circuit), or an FPGA (Field Programmable Gate Array) or the like. Furthermore, at least a portion of the control unit 114, the capacity information acquisition unit 116, and the notification unit 118 may be constituted by an electronic circuit including a discrete device.

The control unit 114 governs the overall control of the mobile battery or batteries 100. For example, the control unit 114 supplies the position information acquired by the positioning unit 106 to the management device 400 via the communication unit 108.

The capacity information acquisition unit 116 acquires information indicating the residual capacity of the mobile battery or batteries 100. In the following description, the information indicating the residual capacity of the mobile battery or batteries 100 is also referred to as residual capacity information. The capacity information acquisition unit 116 acquires the residual capacity information based on, for example, the amount of charge that is stored in the battery cells 102. The residual capacity information acquired by the capacity information acquisition unit 116 can be supplied by the control unit 114 to the management device 400 via the communication unit 108. Further, the residual capacity information acquired by the capacity information acquisition unit 116 can be supplied as at least a portion of the battery information to the control computer of the aforementioned battery station 12.

In the case that a user who has a plan to receive the mobile battery or batteries 100 from the delivery person comes into close proximity to the mobile battery or batteries 100, the notification unit 118 controls the lighting unit 104, and thereby causes the lighting unit 104 to emit light. Consequently, the user is capable of recognizing the position of the mobile battery or batteries 100 that he or she is scheduled to receive. On the other hand, by visually confirming the illumination of the lighting unit 104 of the mobile battery or batteries 100 possessed by the delivery person, the delivery person can recognize that the user who is scheduled to receive the mobile battery or batteries 100 is in close proximity. Whether or not a user has come into close proximity to the mobile battery or batteries 100 can be determined based on whether or not the user position which is the position of the user lies within a predetermined range from the position of the mobile battery or batteries 100. The information indicating the user position can be acquired by a later-described position information acquisition unit 412 of the management device 400. In the case that the mobile battery or batteries 100 are equipped with a speaker, the notification unit 118 may cause the speaker to output a voice prompt when the user has come into close proximity to the mobile battery or batteries 100. By hearing the voice prompt output from the speaker, the user is capable of grasping the position of the mobile battery or batteries 100. By hearing the voice prompt output from the speaker, the delivery person can grasp that the user is nearby.

Further, in the case that a collection person who has a plan to collect the mobile battery or batteries 100 comes into close proximity to the mobile battery or batteries 100, the notification unit 118 can control the lighting unit 104, and thereby cause the lighting unit 104 to emit light. By visually confirming the emitted light, the collection person is capable of recognizing the position of the mobile battery or batteries 100 that are to be collected. Further, by visually confirming the emitted light, the user is capable of recognizing that the collection person who is scheduled to collect the mobile battery or batteries 100 is nearby. Whether or not a collection person has come into close proximity to the mobile battery or batteries 100 can be determined based on whether or not the delivery person position which is the position of the delivery person lies within the predetermined range from the position of the mobile battery or batteries 100. The information indicating the delivery person position can be acquired by the later-described position information acquisition unit 412 of the management device 400. In the case that the mobile battery or batteries 100 are equipped with a speaker, the notification unit 118 may cause the speaker to output a voice prompt in the case that the delivery person has come into close proximity to the mobile battery or batteries 100. By hearing the voice prompt output from the speaker, the delivery person is capable of grasping the position of the mobile battery or batteries 100. By hearing the voice prompt output from the speaker, the user can grasp that the delivery person is nearby.

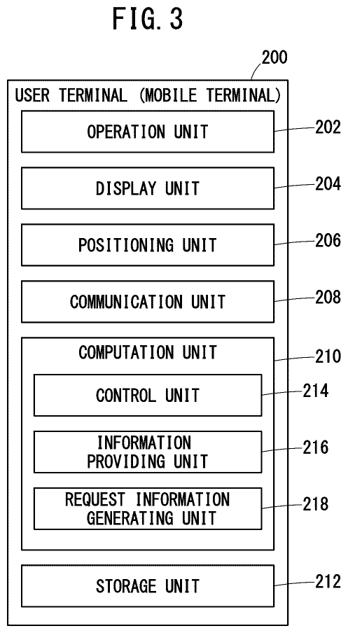

FIG. 3 is a block diagram illustrating an example of the user terminal 200.

The user terminal 200 is equipped with an operation unit 202, a display unit 204, a positioning unit 206, a communication unit 208, a computation unit 210, and a storage unit 212. The user terminal 200 may further be equipped with a non-illustrated speaker, a non-illustrated microphone, a non-illustrated camera, and the like. A program for causing a management method according to the present embodiment to be executed by a computer may be installed beforehand in the user terminal 200. Moreover, as noted previously, the user terminal 200 is a terminal that is possessed by the user.

The operation unit 202 can be used when a user operates the user terminal 200. The display unit 204 is equipped with a non-illustrated display element. The display element, for example, is a liquid crystal display element, an organic electroluminescence display element, or the like. At least a portion of the operation unit 202 and the display unit 204 may be configured in the form of a non-illustrated touch panel equipped with such a display element.

The positioning unit 206 may be equipped with a GNSS sensor. The GNSS sensor uses a satellite positioning system, and thereby acquires information indicating a current position of the user terminal 200. Moreover, it should be noted that the position of the user terminal 200 essentially indicates the user position, which is the position of the user who is in possession of the user terminal 200. More specifically, the positioning unit 206 is capable of acquiring user position information which is information indicating the user position.

The communication unit 208 is constituted, for example, by a communication device for wireless communication. The communication unit 208 is capable of carrying out wireless communications via the network NW. The communication unit 208 may also carry out communications using a wireless LAN. Further, the communication unit 208 may also carry out communications using the Bluetooth (registered trademark) standard. The communication unit 208 is capable of communicating with the management device 400. Further, the communication unit 208 is also capable of communicating with the control computer of the battery station 12.

The computation unit 210 may be constituted by a processor such as a CPU, a GPU, or the like. More specifically, the computation unit 210 can be constituted by a processing circuitry.

The storage unit 212 may be equipped with a non-illustrated volatile memory, and a non-illustrated nonvolatile memory. As an example of the volatile memory, there may be cited a RAM or the like. As an example of the nonvolatile memory, there may be cited a ROM, a flash memory, or the like. Data and the like may be stored, for example, in the volatile memory. Programs, tables, maps, and the like may be stored, for example, in the nonvolatile memory. At least a portion of the storage unit 212 may be provided in the aforementioned processor, an integrated circuit, or the like. The storage unit 212, for example, is capable of storing information that the user terminal 200 has received from the management device 400 via the communication unit 208.

The computation unit 210 may be equipped with a control unit 214, an information providing unit 216, and a request information generating unit 218. The control unit 214, the information providing unit 216, and the request information generating unit 218 can be realized by the computation unit 210 executing a program that is stored in the storage unit 212.

Moreover, at least a portion of the control unit 214, the information providing unit 216, and the request information generating unit 218 may be realized by an integrated circuit such as an ASIC, an FPGA, or the like. Further, at least a portion of the control unit 214, the information providing unit 216, and the request information generating unit 218 may be constituted by an electronic circuit including a discrete device.

The control unit 214 is responsible for the overall control of the user terminal 200. For example, the control unit 214 supplies the user position information acquired by the positioning unit 206 to the management device 400 via the communication unit 208. Further, the control unit 214 provides the user with a UI (User Interface) in order to enable the user to request collection and delivery of the mobile battery or batteries 100. For example, the control unit 214 controls the display unit 204 to display on the display unit 204 a GUI (Graphical User Interface) in order to enable the user to request the collection and delivery of the mobile battery or batteries 100. The control unit 214 is capable of transmitting to the management device 400, via the communication unit 208, a collection and delivery request for the mobile battery or batteries 100.

The information providing unit 216 controls the display unit 204, a speaker, and the like that are provided in the user terminal 200, and thereby provides collection and delivery person information to the user. The collection and delivery person information is information concerning a collection and delivery person who is capable of collecting and delivering the mobile battery or batteries 100 to the user. The collection and delivery person information indicates, for example, a position or the like of a collection and delivery person who is within a predetermined range from the user. The collection and delivery person information is generated by a later-described information generating unit 418. The collection and delivery person information and the information generating unit 418 will be described in more detail later.

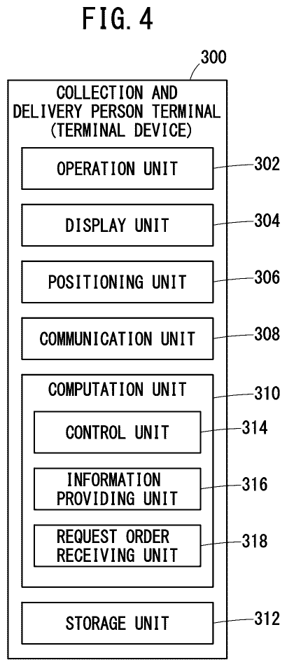

FIG. 4 is a block diagram illustrating an example of the collection and delivery person terminal 300.

The collection and delivery person terminal 300 is equipped with an operation unit 302, a display unit 304, a positioning unit 306, a communication unit 308, a computation unit 310, and a storage unit 312. The collection and delivery person terminal 300 may further be equipped with a non-illustrated speaker, a non-illustrated microphone, a non-illustrated camera, and the like. A program for causing a management method according to the present embodiment to be executed by a computer may be installed beforehand in the collection and delivery person terminal 300. Moreover, as noted previously, the collection and delivery person terminal 300 is a terminal possessed by the collection and delivery person.

The operation unit 302 can be used when the collection and delivery person operates the collection and delivery person terminal 300. The display unit 304 is equipped with a non-illustrated display element. The display element, for example, is a liquid crystal display element, an organic electroluminescence display element, or the like. At least a portion of the operation unit 302 and the display unit 304 may be configured in the form of a non-illustrated touch panel equipped with such a display element.

The positioning unit 306 may be equipped with a GNSS sensor. The GNSS sensor uses a satellite positioning system, and thereby acquires information indicating a current position of the collection and delivery person terminal 300. Moreover, it should be noted that the position of the collection and delivery person terminal 300 essentially indicates the position of the collection and delivery person who is in possession of the collection and delivery person terminal 300. More specifically, the positioning unit 306 is capable of acquiring collection and delivery person position information, which is information indicating the position of the collection and delivery person.

Moreover, in the case that the collection and delivery person is a delivery person who delivers the mobile battery or batteries 100, in the following description, the collection and delivery person position is also referred to as the delivery person position, and together therewith, the collection and delivery person position information is also referred to as the delivery person position information. On the other hand, in the case that the collection and delivery person is a collection person who collects the mobile battery or batteries 100, in the following description, the collection and delivery person position is also referred to as the collection person position, and together therewith, the collection and delivery person position information is also referred to as the collection person position information.

The communication unit 308 is constituted, for example, by a communication device for wireless communication. The communication unit 308 is capable of carrying out wireless communications via the network NW. The communication unit 308 may also carry out communications using a wireless LAN. Further, the communication unit 308 may also carry out communications using the Bluetooth (registered trademark) standard. The communication unit 308 is capable of communicating with the management device 400. Further, the communication unit 308 is also capable of communicating with the control computer of the battery station 12.

The computation unit 310 may be constituted by a processor such as a CPU, a GPU, or the like. More specifically, the computation unit 310 can be constituted by a processing circuitry.

The storage unit 312 may be equipped with a non-illustrated volatile memory, and a non-illustrated nonvolatile memory. As an example of the volatile memory, there may be cited a RAM or the like. As an example of the nonvolatile memory, there may be cited a ROM, a flash memory, or the like. Data and the like may be stored, for example, in the volatile memory. Programs, tables, maps, and the like may be stored, for example, in the nonvolatile memory. At least a portion of the storage unit 312 may be provided in the aforementioned processor, the integrated circuit, or the like. The storage unit 312, for example, is capable of storing information that the collection and delivery person terminal 300 has received from the management device 400 via the communication unit 308.

The computation unit 310 can be equipped with a control unit 314, an information providing unit 316, and a request order receiving unit 318. The control unit 314, the information providing unit 316, and the request order receiving unit 318 can be realized by the computation unit 310 executing a program that is stored in the storage unit 312.

Moreover, at least a portion of the control unit 314, the information providing unit 316, and the request order receiving unit 318 may be realized by an integrated circuit such as an ASIC, an FPGA, or the like. Further, at least a portion of the control unit 314, the information providing unit 316, and the request order receiving unit 318 may be constituted by an electronic circuit including a discrete device.

The control unit 314 is responsible for the overall control of the collection and delivery person terminal 300. For example, the control unit 314 supplies the collection and delivery person position information acquired by the positioning unit 306 to the management device 400 via the communication unit 308.

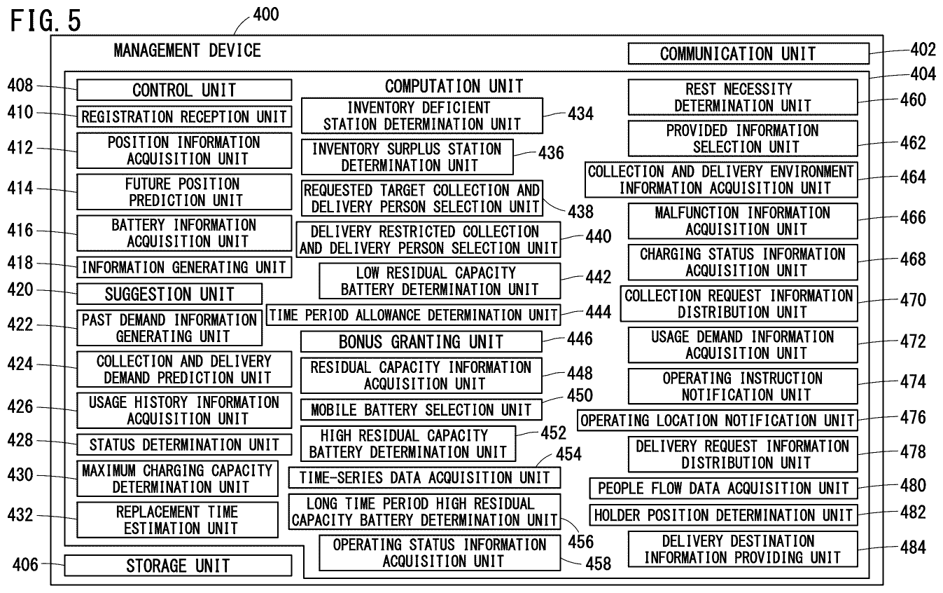

The information providing unit 316 controls the display unit 304, the speaker, and the like that are provided in the collection and delivery person terminal 300, and thereby provides user information to the collection and delivery person. The user information is information concerning the user who may require the collection and delivery of the mobile battery or batteries 100. The user information, for example, indicates the position of the user within a predetermined range from the collection and delivery person. The user information is generated by the later-described information generating unit 418 (refer to FIG. 5). The user information and the information generating unit 418 will be described in more detail later.

FIG. 5 is a block diagram illustrating an example of the management device 400.

The management device 400 comprises a communication unit 402, a computation unit 404, and a storage unit 406. A program for causing a management method according to the present embodiment to be executed by a computer may be installed beforehand in the management device 400. Moreover, as noted previously, the management device 400 is a server computer in order to manage the mobile battery or batteries 100.

The communication unit 402, for example, is constituted by a non-illustrated communication device. The communication unit 402 is capable of communicating with the user terminal 200, and can thereby receive the user position information from the user terminal 200. The communication unit 402 is capable of communicating with the collection and delivery person terminal 300, and can thereby receive the collection and delivery person position information from the collection and delivery person terminal 300. The communication unit 402 is capable of communicating with the mobile battery or batteries 100 or the battery station 12 (the control computer), and can thereby receive the battery information.

The computation unit 404 may be constituted by a processor such as a CPU, a GPU, or the like. More specifically, the computation unit 404 can be constituted by a processing circuitry.

The storage unit 406 may be equipped with a non-illustrated volatile memory and a non-illustrated nonvolatile memory. As an example of the volatile memory, there may be cited a RAM or the like. As an example of the nonvolatile memory, there may be cited a ROM, a flash memory, or the like. Data and the like may be stored, for example, in the volatile memory. Programs, tables, maps, and the like may be stored, for example, in the nonvolatile memory. At least a portion of the storage unit 406 may be provided in the aforementioned processor, the integrated circuit, or the like. Further, the storage unit 406 may further be equipped with an HDD (Hard Disk Drive), an SSD (Solid State Drive), or the like.

The storage unit 406 is capable of storing, for example, the information received by the communication unit 402 from the user terminal 200, the collection and delivery person terminal 300, and the like. Further, the storage unit 406 is capable of storing, for example, the information generated by the later-described information generating unit 418. The storage unit 406 can further store map information. Further, the storage unit 406 can further store information indicating a collection and delivery history of the mobile battery or batteries 100. The collection and delivery history of the mobile battery or batteries 100 may include, for example, information indicating the delivery person who has collected and delivered the mobile battery or batteries 100 to the user, information indicating the user from whom the mobile battery or batteries 100 were collected, and information indicating the mobile battery or batteries 100 that were collected and delivered. The collection and delivery history of the mobile battery or batteries 100 may further include information indicating a location (the user position) where the collection and delivery request for the mobile battery or batteries 100 was generated, information indicating the date and time when the collection and delivery request was made, and information indicating a later described meeting location where the user and the collection and delivery person are intended to meet. The information indicating the delivery person who has collected the mobile battery or batteries 100 from the user, the information indicating the user from whom the mobile battery or batteries 100 were collected, the information indicating the mobile battery or batteries 100 that were collected, and the information indicating the location where the collection and delivery request for the mobile battery or batteries 100 was generated, the information indicating the date and time when the collection and delivery request was made, and the information indicating the meeting location where the later-described user and the delivery person are intended to meet can be associated with each other in the collection and delivery history.

The computation unit 404 may include a control unit 408, a registration reception unit 410, the position information acquisition unit 412, a future position prediction unit 414, a battery information acquisition unit 416, the information generating unit 418, and a suggestion unit 420. The computation unit 404 may further be equipped with a past demand information generating unit 422, a collection and delivery demand prediction unit 424, a usage history information acquisition unit 426, a status determination unit 428, a maximum charging capacity determination unit 430, and a replacement time estimation unit 432. The computation unit 404 may further be equipped with an inventory deficient station determination unit 434, an inventory surplus station determination unit 436, a requested target collection and delivery person selection unit 438, and a delivery restricted collection and delivery person selection unit 440. The computation unit 404 may further be equipped with a low residual capacity battery determination unit 442, a time period allowance determination unit 444, a bonus granting unit 446, a residual capacity information acquisition unit 448, and a mobile battery selection unit 450. The computation unit 404 may further be equipped with a high residual capacity battery determination unit 452, a time-series data acquisition unit 454, and a long time period high residual capacity battery determination unit 456. The computation unit 404 may further be equipped with an operating status information acquisition unit 458, a rest necessity determination unit 460, a provided information selection unit 462, a collection and delivery environment information acquisition unit 464, and a malfunction information acquisition unit 466. The computation unit 404 may further be equipped with a charging status information acquisition unit 468, and a collection request information distribution unit 470. The computation unit 404 may further be equipped with a usage demand information acquisition unit 472, an operating instruction notification unit 474, and an operating location notification unit 476. The computation unit 404 may further be equipped with a delivery request information distribution unit 478, a people flow data acquisition unit 480, a holder position determination unit 482, and a delivery destination information providing unit 484.

The control unit 408, the registration reception unit 410, the position information acquisition unit 412, the future position prediction unit 414, the battery information acquisition unit 416, the information generating unit 418, and the suggestion unit 420 can be realized by the computation unit 404 executing a program that is stored in the storage unit 406. The past demand information generating unit 422, the collection and delivery demand prediction unit 424, the usage history information acquisition unit 426, the status determination unit 428, the maximum charging capacity determination unit 430, and the replacement time estimation unit 432 can be realized by the computation unit 404 executing a program that is stored in the storage unit 406. The inventory deficient station determination unit 434, the inventory surplus station determination unit 436, the requested target collection and delivery person selection unit 438, and the delivery restricted collection and delivery person selection unit 440 can be realized by the computation unit 404 executing a program that is stored in the storage unit 406. The low residual capacity battery determination unit 442, the time period allowance determination unit 444, the bonus granting unit 446, the residual capacity information acquisition unit 448, and the mobile battery selection unit 450 can be realized by the computation unit 404 executing a program that is stored in the storage unit 406. The high residual capacity battery determination unit 452, the time-series data acquisition unit 454, and the long time period high residual capacity battery determination unit 456 can be realized by the computation unit 404 executing a program that is stored in the storage unit 406. The operating status information acquisition unit 458, the rest necessity determination unit 460, the provided information selection unit 462, the collection and delivery environment information acquisition unit 464, and the malfunction information acquisition unit 466 can be realized by the computation unit 404 executing a program that is stored in the storage unit 406. The charging status information acquisition unit 468, and the collection request information distribution unit 470 can be realized by the computation unit 404 executing a program that is stored in the storage unit 406. The usage demand information acquisition unit 472, the operating instruction notification unit 474, and the operating location notification unit 476 can be realized by the computation unit 404 executing a program that is stored in the storage unit 406. The delivery request information distribution unit 478, the people flow data acquisition unit 480, the holder position determination unit 482, and the delivery destination information providing unit 484 can be realized by the computation unit 404 executing a program that is stored in the storage unit 406.

Moreover, at least a portion of the control unit 408, the registration reception unit 410, the position information acquisition unit 412, the future position prediction unit 414, the battery information acquisition unit 416, the information generating unit 418, and the suggestion unit 420 may be realized by an integrated circuit such as an ASIC, an FPGA, or the like. At least a portion of the past demand information generating unit 422, the collection and delivery demand prediction unit 424, the usage history information acquisition unit 426, the status determination unit 428, the maximum charging capacity determination unit 430, and the replacement time estimation unit 432 may be realized by an integrated circuit such as an ASIC, an FPGA, or the like. At least a portion of the inventory deficient station determination unit 434, the inventory surplus station determination unit 436, the requested target collection and delivery person selection unit 438, and the delivery restricted collection and delivery person selection unit 440 may be realized by an integrated circuit such as an ASIC, an FPGA, or the like. At least a portion of the low residual capacity battery determination unit 442, the time period allowance determination unit 444, the bonus granting unit 446, the residual capacity information acquisition unit 448, and the mobile battery selection unit 450 may be realized by an integrated circuit such as an ASIC, an FPGA, or the like. At least a portion of the high residual capacity battery determination unit 452, the time-series data acquisition unit 454, and the long time period high residual capacity battery determination unit 456 may be realized by an integrated circuit such as an ASIC, an FPGA, or the like. At least a portion of the operating status information acquisition unit 458, the rest necessity determination unit 460, the provided information selection unit 462, the collection and delivery environment information acquisition unit 464, and the malfunction information acquisition unit 466 may be realized by an integrated circuit such as an ASIC, an FPGA, or the like. At least a portion of the charging status information acquisition unit 468, and the collection request information distribution unit 470 may be realized by an integrated circuit such as an ASIC, an FPGA, or the like. At least a portion of the usage demand information acquisition unit 472, the operating instruction notification unit 474, and the operating location notification unit 476 may be realized by an integrated circuit such as an ASIC, an FPGA, or the like. At least a portion of the delivery request information distribution unit 478, the people flow data acquisition unit 480, the holder position determination unit 482, and the delivery destination information providing unit 484 may be realized by an integrated circuit such as an ASIC, an FPGA, or the like.

Further, at least a portion of the control unit 408, the registration reception unit 410, the position information acquisition unit 412, the future position prediction unit 414, the battery information acquisition unit 416, the information generating unit 418, and the suggestion unit 420 may be constituted by an electronic circuit including a discrete device. At least a portion of the past demand information generating unit 422, the collection and delivery demand prediction unit 424, the usage history information acquisition unit 426, the status determination unit 428, the maximum charging capacity determination unit 430, and the replacement time estimation unit 432 may be constituted by an electronic circuit including a discrete device. At least a portion of the inventory deficient station determination unit 434, the inventory surplus station determination unit 436, the requested target collection and delivery person selection unit 438, and the delivery restricted collection and delivery person selection unit 440 may be constituted by an electronic circuit including a discrete device. At least a portion of the low residual capacity battery determination unit 442, the time period allowance determination unit 444, the bonus granting unit 446, the residual capacity information acquisition unit 448, and the mobile battery selection unit 450 may be constituted by an electronic circuit including a discrete device. At least a portion of the high residual capacity battery determination unit 452, the time-series data acquisition unit 454, and the long time period high residual capacity battery determination unit 456 may be constituted by an electronic circuit including a discrete device. At least a portion of the operating status information acquisition unit 458, the rest necessity determination unit 460, the provided information selection unit 462, the collection and delivery environment information acquisition unit 464, and the malfunction information acquisition unit 466 may be constituted by an electronic circuit including a discrete device. At least a portion of the charging status information acquisition unit 468, and the collection request information distribution unit 470 may be constituted by an electronic circuit including a discrete device. At least a portion of the usage demand information acquisition unit 472, the operating instruction notification unit 474, and the operating location notification unit 476 may be constituted by an electronic circuit including a discrete device.

The control unit 408 governs the overall control of the management device 400. For example, the control unit 408 is capable of controlling the communication unit 402, and thereby appropriately transmitting the information stored in the storage unit 406 to the user terminal 200 and the collection and delivery person terminal 300.

The registration reception unit 410 receives a user registration that is carried out by a person wishing to make use of the sharing system 10 as a user. A person wishing to make use of the sharing system 10 as a user can carry out the user registration using a predetermined application software that is capable of being installed in a terminal such as a smart phone or the like. The registration reception unit 410 is capable of storing in the storage unit 406 the identification information, which is information that is unique to the user who has completed the user registration process. In the following description, the identification information of the user is also referred to as user identification information.

Further, the registration reception unit 410 receives a collection and delivery person registration carried out by a person wishing to act as a collection and delivery person. The person wishing to act as the collection and delivery person can carry out a collection and delivery person registration process using the predetermined application software that is capable of being installed in a terminal such as a smart phone or the like. The registration reception unit 410 is capable of storing in the storage unit 406 the identification information, which is information that is unique to the collection and delivery person who has completed the collection and delivery registration process. In the following description, the identification information of the collection and delivery person is also referred to as collection and delivery person identification information.

The position information acquisition unit 412 acquires the user position information that was received by the communication unit 402 from the user terminal 200. The position information acquisition unit 412 is capable of sequentially acquiring the user position information. The position information acquisition unit 412 is capable of acquiring a plurality of instances of the user position information from a plurality of the user terminals 200. The position information acquisition unit 412 is capable of storing the user position information that was acquired in the storage unit 406 in association with the user identification information.

Further, the position information acquisition unit 412 acquires the collection and delivery person information that was received by the communication unit 402 from the collection and delivery person terminal 300. The position information acquisition unit 412 is capable of sequentially acquiring the user position information. The position information acquisition unit 412 is capable of acquiring a plurality of instances of the collection and delivery person position information from a plurality of the collection and delivery person terminals 300. The position information acquisition unit 412 is capable of storing the collection and delivery person position information that was acquired, in the storage unit 406 in association with the collection and delivery person identification information.

The future position prediction unit 414 predicts a future user position which is a user position in the future. Stated otherwise, the future position prediction unit 414 predicts a future position of the user. The future position prediction unit 414 predicts the future user position based on, for example, an action plan of the user, and the user position that is acquired by the position information acquisition unit 412. The future position prediction unit 414 can store the future user position that was predicted in the storage unit 406 in association with the user identification information.

The action plan of the user is information indicating, for example, a destination of the user, an expected arrival time of the user at the destination, and a means of transportation of the user to the destination, and the like. The user may operate the user terminal 200, and thereby transmit the action plan of the user to the management device 400. Moreover, based on a current behavior of the user, the future position prediction unit 414 may predict the future position of the user. For example, in the case that the user is using a train, the future position of the user can be predicted based on a timetable or the like for the train. Further, for example, in the case that the user is walking on a road, the future position of the user can be predicted based on map information concerning the road, a movement speed of the user, and the direction of movement of the user. Further, based on schedule information of the user, the future position prediction unit 414 may predict the future position of the user. The schedule information can be stored beforehand in the storage unit 212 that is provided in the user terminal 200.

The battery information acquisition unit 416, via the communication unit 402, acquires the battery information of the mobile battery or batteries 100. Moreover, as noted previously, the battery information may include identification information of the mobile battery or batteries 100, and the information indicating the residual capacity of the mobile battery or batteries 100. The battery information acquisition unit 416 can associate the acquired battery information with the user who is in possession of the mobile battery or batteries 100 indicated by the battery information, and can store the same in the storage unit 406. The battery information acquisition unit 416 can associate the acquired battery information with the collection and delivery person who is in possession of the mobile battery or batteries 100 indicated by the battery information, and can store the same in the storage unit 406. The battery information acquisition unit 416 can associate the acquired battery information with the battery station 12 in which the mobile battery or batteries 100 are arranged, and can store the same in the storage unit 406.

The information generating unit 418 generates the collection and delivery person information. The collection and delivery person information, as noted previously, is information concerning a collection and delivery person who is capable of collecting and delivering the mobile battery or batteries 100 with respect to the user. The information generating unit 418 can generate the collection and delivery person information based on the collection and delivery person position and the user position. More specifically, the information generating unit 418 can generate the collection and delivery person information based on the collection and delivery person position, the user position, and the map information. The information generating unit 418 can include, in the collection and delivery person information, information indicating the collection and delivery person position within a predetermined range from the user position. More specifically, for example, the information generating unit 418 can include, in the collection and delivery person information, information for causing there to be displayed on the display unit 204 of the user terminal 200, together with a map MP, a graphic indicating the collection and delivery person position within the predetermined range from the user position. Moreover, the predetermined range may be a range within a predetermined distance from the future user position, or a range within which an estimated travel time in order for the collection and delivery person to reach the future user position lies within a predetermined time period.

The control unit 408 can transmit the collection and delivery person information generated by the information generating unit 418, via the communication unit 402, to the user terminal 200. The information providing unit 216 of the user terminal 200 can display on the display unit 204 the collection and delivery person information that was received from the management device 400. Consequently, the collection and delivery person information is provided to the user.

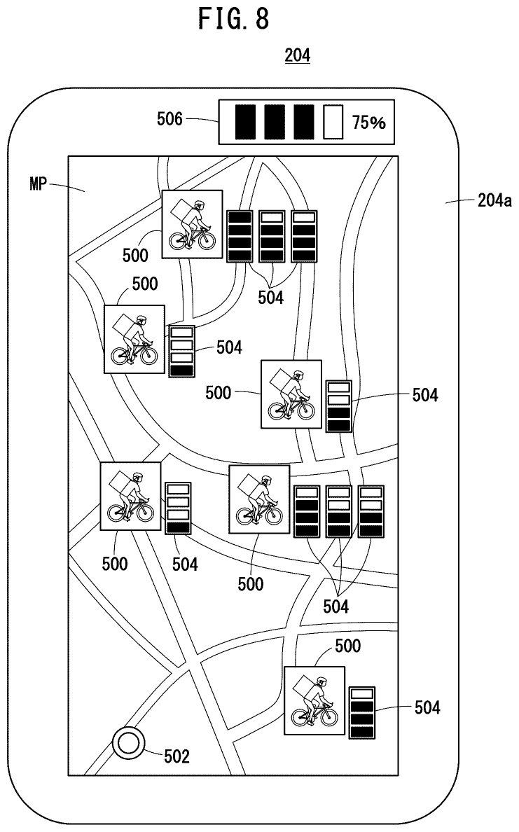

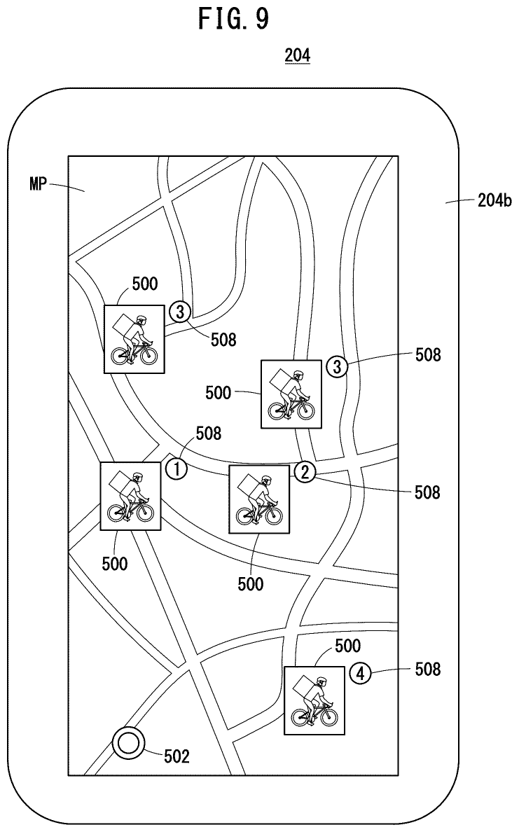

As noted previously, the collection and delivery person information can include information in order cause there to be displayed on the display unit 204 of the user terminal 200, together with the map MP, the graphic indicating the collection and delivery person position. In that case, the information providing unit 216, together with displaying the map MP on the display unit 204, is capable of displaying on the map MP a graphic 500 indicating the collection and delivery person position (refer also to FIG. 8 and FIG. 9). Consequently, the user can easily grasp the position of the collection and delivery person who is capable of collecting and delivering the mobile battery or batteries 100 to the user.

The information providing unit 216 may further display, on the map MP, a graphic indicating the position of the user who is in possession of the user terminal 200 equipped with the information providing unit 216. Consequently, the user is capable of easily grasping a positional relationship between the user and the collection and delivery person. In the case that the graphic indicating the user position is caused to be displayed on the map MP, the information providing unit 216 can acquire the user position information from the positioning unit 206 of the user terminal 200, although the present invention is not necessarily limited to this feature. The information providing unit 216 may also acquire the user position information from the management device 400.

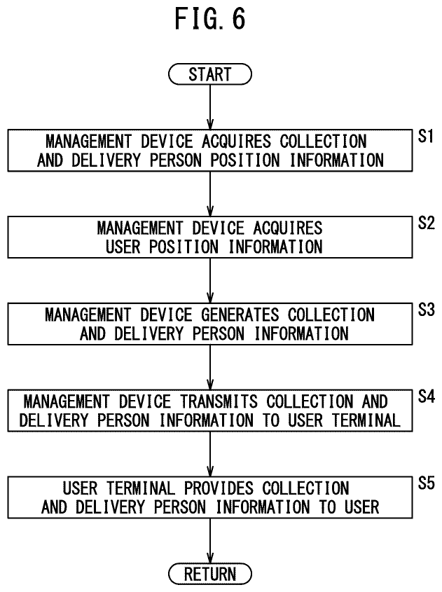

FIG. 6 is a flowchart illustrating an example of operations of the management system 16. An example of a case in which the collection and delivery person information is provided to the user is shown in FIG. 6.

In step S1, the position information acquisition unit 412 of the management device 400 acquires the collection and delivery person position information. Further, in step S2, the position information acquisition unit 412 of the management device 400 acquires the user position information.

Next, the process transitions to step S3, whereupon the information generating unit 418 of the management device 400 generates the collection and delivery person information. The information generating unit 418, based on the future user position and the collection and delivery person position, generates the collection and delivery person information.

Next, the process transitions to step S4, whereupon the communication unit 402 of the management device 400 transmits the collection and delivery person information generated by the information generating unit 418 to the user terminal 200.

Next, the process transitions to step S5, whereupon the information providing unit 216 of the user terminal 200 provides to the user the collection and delivery person information that was received from the management device 400. More specifically, the collection and delivery person information is provided to the user using the user terminal 200. For example, together with displaying the map MP on the display unit 204, by causing a graphic indicating the collection and delivery person position to be displayed on the map MP, the information providing unit 216 provides to the user the collection and delivery person information. In this manner, the operations illustrated in FIG. 6 come to an end.

The information generating unit 418 may generate the collection and delivery person information based on the collection and delivery person position and the future user position. More specifically, the information generating unit 418 may generate the collection and delivery person information based on the collection and delivery person position, the future user position, and the map information. As noted previously, based on the user position, the future user position can be predicted by the future position prediction unit 414. In this case, the information generating unit 418 can include, in the collection and delivery person information, information indicating the collection and delivery person position within a predetermined range from the future user position. More specifically, the information generating unit 418 can include, in the collection and delivery person information, information for displaying the graphic indicating the collection and delivery person position within the predetermined range from the future user position, together with the map MP, on the display unit 204 of the user terminal 200.

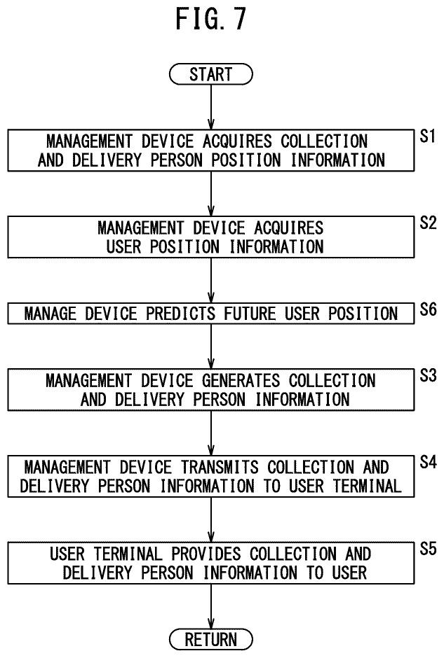

FIG. 7 is a flowchart illustrating an example of operations of the management system 16. An example of a case in which the collection and delivery person information is generated using the future user position is shown in FIG. 7.

Step S1 of FIG. 7 can be performed in the same manner as step S1 of FIG. 6. Further, step S2 of FIG. 7 can be performed in the same manner as step S2 of FIG. 6.

In the example shown in FIG. 7, step S6 may be performed after step S2. In step S6, the future position prediction unit 414 of the management device 400 predicts the future user position. The future position prediction unit 414 predicts the future user position based on, for example, the user position information and the action plan of the user. As noted previously, the user position information is acquired in step S2. As noted previously, the action plan of the user is appropriately transmitted by the user to the management device 400 using the user terminal 200.

According to FIG. 7, subsequent to step S6, step S3 is carried out. In step S3, the information generating unit 418 of the management device 400 generates the collection and delivery person information. In step S3 of FIG. 7, the information generating unit 418, based on the future user position and the collection and delivery person position, generates the collection and delivery person information.

According to FIG. 7, after step S3, step S4 and step S5 are carried out. Step S4 of FIG. 7 can be performed in the same manner as step S4 of FIG. 6. Further, step S5 of FIG. 7 can be performed in the same manner as step S5 of FIG. 6. In this manner, the operations illustrated in FIG. 7 come to an end.

The information generating unit 418 may vary the content of the collection and delivery person information provided to the user, in accordance with whether the user may require either one from among the delivery of the mobile battery or batteries 100 or the collection of the mobile battery or batteries 100. In light of this point, a description concerning the information generating unit 418 will be further presented.

It is preferable for the user who may require the delivery of the mobile battery or batteries 100 to be provided with the collection and delivery person information concerning the delivery person. The collection and delivery person information concerning the delivery person is also referred to as delivery person information in the following description. The information generating unit 418, based on the information indicating the future user position and the delivery person position information, can include in the delivery person information, information indicating the delivery person position within the predetermined range from the future user position. Further, the information generating unit 418, based on the battery information acquired by the battery information acquisition unit 416, may also include in the delivery person information, the information indicating the residual capacity of the mobile battery or batteries 100 possessed by the delivery person. Consequently, the information providing unit 216 of the user terminal 200 is capable of providing to the user the information indicating the residual capacity of the mobile battery or batteries 100 possessed by the delivery person. The user, using the delivery person information that was provided, can easily find a delivery person who is capable of delivering the mobile battery or batteries 100 having a residual capacity that the user desires.

The information generating unit 418 may include, in the delivery person information, information in order to cause there to be displayed on the display unit 204 of the user terminal 200 a graphic indicating the residual capacity of the mobile battery or batteries 100 possessed by the delivery person. Consequently, the information providing unit 216 is capable of causing there to be displayed on the display unit 204, together with the map MP, the graphic indicating the residual capacity of the mobile battery or batteries 100 possessed by the delivery person. The graphic indicating the residual capacity of the mobile battery or batteries 100 possessed by the delivery person, for example, changes at least one of a shape, a color, and a size thereof in accordance with the residual capacity. By observing the display unit 204, the user is capable of easily grasping the residual capacity of the mobile battery or batteries 100 possessed by the delivery person.

The information generating unit 418 may generate the delivery person information to be provided to the user, only in the case that the residual capacity of the mobile battery or batteries 100 possessed by the user has fallen below a predetermined residual capacity threshold value. In accordance with this feature, the information providing unit 216 of the user terminal 200 can provide, to the user for which the residual capacity of the mobile battery or batteries 100 possessed by the user has fallen below the residual capacity threshold value, the delivery person information regarding the delivery person who is capable of delivering other ones of the mobile battery or batteries 100 to the user. More specifically, the information providing unit 216 is capable of providing the delivery person information to the user for which the possibility to request the delivery of the mobile battery or batteries 100 is high. The residual capacity threshold value can be stored beforehand by the storage unit 406 of the management device 400.

The information generating unit 418 may include in the delivery person information, information indicating the number of the mobile battery or batteries 100 possessed by the delivery person. The information generating unit 418, for example, based on a collection and delivery history of the mobile battery or batteries 100, can acquire the information indicating the number of the mobile battery or batteries 100 possessed by the delivery person. In that case, the information generating unit 418 can include, in the delivery person information, information in order to cause there to be displayed on the display unit 204 of the user terminal 200 the graphic indicating the number of the mobile battery or batteries 100 possessed by the delivery person together with the map MP. Consequently, the information providing unit 216 is capable of causing there to be displayed on the display unit 204 of the user terminal 200, together with the map MP, the graphic indicating the number of the mobile battery or batteries 100 possessed by the delivery person. The user of the mobile battery or batteries 100, by observing the display unit 204, can easily find a delivery person who is capable of delivering the number of the mobile battery or batteries 100 that the user desires.

FIG. 8 is a diagram illustrating an example of a display on the display unit 204 of the user terminal 200. An example of a case in which the collection person information is displayed on the display unit 204 is shown in FIG. 8.

The information providing unit 216 of the user terminal 200 that has received the delivery person information is capable of causing there to be displayed on the display unit 204, for example, a display screen 204a illustrated in FIG. 8. The map MP, the graphic 500, a graphic 502, and a graphic 504 are capable of being displayed on the display screen 204a. The graphic 500, the graphic 502, and the graphic 504 can be displayed on the map MP. The graphic 500 indicates the delivery person position (the collection and delivery person position). The graphic 502 indicates the user position. More specifically, the graphic 502 of FIG. 8 indicates the position of the user terminal 200 that is equipped with the display unit 204 on which the display screen 204a of FIG. 8 is displayed. The graphic 504 indicates the residual capacity of the mobile battery or batteries 100 possessed by the delivery person.

The graphic 504 changes, for example, the color, the size, or the like thereof in accordance with the residual capacity of the mobile battery or batteries 100 possessed by the delivery person. For example, the graphic 504 of FIG. 8 represents a residual capacity meter that indicates the residual capacity of the mobile battery or batteries 100. FIG. 8 illustrates that the larger the number of colored portions (blackened portions) in the graphic 504 becomes, the larger the residual capacity of the mobile battery or batteries 100 is. A number of the graphics 504 corresponding to the number of the mobile battery or batteries 100 possessed by the delivery person can be displayed on the display screen 204a. More specifically, the graphic or graphics 504 indicate the number of the mobile battery or batteries 100 possessed by the delivery person.

The information providing unit 216 may cause there to be displayed on the display unit 204 the information indicating the residual capacity of the mobile device battery. The mobile device battery, for example, is a main battery provided in the user terminal 200. A more detailed description of the mobile device battery will be given later. In the case that the user is already in possession of the mobile battery or batteries 100, the information providing unit 216 may cause there to be displayed on the display unit 204 the information indicating the residual capacity of the mobile battery or batteries 100. As shown in FIG. 8, the information providing unit 216 may further cause a graphic 506 to be displayed on the display screen 204a. The graphic 506 may indicate the residual capacity of the mobile device battery, or may indicate the residual capacity of the mobile battery or batteries 100 possessed by the user. The displayed position of the graphic 506 is a position in which the map MP from within the display screen 204a in FIG. 8 is avoided, although the present invention is not necessarily limited to this feature.

The color, the size, or the like of the graphic 500 indicating the delivery person position may change in accordance with the residual capacity of the mobile battery or batteries 100 possessed by the user, or the residual capacity of the mobile battery or batteries 100 that the delivery person is capable of delivering. For example, the color, the size, or the like of the graphic 500 may change depending on whether or not the graphic indicates the delivery person who is capable of delivering the mobile battery or batteries 100 in which the residual capacity thereof is greater than the residual capacity of the mobile battery or batteries 100 possessed by the user. In accordance with this feature, the user can easily find a delivery person who is capable of delivering the mobile battery or batteries 100 in which the residual capacity thereof is greater than the residual capacity of the mobile battery or batteries 100 possessed by the user. In this case, the information generating unit 418 generates the delivery person information, based on the information indicating the residual capacity of the mobile battery or batteries 100 possessed by the user, and the information indicating the residual capacity of the mobile battery or batteries 100 that the delivery person is capable of delivering. The user terminal 200 (the computation unit 210) may change the color, the size, or the like of the graphic 500 that is specified by the delivery person information, based on the information indicating the residual capacity of the mobile battery or batteries 100 possessed by the user, and the information indicating the residual capacity of the mobile battery or batteries 100 that the delivery person is capable of delivering. The color, the size, or the like of the graphic 504 indicating the residual capacity of the mobile battery or batteries 100 possessed by the delivery person may change in accordance with the residual capacity of the mobile battery or batteries 100 possessed by the user, or the residual capacity of the mobile battery or batteries 100 possessed by the delivery person.

Although the description of FIG. 8 is as described above, the information that is capable of being displayed on the display screen 204a for the user who may require the delivery of the mobile battery or batteries 100 is not necessarily limited to the content shown in FIG. 8. This point will be described later in accordance with the necessity thereof.

It is preferable for the user who may require the collection of the mobile battery or batteries 100 to be provided with the collection and delivery person information concerning the collection person. The collection and delivery person information concerning the collection person is also referred to as collection person information in the following description. The information generating unit 418, based on the information indicating the future user position and the collection person position information, can include in the collection person information, information indicating the collection person position within the predetermined range from the future user position. Further, the information generating unit 418 can include in the collection person information, information indicating the number of the mobile battery or batteries 100 that are capable of being collected by the collection person. The information generating unit 418, based on a difference between the maximum number of the mobile battery or batteries 100 that are capable of being possessed by the collection person, and the number of the mobile battery or batteries 100 that the collection person is currently in possession of, is capable of generating the information indicating the number of the mobile battery or batteries 100 that are capable of being collected by the collection person. By the collection person using the collection and delivery person terminal 300, the information indicating the maximum number of the mobile battery or batteries 100 that are capable of being possessed by the collection person can be transmitted beforehand to the management device 400. The information indicating the number of the mobile battery or batteries 100 possessed by the collection person can be acquired based on a collection and delivery history of the mobile battery or batteries 100.

FIG. 9 is a diagram illustrating an example of a display on the display unit 204 of the user terminal 200. An example of a case in which the collection person information is displayed on the display unit 204 is shown in FIG. 9.

The information providing unit 216 of the user terminal 200 that has received the collection person information is capable of causing there to be displayed on the display unit 204, for example, a display screen 204b illustrated in FIG. 9. The map MP, the graphic 500, and the graphic 502 are capable of being displayed on the display screen 204b. The graphic 500 indicates the position of the collection person (the collection and delivery person position) on the display screen 204b. The graphic 502 indicates the user position. More specifically, the graphic 502 of FIG. 9 indicates the position of the user terminal 200 that is equipped with the display unit 204 on which the display screen 204b of FIG. 9 is displayed.

A graphic 508 can further be displayed on the display screen 204b. The graphic 508 can be displayed on the map MP. The graphic 508 indicates that the collection person is capable of collecting the mobile battery or batteries 100. In the example shown in FIG. 9, the number that is added to the graphic 508 indicates the number of the mobile battery or batteries 100 that the collection person is capable of collecting. In the case that the number added to the graphic 508, for example, is the number “3”, the graphic 508 indicates that the collector is capable of collecting up to three of the mobile battery or batteries 100. Moreover, it should be noted that the graphic 508 is not necessarily limited to this feature.

The color, the size, or the like of the graphic 500 indicating the collection person position may change in accordance with the number of the mobile battery or batteries 100 possessed by the user, or the number of the mobile battery or batteries 100 that are capable of being collected by the collection person. In that case, it is preferable that the color, the size, or the like of the graphic 500 changes depending on the number of the mobile battery or batteries 100 that the user wishes to have collected, or the number of the mobile battery or batteries 100 that the collection person is capable of collecting. For example, the color, the size, or the like of the graphic 500 may change depending on whether or not a collection person is indicated who is capable of collecting all of the mobile battery or batteries 100 that the user wishes to have collected. Consequently, the user can easily find a collection person who is capable of collecting all of the mobile battery or batteries 100 possessed by the user. In this case, the information generating unit 418 generates the collection person information, based on the information indicating the number of the mobile battery or batteries 100 possessed by the user, and the information indicating the number of the mobile battery or batteries 100 that the collection person is capable of collecting. The user terminal 200 (the computation unit 210) may change the color, the size, or the like of the graphic 500 that is specified by the collection person information based on the information indicating the number of the mobile battery or batteries 100 possessed by the user, and the information indicating the number of the mobile battery or batteries 100 that the collection person is capable of collecting. The color, the size, or the like of the graphic 508 may change in accordance with the number of the mobile battery or batteries 100 possessed by the user, or the number of the mobile battery or batteries 100 that are capable of being collected by the collection person.

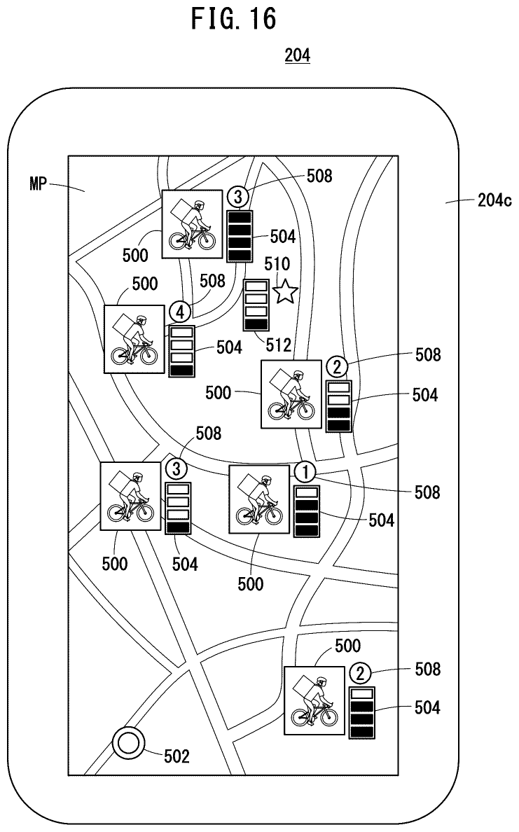

The information providing unit 216 may display together on a single display screen the display screen 204a shown in FIG. 8, and the display screen 204b shown in FIG. 9. For example, the information providing unit 216 may further display, on the display screen 204a shown in FIG. 8, the graphic 508 shown in FIG. 9. The graphic 508, as noted previously, is a graphic indicating that the collection person is capable of collecting the mobile battery or batteries 100. In that case, the delivery person information and the collection person information can be provided simultaneously to the user (refer also to FIG. 16).

Although the description of FIG. 9 is as described above, the information that is capable of being displayed on the display screen 204b for the user who may require the collection of the mobile battery or batteries 100 is not necessarily limited to the content shown in FIG. 9. This point will be described later in accordance with the necessity thereof.

The above-described information generating unit 418 is capable of generating not only the collection and delivery person information, but also the user information. The user information, as noted previously, is information concerning the user who may require the collection and delivery of the mobile battery or batteries 100. The information generating unit 418 can generate the user information, based on the user position information and the collection and delivery person position information acquired by the position information acquisition unit 412. The information generating unit 418 can include in the user information, information indicating the user position within a predetermined range from the collection and delivery person position. More specifically, the information generating unit 418 may include, in the user information, information for causing there to be displayed on the display unit 304 of the collection and delivery person terminal 300, together with the map MP, the graphic indicating the user position within the predetermined range from the collection and delivery person position. Moreover, the predetermined range may be a range within a predetermined distance from the collection and delivery person position, or a range within which an estimated travel time in order for the collection and delivery person to reach the user position lies within the predetermined time period.

The control unit 408 can transmit the user information generated by the information generating unit 418, via the communication unit 402, to the collection and delivery person terminal 300. The information providing unit 316 of the collection and delivery person terminal 300 can display on the display unit 304 the user information that was received from the management device 400. In accordance with this feature, the user information is provided to the collection and delivery person.

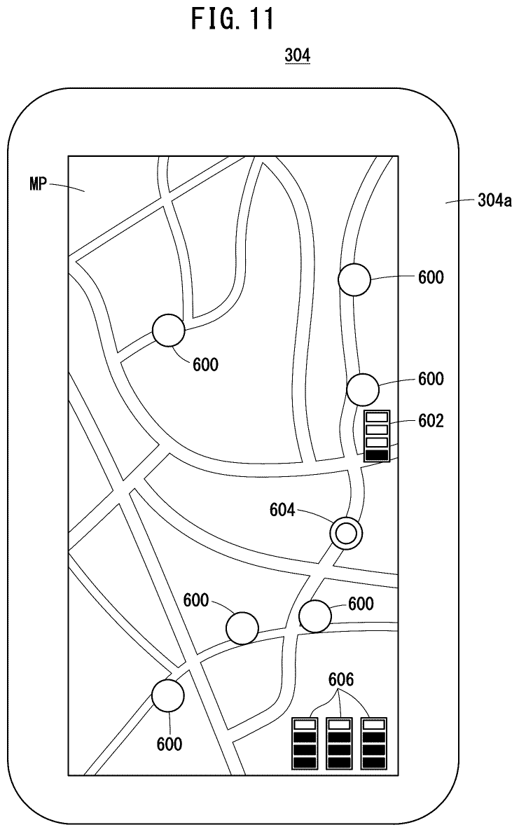

As noted previously, the user information can include information in order to display on the display unit 304 of the collection and delivery person terminal 300, together with the map MP, the graphic indicating the user position. In that case, the information providing unit 316, together with displaying the map MP on the display unit 304, is capable of displaying on the map MP a graphic 600 indicating the user position (refer also to FIG. 11). In accordance with this feature, the delivery person is capable of easily grasping the position of the user.

The information providing unit 316 may further display, on the map MP, a graphic indicating the position of the collection and delivery person who is in possession of the collection and delivery person terminal 300 equipped with the information providing unit 316. Consequently, the collection and delivery person can easily understand the positional relationship between the collection and delivery person and the user. In the case that the graphic indicating the collection and delivery person position is caused to be displayed on the map MP, the information providing unit 316 can acquire the collection and delivery person position information from the positioning unit 306 of the collection and delivery person terminal 300, although the present invention is not necessarily limited to this feature. The information providing unit 316 may also acquire the collection and delivery person position information from the management device 400.

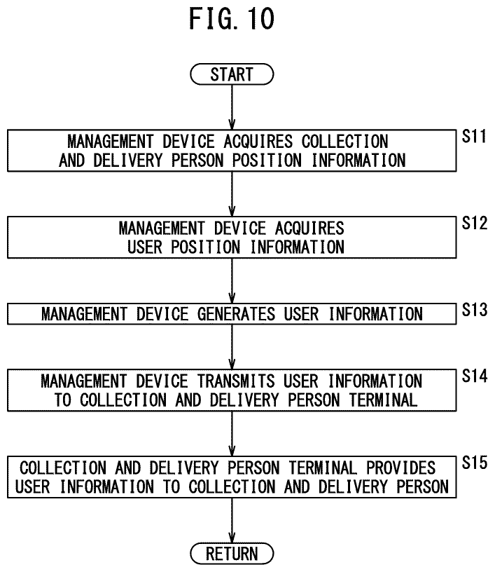

FIG. 10 is a flowchart illustrating an example of operations of the management system 16. An example of a case in which the user information is provided to the collection and delivery person is shown in FIG. 10.

In step S11, the position information acquisition unit 412 of the management device 400 acquires the collection and delivery person position information.

Further, in step S12, the position information acquisition unit 412 of the management device 400 acquires the user position information.

Next, the process transitions to step S13, whereupon the information generating unit 418 of the management device 400 generates the user information. The information generating unit 418, based on the user position and the collection and delivery person position, generates the user information.

Next, the process transitions to step S14, whereupon the communication unit 402 of the management device 400 transmits to the collection and delivery person terminal 300 the user information generated by the information generating unit 418.

Next, the process transitions to step S15, whereupon the information providing unit 316 of the collection and delivery person terminal 300 provides to the collection and delivery person the user information that was received from the management device 400. More specifically, the user information is provided to the collection and delivery person using the collection and delivery person terminal 300. For example, together with displaying the map MP on the display unit 304, by causing a graphic indicating the user position to be displayed on the map MP, the information providing unit 316 provides the user information to the collection and delivery person. In this manner, the operations illustrated in FIG. 10 come to an end.

Hereinafter, a description concerning the generation of the user information by the information generating unit 418 will be further presented.

The information generating unit 418 can include in the user information, information indicating the number (including zero) of the mobile battery or batteries 100 possessed by the user. For example, the information generating unit 418 can include, in the user information, information in order to cause there to be displayed on the display unit 304 of the collection and delivery person terminal 300 a graphic indicating the number of the mobile battery or batteries 100 possessed by the user. In accordance with this feature, the information providing unit 316 of the collection and delivery person terminal 300 can provide to the collection and delivery person the information indicating the number of the mobile battery or batteries 100 possessed by the user. Using the user information that was provided, the collection and delivery person can easily find, for example, a user who is not in possession of the mobile battery or batteries 100. More specifically, using the user information that was provided, the collection and delivery person can easily find, for example, a user for which the possibility to request the delivery of the mobile battery or batteries 100 is high. The information generating unit 418, for example, based on the collection and delivery history that is stored in the storage unit 406 of the management device 400, can acquire the information indicating the number of the mobile battery or batteries 100 possessed by the user.

The information generating unit 418 can further include in the user information, information indicating the residual capacity of the mobile battery or batteries 100 already possessed by the user. In accordance with this feature, the information providing unit 316 of the collection and delivery person terminal 300 can provide to the collection and delivery person the information indicating the residual capacity of the mobile battery or batteries 100 already possessed by the user. Using the user information that was provided, the collection and delivery person can easily find, for example, a user who is in possession of the mobile battery or batteries 100 having a low residual capacity. More specifically, using the user information that was provided, the collection and delivery person can easily find, for example, a user for which the possibility to request the delivery of the mobile battery or batteries 100 is high. Information indicating the residual capacity of the mobile battery or batteries 100 already possessed by the user can be acquired by the battery information acquisition unit 416.

The information generating unit 418 may include, in the user information, information in order to cause there to be displayed on the display unit 304 of the collection and delivery person terminal 300 a graphic indicating the residual capacity of the mobile battery or batteries 100 possessed by the user. Consequently, the information providing unit 316 is capable of causing there to be displayed on the display unit 304, together with the map MP, the graphic indicating the residual capacity of the mobile battery or batteries 100 possessed by the user. The graphic indicating the residual capacity of the mobile battery or batteries 100 possessed by the user, for example, changes at least one of a shape, a color, and a size thereof in accordance with the residual capacity. By observing the display unit 304, the collection and delivery person is capable of easily grasping the residual capacity of the mobile battery or batteries 100 possessed by the user.

FIG. 11 is a diagram illustrating an example of a display on the display unit 304 of the collection and delivery person terminal 300. An example of a case in which the user information is displayed on the display unit 304 is shown in FIG. 11.

In the case that the user information is received by the communication unit 308 of the collection and delivery person terminal 300, the information providing unit 316 of the collection and delivery person terminal 300 is capable of causing there to be displayed on the display unit 304 a display screen 304a, for example, as shown in FIG. 11. The map MP, the graphic 600, and a graphic 602 are capable of being displayed on the display screen 304a. The graphic 600 and the graphic 602 can be displayed on the map MP. The graphic 600 indicates the user position. The graphic 602 indicates the residual capacity of the mobile battery or batteries 100 possessed by the user.

The graphic 602 changes, for example, the color, the size, or the like thereof in accordance with the residual capacity of the mobile battery or batteries 100 possessed by the user. In the example shown in FIG. 11, the graphic 602 represents a residual capacity meter that indicates the residual capacity of the mobile battery or batteries 100. The example shown in FIG. 11 illustrates that the larger the number of colored portions (blackened portions) in a graphic 602 becomes, the larger the residual capacity of the mobile battery or batteries 100 is. A graphic or graphics 602 corresponding to the number of the mobile battery or batteries 100 possessed by the user can be displayed on the display screen 304a. More specifically, the number of the graphics 602 indicates the number of the mobile battery or batteries 100 possessed by the user.

The color, the size, or the like of the graphic 600 indicating the user position may change in accordance with the residual capacity of the mobile battery or batteries 100 possessed by the user, or the residual capacity of the mobile battery or batteries 100 possessed by the collection and delivery person. For example, the color, the size, or the like of the graphic 600 indicating the user position may change depending on whether or not the residual capacity of the mobile battery or batteries 100 possessed by the user shown by the graphic 600 is lower than the residual capacity of the mobile battery or batteries 100 that the collection and delivery person is capable of delivering. In accordance with this feature, the collection and delivery person can easily find, for example, a user for which the possibility to request the delivery of the mobile battery or batteries 100 is high. In this case, the information generating unit 418 generates the user information, based on the information indicating the residual capacity of the mobile battery or batteries 100 possessed by the user, and the information indicating the residual capacity of the mobile battery or batteries 100 that the collection and delivery person is capable of delivering. The collection and delivery person terminal 300 (the computation unit 310) may change the color, the size, or the like of the graphic 600 that is specified by the user information, based on the information indicating the residual capacity of the mobile battery or batteries 100 possessed by the user, and the information indicating the residual capacity of the mobile battery or batteries 100 that the collection and delivery person is capable of delivering. The color, the size, or the like of the graphic 602 indicating the residual capacity of the mobile battery or batteries 100 possessed by the user may change in accordance with the residual capacity of the mobile battery or batteries 100 possessed by the user, or the residual capacity of the mobile battery or batteries 100 possessed by the collection and delivery person.

The color, the size, or the like of the graphic 600 indicating the user position may change in accordance with the number of the mobile battery or batteries 100 possessed by the user, or the number of the mobile battery or batteries 100 that are capable of being collected by the collection and delivery person. In that case, it is preferable that the color, the size, or the like of the graphic 600 changes depending on the number of the mobile battery or batteries 100 that the user wishes to have collected, or the number of the mobile battery or batteries 100 that the collection and delivery person is capable of collecting. For example, it is preferable that the color, the size, or the like of the graphic 600 change depending on whether or not the collection and delivery person is capable of collecting all of the mobile battery or batteries 100 that the user shown by the graphic 600 wishes to have collected. In accordance with this feature, the collection and delivery person can easily find a user for which the possibility to request the collection of the mobile battery or batteries 100 is high. In this case, the information generating unit 418 generates the collection and delivery person information, based on the information indicating the number of the mobile battery or batteries 100 possessed by the user, and the information indicating the number of the mobile battery or batteries 100 that the collection person is capable of collecting. The collection and delivery person terminal 300 (the computation unit 310) may change the color, the size, or the like of the graphic 600 that is specified by the user information, based on the information indicating the number of the mobile battery or batteries 100 possessed by the user, and the information indicating the number of the mobile battery or batteries 100 that the collection and delivery person is capable of collecting. The color, the size, or the like of the graphic 602 indicating the residual capacity of the mobile battery or batteries 100 possessed by the user may change in accordance with the number of the mobile battery or batteries 100 possessed by the user, or the number of the mobile battery or batteries 100 that the collection and delivery person is capable of collecting.

A graphic 604 and a graphic 606 can further be displayed on the display screen 304a. The graphic 604 and the graphic 606 can be displayed on the map MP. The graphic 604 indicates the collection and delivery person position. More specifically, the graphic 604 of FIG. 11 indicates the position of the collection and delivery person terminal 300 that is equipped with the display unit 304 on which the display screen 304a of FIG. 11 is displayed. The graphic 606 indicates the residual capacity of the mobile battery or batteries 100 possessed by the collection and delivery person. A number of the graphics 606 corresponding to the number of the mobile battery or batteries 100 possessed by the collection and delivery person can be displayed on the display screen 304a. More specifically, the number of the graphics 606 indicates the number of the mobile battery or batteries 100 possessed by the collection and delivery person.

The graphic 606 changes, for example, the color, the size, or the like thereof in accordance with the residual capacity of the mobile battery or batteries 100 possessed by the collection and delivery person. For example, the graphic 606 of FIG. 11 represents a residual capacity meter that indicates the residual capacity of the mobile battery or batteries 100. FIG. 11 shows that the larger the number of colored portions (blackened portions) in the graphic 606 of FIG. 11 becomes, the larger the residual capacity of the mobile battery or batteries 100 is.

Although the description of FIG. 11 is as described above, the information that is capable of being displayed on the display screen 304a for the collection and delivery person is not necessarily limited to the content shown in FIG. 11. This point will be described later in accordance with the necessity thereof.

As noted previously, the computation unit 210 of the user terminal 200 may include the request information generating unit 218. The request information generating unit 218 generates the request information. The request information is information concerning a collection and delivery request for the mobile battery or batteries 100. In the case that the user requires delivery of the mobile battery or batteries 100, in the request information, there can be included, for example, the user identification information, and the number of the mobile battery or batteries 100 required by the user. In the case that the user requires delivery of the mobile battery or batteries 100, the request information may further include information indicating the residual capacity of the mobile battery or batteries 100 required by the user. The user identification information, as noted previously, is information that is unique to the user. In the case that the user requires delivery of the mobile battery or batteries 100, the request information may further include information indicating the type of the mobile battery or batteries 100 required by the user. In the case that the user requires collection of the mobile battery or batteries 100, in the request information, there can be included, for example, the user identification information, and the number of the mobile battery or batteries 100 that the user wishes to have collected. In the case that the user requires collection of the mobile battery or batteries 100, the request information may further include information indicating the type of the mobile battery or batteries 100 that the user requires to be collected. The user can use the operation unit 202 of the user terminal 200, and can thereby appropriately input to the user terminal 200 the information required in order for the request information generating unit 218 to generate the request information.

The request information may include information in order for the user to designate the collection and delivery person from whom the user wishes to request the collection and delivery of the mobile battery or batteries 100. For example, in the case that the user has selected one person from among a plurality of collection and delivery persons (delivery persons) that are displayed on the display screen 204a shown in FIG. 8, the collection and delivery person identification information indicating the collection and delivery person who was selected may be included in the request information. As noted previously, the collection and delivery person identification information is information that is unique to the collection and delivery person. Further, for example, in the case that the user has selected one person from among a plurality of collection and delivery persons (collection persons) that are displayed on the display screen 204b shown in FIG. 9, the collection and delivery person identification information indicating the delivery person who was selected may be included in the request information.

The request information that was input by the user to the user terminal 200 is transmitted by the control unit 214 of the user terminal 200, via the communication unit 208, to the management device 400. The request information that was transmitted from the user terminal 200 is received by the communication unit 402 of the management device 400.

In the case that the communication unit 402 has received the request information, the information generating unit 418 of the management device 400 generates the user information, based not only on the user position information and the collection and delivery person position information, but also on the request information. The user position information is information that indicates the position of the user who has requested the collection and delivery of the mobile battery or batteries 100. The collection and delivery person position information is information that indicates the position of the delivery person who is capable of collecting and delivering the mobile battery or batteries 100 to the user who has requested the collection and delivery of the mobile battery or batteries 100. The request information, as noted previously, can include information indicating the number, the residual capacity, and the like of the mobile battery or batteries 100 that the user requires to be collected and delivered.

The above-described user information that is generated based on not only the user position information and the collection and delivery person position information, but also the request information, in the following description, is also referred to as requesting user information. The requesting user information is transmitted by the control unit 408, via the communication unit 402, to the collection and delivery person terminal 300. The control unit 408 can transmit the requesting user information to the collection and delivery person terminal 300 possessed by the delivery person who is positioned within a predetermined range from the user who has requested the collection and delivery of the mobile battery or batteries 100. Moreover, as noted previously, in the request information, there can be included information in order for the user to designate the collection and delivery person from whom the user has requested the collection and delivery of the mobile battery or batteries 100. In this case, the control unit 408 can at least carry out the transmission of the requesting user information to the collection and delivery person terminal 300 possessed by the collection and delivery person who was designated by the user.

The collection and delivery person terminal 300 is capable of receiving the requesting user information by way of the communication unit 308. In the case that the communication unit 308 of the collection and delivery person terminal 300 has received the requesting user information, the information providing unit 316 of the collection and delivery person terminal 300 provides the requesting user information to the collection and delivery person. For example, the information providing unit 316, together with causing the map MP to be displayed on the display unit 304 of the collection and delivery person terminal 300, also causes a graphic indicating the position of the user who has requested the collection and delivery of the mobile battery or batteries 100 to be displayed on the map MP.

In the case that the requesting user information has been received by the communication unit 308 of the collection and delivery person terminal 300, the information providing unit 316 may cause there to be displayed on the display unit 304 a pop-up window in order to issue a notification to the collection and delivery person, to the effect that the requesting user information has been received. Consequently, the collection and delivery person can easily grasp that the user has requested that the collection and delivery person collect and deliver the mobile battery or batteries 100. In the case that the requesting user information has been received by the communication unit 308, the information providing unit 316 may output from a speaker of the collection and delivery person terminal 300 a voice prompt in order to issue a notification to the collection and delivery person, to the effect that the requesting user information has been received. In this case as well, the collection and delivery person can easily grasp that the user has requested that the collection and delivery person collect and deliver the mobile battery or batteries 100.

As noted previously, in the request information, there can be included information indicating the number of the mobile battery or batteries 100 that the user requires to be collected and delivered. In this case, the information generating unit 418 may generate the requesting user information, based on the information indicating the number of the mobile battery or batteries 100 that the user requires to be collected and delivered, and the information indicating the number of the mobile battery or batteries 100 that the collection and delivery person is capable of collecting and delivering. For example, the information generating unit 418 selects the collection and delivery person who is capable of delivering a number of the mobile battery or batteries 100 that is greater than or equal to the number of the mobile battery or batteries 100 that the user requests to be delivered. The information generating unit 418, using the collection and delivery person position information indicating the position of the collection and delivery person who was selected, generates the requesting user information. The control unit 408 transmits the requesting user information to the collection and delivery person terminal 300 of the collection and delivery person who was selected. Further, the information generating unit 418 selects the collection and delivery person who is capable of collecting a number of the mobile battery or batteries 100 that is greater than or equal to the number of the mobile battery or batteries 100 that the user requests to be delivered. The information generating unit 418, using the collection and delivery person position information indicating the position of the collection and delivery person who was selected, generates the requesting user information. The control unit 408 transmits the requesting user information to the collection and delivery person terminal 300 of the collection and delivery person who was selected. If carried out in this manner, the requesting user information can be provided only to a collection and delivery person who is capable of accepting the request order from the user.

Further, as noted previously, in the request information, there may be included information indicating the residual capacity of the mobile battery or batteries 100 that the user requires to be collected and delivered. In this case, the information generating unit 418 may generate the requesting user information, based on the information indicating the residual capacity of the mobile battery or batteries 100 that the user requires to be collected and delivered, and the information indicating the residual capacity of the mobile battery or batteries 100 that the collection and delivery person is capable of delivering. For example, the information generating unit 418 selects the collection and delivery person who is capable of delivering the mobile battery or batteries 100 having a residual capacity that is greater than or equal to that of the mobile battery or batteries 100 that the user requests to be delivered. The information generating unit 418, using the collection and delivery person position information indicating the position of the collection and delivery person who was selected, generates the requesting user information. The control unit 408 transmits the requesting user information to the collection and delivery person terminal 300 of the collection and delivery person who was selected. If carried out in this manner, the requesting user information can be provided only to a collection and delivery person who is capable of accepting the request order from the user.

As noted previously, in the request information, there may be included information indicating the type of the mobile battery or batteries 100 that the user requires to be collected and delivered. In this case, the information generating unit 418 may generate the requesting user information, based on the information indicating the type of the mobile battery or batteries 100 that the user requires to be collected and delivered, and the information indicating the type of the mobile battery or batteries 100 that the collection and delivery person is capable of collecting and delivering. For example, the information generating unit 418 selects a collection and delivery person who is capable of delivering the type of the mobile battery or batteries 100 requested by the user. The information generating unit 418, using the collection and delivery person position information indicating the position of the collection and delivery person who was selected, generates the requesting user information. The control unit 408 transmits the requesting user information to the collection and delivery person terminal 300 of the collection and delivery person who was selected. Further, for example, the information generating unit 418 selects a collection and delivery person who is capable of collecting the type of the mobile battery or batteries 100 requested by the user. The information generating unit 418, using the collection and delivery person position information indicating the position of the collection and delivery person who was selected, generates the requesting user information. The control unit 408 transmits the requesting user information to the collection and delivery person terminal 300 of the collection and delivery person who was selected. If carried out in this manner, the requesting user information can be provided only to a collection and delivery person who is capable of accepting the request order from the user.

As noted previously, the computation unit 310 of the collection and delivery person terminal 300 can be equipped with the request order receiving unit 318. The request order receiving unit 318 causes there to be displayed on the display unit 304 an operation screen in order for the collection and delivery person to select whether or not to receive the request order from the user. For example, as noted previously, a graphic indicating the position of the user who has requested the collection and delivery of the mobile battery or batteries 100 can be displayed on the display screen 304a. In the case that the delivery person has tapped on the graphic, the request order receiving unit 318 causes there to be displayed on the display unit 304 the operation screen in order for the collection and delivery person to select whether or not to accept the request order from the user. The collection and delivery person can use the operation screen, and thereby can provide a response as to whether or not to accept the request order from the user. The request order receiving unit 318 transmits to the management device 400, via the communication unit 308, a notification indicating the response result as to whether or not the collection and delivery person will accept the request order from the user. In the following description, such a notification is also referred to as a response notification.

In the case that the content of the response notification transmitted from the collection and delivery person terminal 300 is a response to the effect that the request order from the user has been accepted, the control unit 408 transmits a notification to the user terminal 200 of the user who has transmitted the request information, to the effect that the request has been accepted. Consequently, the user can grasp the fact that the request order from the user has been accepted by the collection and delivery person.

Provisionally, in the case that there was not a collection and delivery person willing to accept the request order from the user, the control unit 408 transmits to the user terminal 200 of the user who has transmitted the request order, a notification to the effect that the request order has not been accepted. Consequently, it is possible for the user to grasp the fact that the request order from the user has not been accepted by the collection and delivery person. For example, in the case that an operation is not performed in order to accept the request order at any one of the plurality of collection and delivery person terminals 300 that have received the requesting user information, the control unit 408 transmits a notification to the user terminal 200 of the user who has transmitted the request information, to the effect that the request has not been accepted. More specifically, in the case that a response to the effect that the request has been accepted has not been received within a predetermined time period from having transmitted the requesting user information, the control unit 408 transmits a notification to the user terminal 200 of the user who has transmitted the request information, to the effect that the request has not been accepted.

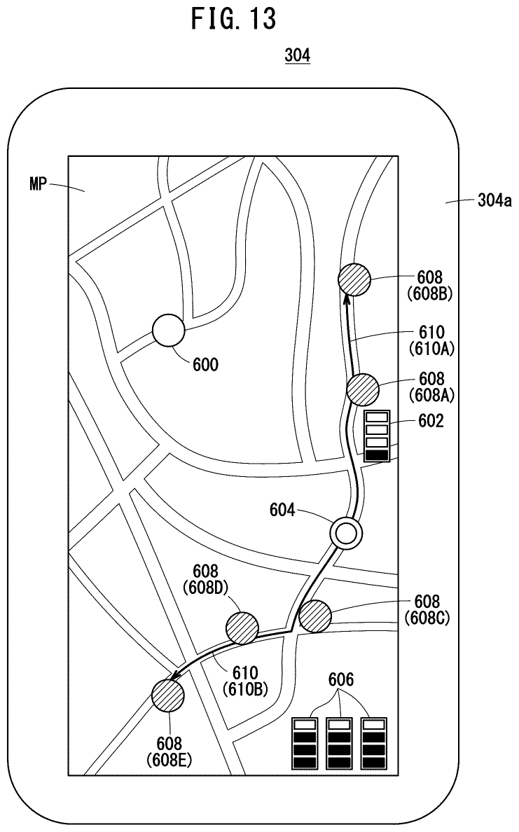

In the case that the management device 400 has received the request information, the information generating unit 418 of the management device 400 may generate not only the requesting user information, but also route candidate information. The route candidate information is information that indicates candidates for a collection and delivery route for the mobile battery or batteries 100. The route candidate information can be generated, based on the user position information, the collection and delivery person position information, and the map information. The information generating unit 418 may generate a plurality of the delivery route candidates with respect to one user. In the case that a plurality of users have requested the collection and delivery of the mobile battery or batteries 100, the information generating unit 418 may include in the route candidate information, information indicating potential collection and delivery routes along which the collection and delivery person can sequentially collect and deliver the mobile battery or batteries 100 with respect to the plurality of users (refer also to FIG. 13).

In the case of generating the route candidate information, the information generating unit 418 may select the candidates for the collection and delivery route based on predetermined conditions. For example, the information generating unit 418 may select, as the collection and delivery route candidate, a route in which the travel distance of the collection and delivery person lies within a predetermined distance. Further, the information generating unit 418 may select, as the collection and delivery route candidate, a route in which the travel time period of the collection and delivery person lies within a predetermined time period.

The route candidate information generated by the information generating unit 418 can be transmitted, via the communication unit 402, to the collection and delivery person terminal 300. Consequently, the information providing unit 316 of the collection and delivery person terminal 300 is capable of providing to the collection and delivery person the route candidate information that the collection and delivery person terminal 300 has received from the management device 400. The collection and delivery person, in view of the route candidate information provided by the information providing unit 316, can determine whether or not to accept the request order from the user.

Moreover, it should be noted that there are cases in which the user or the collection and delivery person designates a mutual meeting location. In that case, the information generating unit 418 may generate the route candidate information based on the designated meeting location. A more detailed description of the meeting location will be given later.

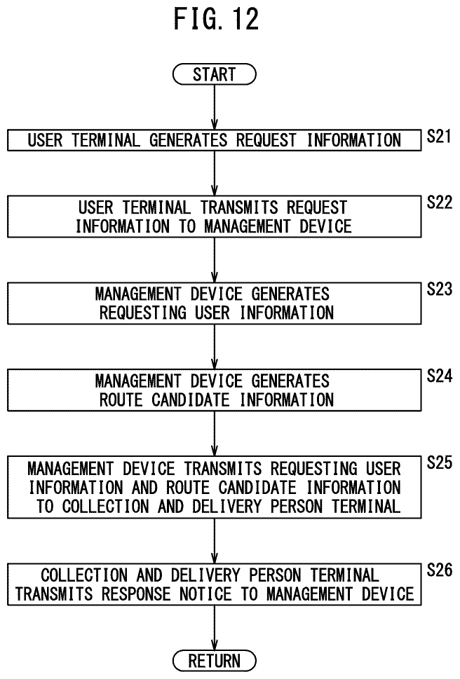

FIG. 12 is a flowchart illustrating an example of operations of the management system 16. An example of receiving the collection and delivery request for the mobile battery or batteries 100 is shown in FIG. 12.

In step S21, the user terminal 200 generates the request information. More specifically, the request information generating unit 218 provided in the user terminal 200 generates the request information in response to an operation of the user. The generated request information, in step S22, is transmitted, via the communication unit 208, to the management device 400.

Next, the process transitions to step S23, whereupon using the request information, the management device 400 generates the requesting user information. More specifically, the information generating unit 418 provided in the management device 400 generates the requesting user information, based on the user position information, the collection and delivery person position information, and the request information. Moreover, the user position information and the delivery person position information are appropriately acquired by the position information acquisition unit 412.

Next, the process transitions to step S24, whereupon the management device 400 generates the route candidate information, based on the user position information, the collection and delivery person position information, and the map information. More specifically, the information generating unit 418 provided in the management device 400 generates the route candidate information, based on the user position information, the collection and delivery person position information, and the map information. Moreover, the map information can be stored beforehand in the storage unit 406 of the management device 400.

Next, the process transitions to step S25, whereupon the requesting user information and the route candidate information are transmitted to the collection and delivery person terminal 300 from the communication unit 402 of the management device 400. The requesting user information and the route candidate information are transmitted via the communication unit 402 of the management device 400. Further, the requesting user information and the route candidate information are received by the communication unit 308 of the collection and delivery person terminal 300. The requesting user information and the route candidate information that are received by the collection and delivery person terminal 300 are provided by the information providing unit 316 to the collection and delivery person.

Next, the process transitions to step S26, whereupon the collection and delivery person terminal 300 transmits a response notice to the management device 400. More specifically, the request order receiving unit 318 of the collection and delivery person terminal 300, together with generating the response notice in response to an operation by the collection and delivery person, the communication unit 308 of the collection and delivery person terminal 300 transmits the response notice to the management device 400. In this manner, the operations illustrated in FIG. 12 come to an end. Moreover, as noted previously, the response notice is a notice indicating the response result as to whether or not the collection and delivery person will accept the request order from the user.

FIG. 13 is a diagram illustrating an example of a display on the display unit 304 of the collection and delivery person terminal 300. An example of a case in which the route candidate information is displayed together with the requesting user information is shown in FIG. 13.

By the collection and delivery person terminal 300 receiving the requesting user information, a graphic 608 can further be displayed on the display screen 304a of the display unit 304. The graphic 608 can be displayed on the map MP. The graphic 608 indicates the position of the user who has requested the collection and delivery of the mobile battery or batteries 100. A plurality of the graphics 608 (608A to 608E) may be displayed on the display screen 304a. Moreover, a graphic indicating the number, the residual capacity, and the like of the mobile battery or batteries 100 that the user indicated by each of the graphics 608 wishes to have collected and delivered may further be displayed on the display screen 304a. In the case that the collection and delivery person has tapped on the graphic 608, the details of the request content from the user indicated by the graphic 608 may be displayed on the display unit 304.

Moreover, as noted previously, the graphic 600 can be displayed on the display screen 304a. In FIG. 13, the graphic 600 indicates the position of a user who has not requested the collection and delivery of the mobile battery or batteries 100. It is preferable that the graphic 600 and the graphic 608 differ from each other in at least one from among the shape, the color, the size, and the like thereof, in a manner so that the collection and delivery person can easily distinguish between the user or users who have requested the collection and delivery of the mobile battery or batteries 100, and the user or users who have not requested the collection and delivery of the mobile battery or batteries 100. The graphic 608 may be highlighted on the display screen 304a. For example, the graphic 608 may be displayed in a blinking manner, without the graphic 600 being displayed in a blinking manner.

By the collection and delivery person terminal 300 receiving the route candidate information, a graphic 610 can further be displayed on the display screen 304a of the display unit 304. The graphic 610 can be displayed on the map MP. The graphic 610 indicates candidates for the aforementioned collection and delivery route. A plurality of the graphics 610 (610A, 610B) may be displayed on the display screen 304a. In the example shown in FIG. 13, a combination of the users for which the collection and delivery of the mobile battery or batteries 100 can be performed on the collection and delivery route indicated by the graphic 610A, and the combination of the users for which the collection and delivery of the mobile battery or batteries 100 can be performed on the collection and delivery route indicated by the graphic 610B differ from each other. For example, the graphic 610A shows candidates for the collection and delivery route for carrying out the collection and delivery of the mobile battery or batteries 100 with respect to the user shown by the graphic 608A, and the user shown by the graphic 608B. In contrast thereto, the graphic 610B shows candidates for the collection and delivery route for carrying out the collection and delivery of the mobile battery or batteries 100 with respect to the user shown by the graphic 608C, the user shown by the graphic 608D, and the user shown by the graphic 608E.

According to the display screen 304a shown in FIG. 13, the collection and delivery person can confirm the position of the user who has requested the collection and delivery of the mobile battery or batteries 100, and the candidates for the collection and delivery route for carrying out the collection and delivery of the mobile battery or batteries 100 with respect to the user. In view of the candidates for the delivery route, the number of users positioned on the delivery routes, and the like, the collection and delivery person is capable of determining whether or not to accept the request order from the user.

Upon receiving the request order from the user, the collection and delivery person carries out the collection and delivery of the mobile battery or batteries 100 with respect to the user. For example, the collection and delivery person who has received a delivery request order for the mobile battery or batteries 100 travels to the position where the user is positioned, and hands over the mobile battery or batteries 100 to the user. Further, for example, the collection and delivery person who has received a collection request order for the mobile battery or batteries 100 travels to the position where the user is positioned, and collects the mobile battery or batteries 100 from the user.

Incidentally, there may be cases in which the user wishes to designate a mutual meeting location. In consideration of this feature, the information providing unit 216 of the user terminal 200 may cause there to be displayed on the display unit 204 of the user terminal 200 an operation screen in order for the user to designate the delivery location.

The delivery location is the location at which the delivery of the mobile battery or batteries 100 to the user is carried out. The operation screen in order for the user to designate the delivery location may be the display screen 204a shown in FIG. 8. In this case, for example, the user can tap on an arbitrary point on the map MP shown on the display screen 204a, and can thereby designate the delivery location. Information indicating the delivery location designated by the user is transmitted to the collection and delivery person terminal 300. The information providing unit 316 of the collection and delivery person terminal 300 causes there to be displayed on the display unit 304, for example, the delivery location designated by the user. In accordance with this feature, the collection and delivery person is capable of grasping the delivery location, which is the location for meeting with the user.

Further, the information providing unit 216 of the user terminal 200 may cause there to be displayed on the display unit 204 of the user terminal 200 the operation screen in order for the user to designate the collection location. The collection location is the location at which the user hands over the mobile battery or batteries 100 to the collection and delivery person. The operation screen in order for the user to designate the collection location may be the display screen 204b shown in FIG. 9. In this case, for example, the user can tap on an arbitrary point on the map MP shown on the display screen 204b, and can thereby designate the collection location. Information indicating the collection location designated by the user is transmitted to the collection and delivery person terminal 300. The information providing unit 316 of the collection and delivery person terminal 300 causes there to be displayed on the display unit 304, for example, the collection location designated by the user. In accordance with this feature, the collection and delivery person is capable of grasping the collection location, which is the location for meeting with the user.

The collection and delivery person may designate the meeting location with the user. More specifically, the collection and delivery person may designate the delivery location or the collection location. In that case, the information providing unit 316 of the collection and delivery person terminal 300 causes there to be displayed on the display unit 304 of the collection and delivery person terminal 300 an operation screen in order for the collection and delivery person to designate the meeting location. The operation screen may be the display screen 304a of FIG. 11. In this case, for example, the collection and delivery person can tap on an arbitrary point on the map MP shown on the display screen 304a, and can thereby designate the meeting location. The information indicating the meeting location designated by the collection and delivery person is transmitted to the user terminal 200. The information providing unit 216 of the user terminal 200 causes there to be displayed on the display unit 204, for example, the meeting location designated by the collection and delivery person. In accordance with this feature, the user is capable of grasping the meeting location with the collection and delivery person. Moreover, there may be cases in which the user and the collection and delivery person designate meeting locations that are different from each other. Taking this into consideration, it may be possible for only one of the user and the collection and delivery person to be capable of designating the meeting location, while on the other hand, the other of the user and the collection and delivery person is allowed to select whether or not to accept such a designation.

As noted previously, the computation unit 404 of the management device 400 can be equipped with the suggestion unit 420. The suggestion unit 420 is capable suggesting a candidate for the aforementioned meeting location, based on at least one of the user position information and the collection and delivery person position information, and the map information. For example, the suggestion unit 420 can suggest as the candidate for the meeting location a midpoint between the user position and the collection and delivery person position. Further, the suggestion unit 420, for example, can suggest as the candidate for the meeting location a facility, a building, or the like existing in close proximity to the user position or the collection and delivery person position. The facility, the building, or the like can function as a landmark when the user is searching for the collection and delivery person, and together therewith, can also function as a landmark when the collection and delivery person is searching for the user. The suggestion unit 420 may use the aforementioned future user position as the user position information. The suggestion unit 420 may suggest a plurality of candidates for the meeting location. In the case that the route candidate information indicating a candidate collection and delivery route is provided to the collection and delivery person, the suggestion unit 420 may suggest any point on the collection and delivery route as the candidate for the meeting location. The number of the candidates for the meeting location may be one location, or may be a plurality of locations.

The information indicating the candidates for the meeting location suggested by the suggestion unit 420 can be transmitted by the control unit 408 of the management device 400, via the communication unit 402, to the user terminal 200. Consequently, the information providing unit 216 of the user terminal 200 is capable of providing to the user the information indicating the candidates for the meeting location. For example, the information providing unit 216, together with causing the map MP to be displayed on the display unit 204 of the user terminal 200, is capable of causing the graphic indicating the candidates for the meeting location to be displayed on the map MP. The user, from among the candidates displayed on the display unit 204, is capable of selecting the meeting location.

Further, the information indicating the candidates for the meeting location suggested by the suggestion unit 420 can be transmitted by the control unit 408 of the management device 400, via the communication unit 402, to the collection and delivery person terminal 300. Consequently, the information providing unit 316 of the collection and delivery person terminal 300 is capable of providing to the collection and delivery person the information indicating the candidates for the meeting location. For example, the information providing unit 316, together with causing the map MP to be displayed on the display unit 304 of the collection and delivery person terminal 300, is capable of causing the graphic indicating the candidates for the meeting location to be displayed on the map MP. The collection and delivery person, from among the candidates displayed on the display unit 304, is capable of selecting the meeting location.

Moreover, when a plurality of the candidates for the meeting location are provided to both the user and the collection and delivery person, there may be cases in which the user and the collection and delivery person designate meeting locations that are different from each other. Taking this into consideration, it may be possible for only one of the user and the collection and delivery person to be capable of designating the meeting location, while on the other hand, the other of the user and the collection and delivery person is allowed to select whether or not to accept such a designation.

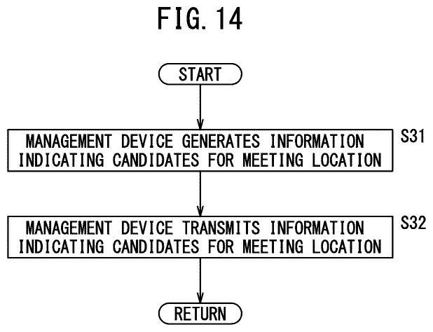

FIG. 14 is a flowchart illustrating an example of operations of the management system 16. An example of a case in which the meeting location is suggested is shown in FIG. 14.

The management system 16 is capable of executing step S31 and step S32 illustrated in FIG. 14. Step S31 and step S32 can be included in the management method according to the present embodiment.

In step S31, the information generating unit 418 of the management device 400 generates information indicating the candidates for the meeting location. Based on the user position information indicating the position of the user who has requested the collection and delivery of the mobile battery or batteries 100, and the collection and delivery person position information indicating the position of the collection and delivery person who has accepted the request order from the user, the information generating unit 418 is capable of generating the information indicating the candidates for the meeting location. More specifically, based on the user position information indicating the position of the user who has requested the collection and delivery of the mobile battery or batteries 100, and the collection and delivery person position information indicating the position of the collection and delivery person who has accepted the request order from the user, and the map information, the information generating unit 418 is capable of generating the information indicating the candidates for the meeting location. The user position information and the collection and delivery person position information, which are used by the information generating unit 418 in step S31, are appropriately acquired by the position information acquisition unit 412.

Next, the process transitions to step S32, whereupon the information indicating the candidates for the meeting location is transmitted from the management device 400. The information indicating the candidates for the meeting location is transmitted via the communication unit 402 of the management device 400. The information indicating the candidates for the meeting location can be received by the communication unit 208 of the user terminal 200 possessed by the user who has requested the collection and delivery of the mobile battery or batteries 100. The information indicating the candidates for the meeting location may be received by the communication unit 308 of the collection and delivery person terminal 300 possessed by the collection and delivery person who has accepted the request order from the user. In this manner, the operations illustrated in FIG. 14 come to an end.

The suggestion unit 420 may suggest, as the receiving location, a predetermined facility 20 where the collection and delivery person can place the mobile battery or batteries 100. The facility 20, for example, is a locker (refer also to FIG. 1) which is capable of storing the mobile battery or batteries 100, although the present invention is not necessarily limited to this feature. The facility 20 may be, for example, a battery holder that is capable of retaining the mobile battery or batteries 100. The battery holder may be a small scale container that is easy to install, for example, throughout the city. The facility 20 may be installed appropriately throughout the city, for example, by the operating business entity that operates the sharing system 10. The collection and delivery person can place the mobile battery or batteries 100 in the facility 20 that was suggested by the suggestion unit 420. On the other hand, the user can receive the mobile battery or batteries 100 that have been placed in the facility 20. In accordance with this feature, without coming face to face with the collection and delivery person, the user is capable of receiving the mobile battery or batteries 100.

In the case that the collection and delivery person suggests, as the receiving location, the predetermined facility 20 where it is possible to install the mobile battery or batteries 100, based on the user position information, the collection and delivery person position information, and information indicating the position of the facility 20, the suggestion unit 420 is capable of selecting the facility 20 to be used for receiving the mobile battery or batteries 100. Information indicating the position of the facility 20 can be included in the map information that is stored beforehand in the storage unit 406. Moreover, when selecting the facility 20 to be used for receiving the mobile battery or batteries 100, the suggestion unit 420 may use as the user position information the aforementioned future user position. The information indicating the position of the facility 20 that was selected is provided to the user by the information providing unit 216 of the user terminal 200. Further, the information indicating the position of the facility 20 that was selected is provided to the collection and delivery person by the information providing unit 316 of the collection and delivery person terminal 300.

The suggestion unit 420 may suggest the facility 20 as a collection location where the user can hand over the mobile battery or batteries 100 to the collection and delivery person. In this case, for example, the user can place in the facility 20 the mobile battery or batteries 100 that need to be collected by the collection and delivery person. The collection and delivery person is capable of collecting the mobile battery or batteries 100 that have been placed in the facility 20. In accordance with this feature, without coming face to face with the collection and delivery person, the user is capable of handing over the mobile battery or batteries 100 to the collection and delivery person.

The suggestion unit 420, at a stage prior to the user requesting the collection and delivery of the mobile battery or batteries 100, may suggest to the user the candidates for the meeting location. For example, as noted previously, on the display screen 204a of FIG. 8, there can be displayed the graphic indicating the collection and delivery persons who are capable of delivering the mobile battery or batteries 100 to the user. The suggestion unit 420, assuming a case in which the user has made a request to the collection and delivery person to collect and deliver the mobile battery or batteries 100, can suggest the candidates for the meeting location between the user and the collection and delivery person. In this case, the information providing unit 216 of the user terminal 200 can be made to display a graphic or the like on the display screen 204a indicating the candidates for the meeting location suggested by the suggestion unit 420. In accordance with this feature, in view of the candidates for the meeting location that were suggested, the user can select the collection and delivery person from whom to request the collection and delivery of the mobile battery or batteries 100.

The suggestion unit 420, at a stage prior to the collection and delivery person receiving the request order from the user, may suggest to the collection and delivery person the candidates for the meeting location. For example, as noted previously, on the display screen 304a shown in FIG. 11, there can be displayed the locations of the users who may require the collection and delivery of the mobile battery or batteries 100. The suggestion unit 420, assuming that the collection and delivery person has accepted the request order from the user, can suggest the candidates for the meeting location between the user and the collection and delivery person. In this case, the information providing unit 316 of the collection and delivery person terminal 300 can be made to display a graphic or the like on the display screen 304a indicating the candidates for the meeting location suggested by the suggestion unit 420. In accordance with this feature, in view of the candidates for the meeting location that were suggested, the collection and delivery person can determine whether or not to accept the request order from the user.

Further, the suggestion unit 420 may make a suggestion with respect to the user who may require the delivery of the mobile battery or batteries 100 that the user visit the battery station 12. In this case, the suggestion unit 420, based on the user position information, the information indicating the position of the battery station 12, and the information indicating the operating status of such a battery station 12, is capable of selecting the battery station 12 from which the user can receive the mobile battery or batteries 100. More specifically, the suggestion unit 420, based on the user position information, the information indicating the position of the battery station 12, and the information indicating the operating status of such a battery station 12, and the map information, is capable of selecting the battery station 12 from which the user can receive the mobile battery or batteries 100. The suggestion unit 420 can select the battery station 12 that is in operation within a specified range from the user position, and can suggest to the user that the user receive the mobile battery or batteries 100 that are disposed in such a battery station 12. The user position information can be appropriately acquired by the position information acquisition unit 412. Information indicating the position of the battery station 12 can be included in the map information that is stored beforehand in the storage unit 406. The information indicating the operating status of the battery station 12, for example, can be provided as appropriate to the management system 16 from the battery station 12. Alternatively, information indicating a planned operation (business schedule) of the battery station 12 can be stored beforehand by the storage unit 406 of the management device 400. When selecting the battery station 12 to be used for receiving the mobile battery or batteries 100, the suggestion unit 420 may use, as the user position information, the information indicating the future user position.

The information indicating the position of the battery station 12 that was selected by the suggestion unit 420 is transmitted via the communication unit 402 of the management device 400 to the user terminal 200. In accordance with this feature, the information providing unit 216 of the user terminal 200 is capable of providing to the user the information indicating the position of the battery station 12 that was selected by the suggestion unit 420. The information providing unit 216 can display, on the display screen 204a shown in FIG. 8, a graphic or the like indicating the position of the battery station 12 that was selected. Further, the information providing unit 216 may cause a text message to be displayed on the display screen 204a, which indicates that the mobile battery or batteries 100 are capable of being received at the battery station 12 shown on the display screen 204a. The user, by visiting the battery station 12 suggested by the suggestion unit 420, is capable of receiving the mobile battery or batteries 100 that have been placed in that battery station 12. Since the user is capable of receiving the mobile battery or batteries 100 that have been placed in the battery station 12, even in the case that a collection and delivery person to accept the request order from the user does not exist, the user is still capable of receiving the mobile battery or batteries 100.

The suggestion unit 420 can make a suggestion with respect to the user who may require the collection of the mobile battery or batteries 100 that the user visit the battery station 12. In this case as well, the suggestion unit 420, based on the user position information, the information indicating the position of the battery station 12, and the information indicating the operating status of such a battery station 12, is capable of selecting the battery station 12. More specifically, the suggestion unit 420, based on the user position information, the information indicating the position of the battery station 12, the information indicating the operating status of such a battery station 12, and the map information, is capable of selecting the battery station 12. The information providing unit 216 can display, on the display screen 204b shown in FIG. 9, a graphic or the like indicating the position of the battery station 12 that was selected by the suggestion unit 420. Further, the user may also hand over the mobile battery or batteries 100 at the battery station 12 that was suggested.

In the manner described above, according to the management system 16, the information concerning the collection and delivery person who is capable of carrying out the collection and delivery of the mobile battery or batteries 100 with respect to the user, can be provided to the user by using the user terminal 200.

Incidentally, there may be cases in which the user requires that the mobile battery or batteries 100 be collected and delivered with respect to a location where the device that the user manages as a management person is provided. More specifically, there may be cases in which the user requires that the mobile battery or batteries 100 be delivered to a location where the device is provided. Further, there may be cases in which the user requires that the mobile battery or batteries 100 that are connected to the device be collected. The device may not be positioned at the location where the user is positioned, but may be at a position that is sufficiently distanced from the location where the user is positioned. In consideration of this feature, the information generating unit 418 of the management device 400 may generate information concerning a collection and delivery person who is capable of carrying out the collection and delivery of the mobile battery or batteries 100 to a location where the device that the user manages as a management person is provided. The information concerning the collection and delivery person who is capable of carrying out the collection and delivery of the mobile battery or batteries 100 to the location where the device is provided, in the following description, is also referred to as collection and delivery person information for the device.

The delivery and collection person information for the device is generated based on the device position information, and the collection and delivery person position information. The device position information is information that indicates the device position, which is the position of the device that the user manages as the management person. The device position information can be appropriately input by the user to the user terminal 200. The device position information that was input to the user terminal 200 can be transmitted by the communication unit 208 to the management device 400. The device position information that was transmitted to the management device 400 can be acquired by the position information acquisition unit 412 of the management device 400. The collection and delivery person position information that was used in order to generate the collection and delivery person information for the device indicates the position of a collection and delivery person who is capable of carrying out the collection and delivery of the mobile battery or batteries 100 to the position where the device is provided. For example, a collection and delivery person who is in possession of the mobile battery or batteries 100 of a type that is capable of supplying electrical power to the device, and who is positioned within a predetermined range from the device position can be the collection and delivery person who is capable of carrying out the collection and delivery of the mobile battery or batteries 100 with respect to the location where the device is provided. Further, a collection and delivery person who is positioned within the predetermined range from the device position, which is the position of the device, can be the collection and delivery person who is capable of carrying out the collection of the mobile battery or batteries 100 that are connected to the device. The collection and delivery person information for the device, for example, includes information in order to cause the graphic indicating the position of the collection and delivery person to be displayed together with the map MP on the display unit 204 of the user terminal 200.

The collection and delivery person information for the device is transmitted, by way of the communication unit 402 of the management device 400, to the user terminal 200. In accordance therewith, the information providing unit 216 of the user terminal 200 is capable of providing to the user the collection and delivery person information for the device. For example, the information providing unit 216, together with causing the map MP to be displayed on the display unit 204, causes there to be displayed on the map MP the graphic indicating the position of the collection and delivery person who is capable of carrying out the collection and delivery of the mobile battery or batteries 100 with respect to the position where the device is provided.

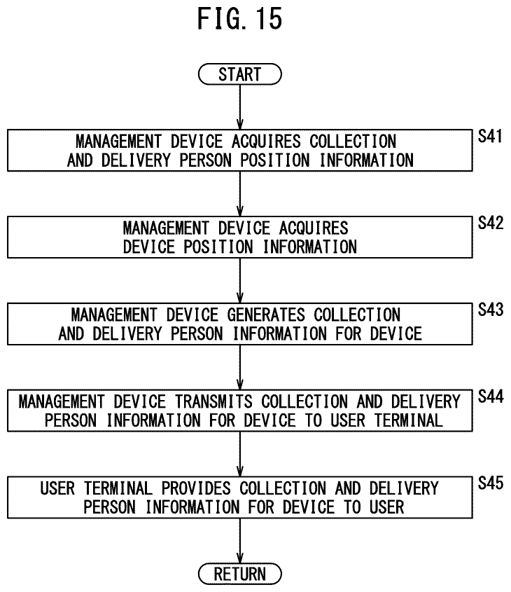

FIG. 15 is a flowchart illustrating an example of operations of the management system 16. FIG. 15 shows an example of a case in which the collection and delivery person information for the device is provided to the user who is a management person of the device.

In step S41, the position information acquisition unit 412 of the management device 400 acquires the collection and delivery person position information. Further, in step S42, the position information acquisition unit 412 of the management device 400 acquires the device position information.

Next, the process transitions to step S43, whereupon the information generating unit 418 of the management device 400 generates the collection and delivery person information for the device. The information generating unit 418, based on the device position information and the collection and delivery person position information, generates the collection and delivery person information for the device.

Next, the process transitions to step S44, whereupon the communication unit 402 of the management device 400 transmits the collection and delivery person information for the device generated in step S43 to the user terminal 200.

Next, the process transitions to step S45, whereupon the information providing unit 216 of the user terminal 200 provides to the user the information that was transmitted in step S44 to the user terminal 200. For example, together with displaying the map MP on the display unit 204, the information providing unit 216 causes a graphic indicating the collection and delivery person position to be displayed on the map MP. In this manner, the operations illustrated in FIG. 15 come to an end.

Moreover, in the case that the user requires the delivery of the mobile battery or batteries 100 that are capable of supplying electrical power to the device, the information providing unit 216 may further provide to the user the information indicating the residual capacity of the mobile battery or batteries 100 that are capable of being delivered by the collection and delivery person. More specifically, the information providing unit 216 may further provide to the user the information indicating the residual capacity of the mobile battery or batteries 100 that are capable of supplying the electrical power to the device. The information providing unit 216 may cause there to be displayed on the display unit 204, for example, the aforementioned graphic 504 that was described above with reference to FIG. 8 (refer also to FIG. 16). The graphic 504 changes, for example, the color, the size, or the like thereof in accordance with the residual capacity of the mobile battery or batteries 100 possessed by the collection and delivery person.

Moreover, in the case that the user requires the collection of the mobile battery or batteries 100 that are connected to the device, the information providing unit 216 may further provide to the user the information indicating the residual capacity of the mobile battery or batteries 100. The information providing unit 216 causes the display unit 204 to display, for example, a graphic 512 indicating the residual capacity of the mobile battery or batteries 100 that are connected to the device (refer also to FIG. 16). The graphic 512 changes, for example, the color, the size, or the like thereof in accordance with the residual capacity of the mobile battery or batteries 100 that are connected to the device. The information indicating the residual capacity of the mobile battery or batteries 100 that are connected to the device can be appropriately acquired by the battery information acquisition unit 416.

FIG. 16 is a diagram illustrating an example of a display on the display unit 204 of the user terminal 200.

The information providing unit 216 of the user terminal 200 is capable of causing there to be displayed on the display unit 204, for example, a display screen 204c illustrated in FIG. 16. The map MP, the graphic 500, the graphic 502, the graphic 504, and the graphic 508 are capable of being displayed on the display screen 204c. The graphic 500, the graphic 502, the graphic 504, and the graphic 508 can be displayed on the map MP. The graphic 500 indicates the collection and delivery person position. The number of the graphics 500 corresponding to the number of the collection and delivery persons who are capable of collecting and delivering the mobile battery or batteries 100 to the location where the device is provided can be displayed on the display screen 204c. The graphic 502 indicates the position of the user who is the management person of the device. The graphic 504 indicates the residual capacity of the mobile battery or batteries 100 that are capable of being delivered by the collection and delivery person indicated by the graphic 500. The number of the graphics 504 corresponding to the number of the mobile battery or batteries 100 possessed by the collection and delivery person can be displayed on the display screen 204c. The graphic 508 indicates that the collection and delivery person indicated by the graphic 500 is capable of collecting the mobile battery or batteries 100 as the collection person.

A graphic 510 and the graphic 512 can further be displayed on the display screen 204c. The graphic 510 and the graphic 512 can be displayed on the map MP. The graphic 510 indicates the aforementioned device position. In the example shown in FIG. 16, one graphic 510 is shown. A number of the graphics 510 corresponding to the number of the devices being managed by the user can be displayed on the display screen 204c. The graphic 512 indicates the residual capacity of the mobile battery or batteries 100 that are connected to the device. In the case that the mobile battery or batteries 100 are not connected to the device, the display of the graphic 512 may be omitted.

The graphic 512 changes, for example, the color, the size, or the like thereof in accordance with the residual capacity of the mobile battery or batteries 100 that are capacity of indicated by the graphic 512. For example, the graphic 512 shown in FIG. 16 represents a residual capacity meter that indicates the residual capacity of the mobile battery or batteries 100. FIG. 16 shows that the larger the number of colored portions (blackened portions) in the graphic 512 becomes, the larger the residual capacity of the mobile battery or batteries 100 is.

Based on the position of the graphic 500 displayed on the display screen 204c, the user can easily find a collection and delivery person who is capable of carrying out the collection and delivery of the mobile battery or batteries 100 with respect to the location where the device is provided. The user can request the collection and delivery of the mobile battery or batteries 100 with respect to the collection and delivery person who is shown on the display screen 204c. The user, using the user terminal 200 (the request information generating unit 218), is capable of requesting the collection and delivery of the mobile battery or batteries 100.

In addition, as noted previously, there can further be displayed on the display screen 204c the graphic 504 indicating the residual capacity of the mobile battery or batteries 100 possessed by the collection and delivery person. Accordingly, taking into consideration the residual capacity of the mobile battery or batteries 100 that each of the plurality of collection and delivery persons is capable of delivering, the user can determine from which of the collection and delivery persons to request the delivery of the mobile battery or batteries 100.

Further, based on the graphic 512 displayed on the display screen 204c, the user can easily grasp the residual capacity of the mobile battery or batteries 100 that are connected to the device. Consequently, taking into consideration the residual capacity of the mobile battery or batteries 100, the user is capable of determining whether or not to request that the mobile battery or batteries 100 be collected.

The display screen 204a shown in FIG. 8, and the display screen 204c shown in FIG. 16 may be displayed together on a single display screen. More specifically, the information providing unit 216 may display on a single display screen the collection and delivery person who is capable of delivering the mobile battery or batteries 100 to the location where the user is positioned, and the collection and delivery person who is capable of delivering the mobile battery or batteries 100 to the location where the device is provided. In that case, it is preferable that the shape, the color, the size, or the like of the graphic 500 indicating the collection and delivery person position be set, in accordance with whether the collection and delivery person is capable of delivering the mobile battery or batteries 100 to the location where the user is positioned, or whether the collection and delivery person is capable of delivering the mobile battery or batteries 100 to the location where the device is provided. In accordance with this feature, the user can easily distinguish between the collection and delivery person who is capable of delivering the mobile battery or batteries 100 to the location where the user is positioned, and the collection and delivery person who is capable of delivering the mobile battery or batteries 100 to the location where the device is provided.

The display screen 204b shown in FIG. 9, and the display screen 204c shown in FIG. 16 may be displayed together on a single display screen. More specifically, the information providing unit 216 may display on a single display screen the collection and delivery person who is capable of collecting the mobile battery or batteries 100 from the user, and the collection and delivery person who is capable of collecting the mobile battery or batteries 100 that are connected to the device. In that case, it is preferable that the shape, the color, the size, or the like of the graphic 500 indicating the collection and delivery person position be set, in accordance with whether the collection and delivery person is capable of collecting the mobile battery or batteries 100 from the user, or whether the collection and delivery person is capable of collecting the mobile battery or batteries 100 that are connected to the device. In accordance with this feature, the user can easily distinguish between the collection and delivery person who is capable of collecting the mobile battery or batteries 100 from the user, and the collection and delivery person who is capable of collecting the mobile battery or batteries 100 that are connected to the device.

In the manner described above, according to the management system 16, the information concerning the collection and delivery person, who is capable of carrying out the collection and delivery of the mobile battery or batteries 100 with respect to the location where the device that is managed by the user as the management person, can be provided to the user by using the user terminal 200.

Incidentally, from the perspective of the collection and delivery person, in order to receive as many request orders as possible, there may be cases in which the collection and delivery person wishes to grasp locations where request orders from the users can be easily received. In order to enable the collection and delivery person to grasp the locations where the request orders from the users are easily received, the management system 16 may be configured as follows.

As noted previously, in the computation unit 404 of the management device 400, there may be provided the past demand information generating unit 422 (refer to FIG. 5). The past demand information generating unit 422 generates past demand information. The past demand information is information that indicates the number of the collection and delivery requests for the mobile battery or batteries 100 in the past. More specifically, the past demand information is information that indicates the collection and delivery demand of the mobile battery or batteries 100 in the past. The past demand information can be generated based on the collection and delivery history of the mobile battery or batteries 100, and the conditions designated by the delivery person. As noted previously, the information indicating the collection and delivery history of the mobile battery or batteries 100 can be stored by the storage unit 406 of the management device 400. The conditions designated by the collection and delivery person can include, for example, at least one of a region designated by the collection and delivery person (XX Station, YY Park, or the like) and dates and times in the past that were designated by the collection and delivery person. Information indicating the conditions can be appropriately input to the collection and delivery person terminal 300 by the collection and delivery person. The collection and delivery person, using the operation unit 302, is capable of inputting to the collection and delivery person terminal 300 the information indicating the above-described conditions. The information that was input to the collection and delivery person terminal 300, together with being transmitted by the communication unit 308 to the management device 400, can also be acquired by the past demand information generating unit 422.

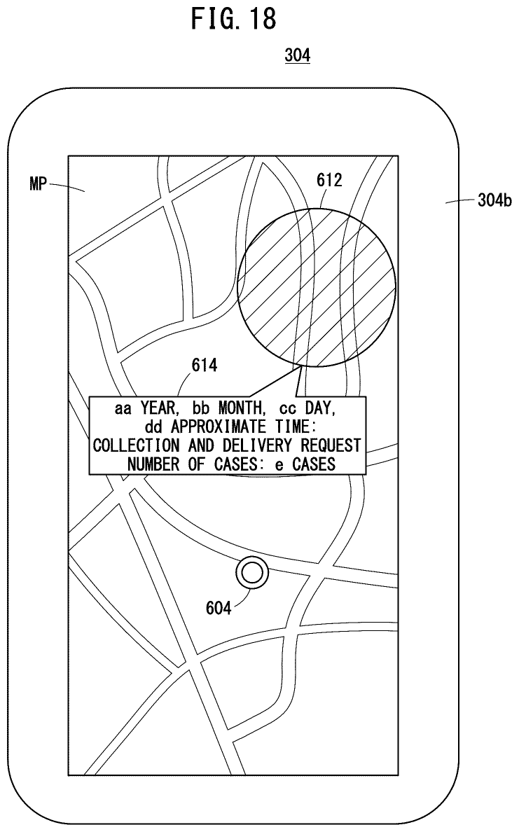

The past demand information generating unit 422 can generate the past demand information which indicates, for example, the collection and delivery demands (the number of the requests) that has been generated within the designated region at the designated date and time, based on the condition that was designated and the collection and delivery history. In this case, in the past demand information, there can be included information in order to cause there to be displayed on the display unit 304 of the collection and delivery person terminal 300 (refer also to FIG. 18), together with the map MP, a graphic indicating the collection and delivery demand that has been generated within the designated region at the specified date and time. The past demand information generating unit 422, in accordance with the collection and delivery demands (requests) that were generated within the designated region at the designated date and time, is capable of determining the form of the aforementioned graphic. Specifically, the past demand information generating unit 422 is capable of determining the color or the like of the aforementioned graphic, in accordance with whether or not the collection and delivery demands (requests) that were generated within the designated region at the designated date and time have become greater than or equal to a predetermined threshold value (a past collection and delivery demand threshold value). The past collection and delivery demand threshold value can be stored beforehand by the storage unit 406 of the management device 400.

The past demand information is transmitted by the control unit 408, via the communication unit 402, to the collection and delivery person terminal 300. The information providing unit 316 of the collection and delivery person terminal 300 that has received the past demand information can cause the past demand information to be displayed on the display unit 304. In accordance with this feature, the past demand information is provided to the collection and delivery person.

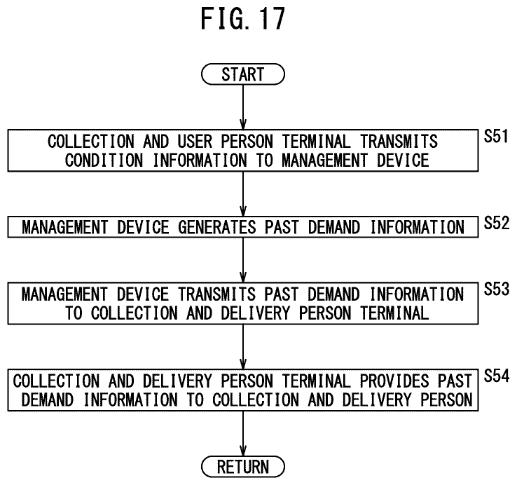

FIG. 17 is a flowchart illustrating an example of operations of the management system 16. An example of a case in which the past demand information is provided to the collection and delivery person is shown in FIG. 17.

In step S51, the communication unit 308 of the collection and delivery person terminal 300 transmits to the management device 400 the information (the condition information) indicating the conditions that were used in order to generate the past demand information. The information indicating the conditions that were used in order to generate the past demand information is input by the collection and delivery person using the collection and delivery person terminal 300.

Next, the process transitions to step S52, whereupon the past demand information generating unit 422 of the management device 400, based on the past collection and delivery history and the conditions specified by the collection and delivery person, generates the past demand information.

Next, the process transitions to step S53, whereupon the communication unit 402 of the management device 400 transmits to the collection and delivery person terminal 300 the past demand information generated by the past demand information generating unit 422.

Next, the process transitions to step S54, whereupon the information providing unit 316 of the collection and delivery person terminal 300 provides to the collection and delivery person the past demand information that was received from the communication unit 402. In this manner, the operations illustrated in FIG. 17 come to an end.

FIG. 18 is a diagram illustrating an example of a display on the display unit 304 of the collection and delivery person terminal 300. An example of a display screen 304b that is displayed on the display unit 304 of the collection and delivery person terminal 300 is shown in FIG. 18.

In the case that the past demand information is received by the collection and delivery person terminal 300, the information providing unit 316 of the collection and delivery person terminal 300 can cause there to be displayed on the display unit 304 of the collection and delivery person terminal 300 the display screen 304b as shown in FIG. 18. The map MP is capable of being displayed on the display screen 304b. A graphic 612 can further be displayed on the display screen 304b. The graphic 612 corresponds to a region designated as a condition by the collection and delivery person. The graphic 612 can be displayed in a manner corresponding to a collection and delivery demand that was generated at a designated date and time within the designated region. For example, the greater the number of the collection and delivery requests that are generated at the designated date and time, the higher a display density of the graphic 612 can be set. A collection and delivery person, by observing the display screen 304b, is capable of easily grasping the delivery demands that were made in the past. On the display screen 304b, there may further be displayed a pop-up window 614 indicating the generated number of the collection and delivery requests that were generated at the designated date and time, and in the region.

The information providing unit 316 may further cause the graphic 604 to be displayed on the display screen 304b. The graphic 604, as noted previously, indicates the collection and delivery person position.

As noted previously, the computation unit 404 of the management device 400 can be equipped with the collection and delivery demand prediction unit 424. The collection and delivery demand prediction unit 424 is capable of predicting a collection and delivery demand for the mobile battery or batteries 100 in the future. The future collection and delivery demand may be predicted, for example, based on the future user position, and the collection and delivery history. Moreover, as noted previously, the future user position is the future position of the user. The information indicating the future user position, as noted previously, can be predicted by the future position prediction unit 414.

The collection and delivery demand prediction unit 424 predicts the future collection and delivery demand, for example, on the assumption that the collection and delivery request for the mobile battery or batteries 100 will occur at the future position of the user who frequently requests the collection and delivery of the mobile battery or batteries 100. Whether or not a user frequently requests the collection and delivery of the mobile battery or batteries 100 can be determined based on the collection and delivery history. The collection and delivery demand prediction unit 424 can predict the future collection and delivery demand based on a plurality of the future user positions and the collection and delivery histories.

Moreover, it should be noted that the demands for the mobile battery or batteries 100 can become higher in a location where an unspecified large number of people gather. Taking this into consideration, the collection and delivery demand prediction unit 424 is capable of predicting the future collection and delivery demands based on an event implementation schedule. The event, for example, is a gathering that is carried out in a park, an open space, or the like. The collection and delivery demand prediction unit 424 is capable of predicting that the collection and delivery demands for the mobile battery or batteries 100 in the park or the like where the gathering is held will become higher during a period in which the gathering is carried out. The collection and delivery demand prediction unit 424 is capable of acquiring information indicative of the event implementation schedule from a website or the like via the network NW.

The control unit 408 can transmit to the collection and delivery person terminal 300, via the communication unit 402, information indicating the collection and delivery demands that were predicted by the collection and delivery demand prediction unit 424. Consequently, the information providing unit 316 of the collection and delivery person terminal 300 is capable of providing to the collection and delivery person the information indicating the future collection and delivery demands. Moreover, in the information indicating the collection and delivery demands predicted by the collection and delivery demand prediction unit 424, there can be included information in order to cause there to be displayed on the display unit 304 of the collection and delivery person terminal 300, together with the map MP, a graphic indicating the collection and delivery demands. In this case, the information providing unit 316, together with causing the map MP to be displayed on the display unit 304, is capable of causing the aforementioned graphic to be displayed on the map MP. The information in order to cause there to be displayed on the display unit 304, together with the map MP, the graphic indicating the future collection and delivery demands of the collection and delivery person terminal 300 is capable of being generated by the collection and delivery demand prediction unit 424. The collection and delivery demand prediction unit 424, in accordance with the collection and delivery demands that were predicted, is capable of determining the form of the aforementioned graphic. Specifically, the collection and delivery demand prediction unit 424 can determine the color or the like of the aforementioned graphic, in accordance with whether or not the collection and delivery demands that were predicted are greater than or equal to a predetermined threshold value (a collection and delivery demand threshold value). The collection and delivery demand threshold value can be stored beforehand by the storage unit 406 of the management device 400.

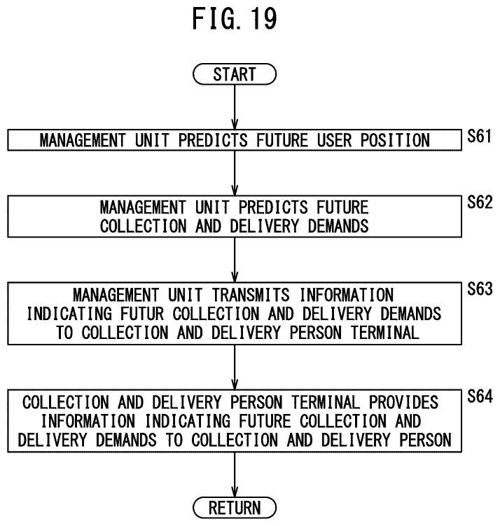

FIG. 19 is a flowchart illustrating an example of operations of the management system 16. An example of a case in which the information indicating the future collection and delivery demands are provided to the collection and delivery person is shown in FIG. 19.

In step S61, the future position prediction unit 414 of the management device 400 predicts the future user position. The future position prediction unit 414 predicts the future user position based on, for example, the user position information and the action plan of the user. The user position information can be appropriately acquired by the position information acquisition unit 412. As noted previously, the action plan of the user is appropriately transmitted by the user to the management device 400 using the user terminal 200.

Next, the process transitions to step S62, whereupon the collection and delivery demand prediction unit 424 of the management device 400 predicts the future collection and delivery demands. The collection and delivery demand prediction unit 424 predicts the future collection and delivery demand based on the future user position, and the collection and delivery history. The collection and delivery demand prediction unit 424 is capable of generating the information indicating the future collection and delivery demands that were predicted.

Next, the process transitions to step S63, whereupon the communication unit 402 of the management device 400 transmits to the collection and delivery person terminal 300 the information indicating the future collection and delivery demands that were predicted by the collection and delivery demand prediction unit 424.

Next, the process transitions to step S64, whereupon the information providing unit 316 of the collection and delivery person terminal 300 provides to the collection and delivery person the future collection and delivery demand information that was received from the communication unit 402. In this manner, the operations illustrated in FIG. 19 come to an end.

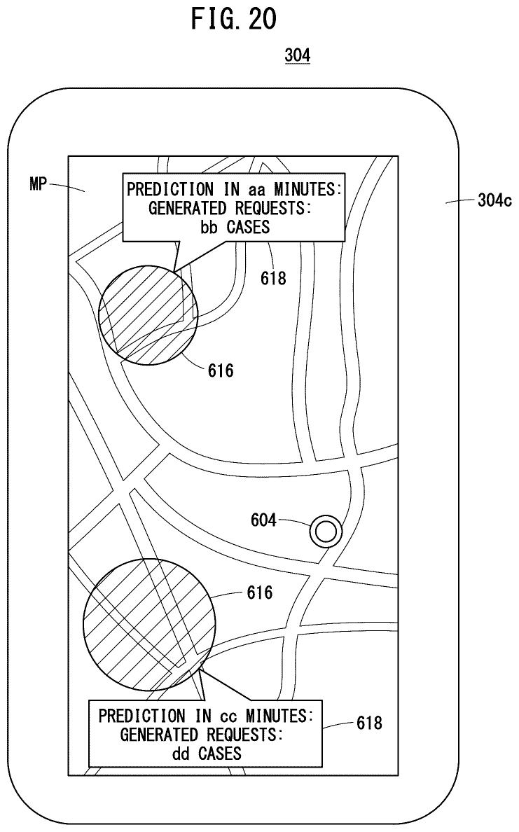

FIG. 20 is a diagram illustrating an example of a display on the display unit 304 of the collection and delivery person terminal 300.

The information providing unit 316 of the collection and delivery person terminal 300 that has received the information indicating the future collection and delivery demands is capable of causing there to be displayed, on the display unit 304 of the collection and delivery person terminal 300, for example, a display screen 304c as shown in FIG. 20. The map MP is capable of being displayed on the display screen 304c. A graphic 616 can further be displayed on the display screen 304c. The graphic 616 is displayed, for example, in a superimposed manner on a predetermined region on the map MP. The graphic 616 indicates the future collection and delivery demands in the region. The color, the size, or the like of the graphic 616 can be set in accordance with the collection and delivery demands that were predicted. The collection and delivery person, based on the graphic 616 displayed on the display screen 304c, is capable of easily grasping the future collection and delivery demands. On the display screen 304c, there may further be displayed a pop-up window 618 indicating the number of the collection and delivery requests that are expected to be generated in the future in the region indicated by the graphic 616.

The information providing unit 316 may further cause the graphic 604 to be displayed on the display screen 304c. The graphic 604, as noted previously, indicates the collection and delivery person position.

As noted previously, according to the management system 16, the collection and delivery person, taking into consideration the past collection and delivery demands, is capable of grasping the locations where the request orders from the users are easily received. Further, according to the management system 16, the collection and delivery person, taking into consideration the future collection and delivery demands, is capable of grasping the locations where the request orders from the users are easily received.

Incidentally, from the perspective of the user, there may be cases in which the user wishes to charge the mobile battery or batteries 100 possessed by the user. In consideration of this feature, the information generating unit 418 of the management device 400 may generate information concerning charging spots where the user is capable of carrying out charging with respect to the mobile battery or batteries 100 possessed by the user. Moreover, it should be noted that the charging spots may include locations equipped with public chargers, and locations equipped with public outlets to which users can connect their personal chargers. In the following description, the information regarding the charging spots where the user is capable of carrying out charging with respect to the mobile battery or batteries 100 possessed by the user is also referred to as charging spot information.

The charging spot information can be generated based on the user position information, and information indicating the positions of the charging spots. The user position information and the information indicating the positions of the charging spots can be acquired by the position information acquisition unit 412 of the management device 400. Moreover, the information indicating the positions of the charging spots can be included in the map information that is stored beforehand in the storage unit 406 of the management device 400. The information generating unit 418 can include, in the charging spot information, information indicating the charging spots within the predetermined range from the user position. Moreover, in the case of generating the charging spot information, the information generating unit 418 may use as the user position the aforementioned future user position. The future user position can be predicted by the future position prediction unit 414 of the management device 400.

The charging spot information generated by the information generating unit 418 can be transmitted to the user terminal 200 by the communication unit 402. The information providing unit 216 of the user terminal 200 that has received the charging spot information is capable of providing the charging spot information to the user. For example, the information providing unit 216, together with causing the map MP to be displayed on the display unit 204 of the user terminal 200, is capable of causing the graphic indicating the charging spots to be displayed on the map MP. In accordance with this feature, the user is capable of grasping the positions of the charging spots where charging can be carried out with respect to the mobile battery or batteries 100.

The information generating unit 418 may generate the charging spot information based not only on the user position information and the information indicating the positions of the charging spots, but also on the information indicating the operating status of the charging spots. The information generating unit 418 generates the charging spot information in a manner so that, for example, only the positions of the charging spots that are in operation from among the plurality of charging spots within the predetermined range from the user position are displayed on the display unit 204. The information indicating the operating status of the charging spots may be stored by the storage unit 406 of the management device 400. The information generating unit 418, instead of the operating status of the charging spots, may generate the charging spot information using the information indicating the operating status of facilities in which the charging spots are provided.

The information generating unit 418 may generate the charging spot information based not only on the user position information, and the information indicating the positions of the charging spots, but also on information indicating the usage history of the charging spots by the user. The information generating unit 418 is capable of generating the charging spot information, in a manner so that, for example, only the positions of the charging spots for which the usage frequency thereof by the user is comparatively high are displayed on the display unit 204. By providing the user with the charging spot information including the positions of the charging spots for which the usage frequency thereof by the user is comparatively high, the convenience for the user can be improved. Moreover, the information indicating the usage history of the charging spots may be stored by the storage unit 406 of the management device 400.

The charging spot information may include required time period information. The required time period information is information indicating an expected required time period in order to fully charge the mobile battery or batteries 100 possessed by the user. The information generating unit 418 may generate the required time period information, for example, using the information indicating the residual capacity of the mobile battery or batteries 100 possessed by the user. The information indicating the residual capacity of the mobile battery or batteries 100 possessed by the user can be acquired by the battery information acquisition unit 416 of the management device 400.

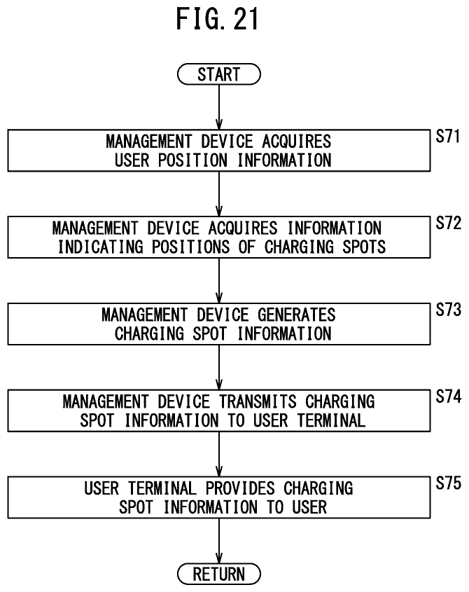

FIG. 21 is a flowchart illustrating an example of operations of the management system 16. An example of a case in which the charging spot information is provided to the user is shown in FIG. 21.

In step S71, the position information acquisition unit 412 of the management device 400 acquires the user position information. Further, in step S72, the position information acquisition unit 412 of the management device 400 acquires the information indicating the positions of the charging spots.

Next, the process transitions to step S73, whereupon the information generating unit 418 of the management device 400 generates the charging spot information, based on the user position information, and the information indicating the positions of the charging spots. In step S73, the information generating unit 418 may further use the information indicating the residual capacity of the mobile battery or batteries 100 possessed by the user, in a manner so that the required time period information is included in the charging spot information. Further, in step S73, the information generating unit 418 may further use the information indicating the usage history of the charging spots by the user, in a manner so that information indicating the positions of the charging spots for which the usage frequency thereof by the user is comparatively high is included in the charging spot information.

Next, the process transitions to step S74, whereupon the communication unit 402 of the management device 400 transmits to the user terminal 200 the charging spot information generated by the information generating unit 418.

Next, the process transitions to step S75, whereupon the information providing unit 216 of the user terminal 200 provides to the user the charging spot information transmitted from the communication unit 402. In this manner, the operations illustrated in FIG. 21 come to an end.

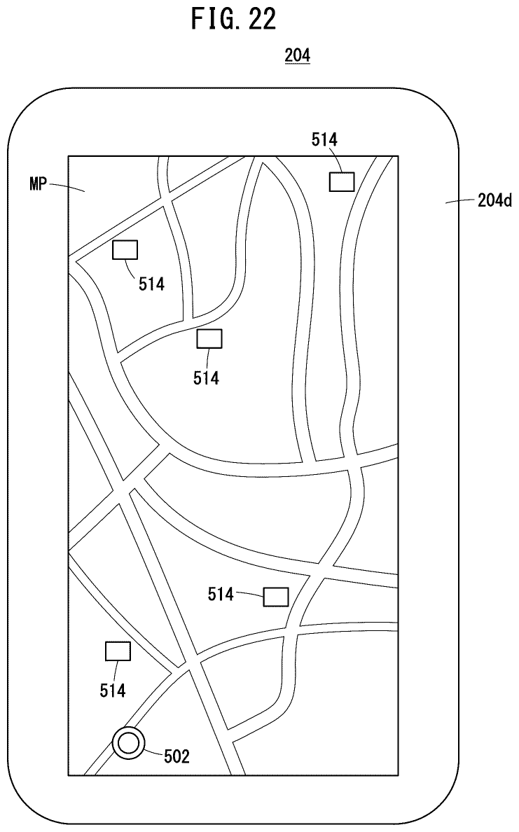

FIG. 22 is a diagram illustrating an example of a display on the display unit 204 of the user terminal 200.

In the case that the user terminal 200 has received the charging spot information, the information providing unit 216 of the user terminal 200 causes there to be displayed on the display unit 204, for example, a display screen 204d illustrated in FIG. 22. The map MP is capable of being displayed on the display screen 204d. The graphic 502 indicating the user position can further be displayed on the display screen 204d. A graphic 514 indicating a position of the charging spot can further be displayed on the display screen 204d. A number of the graphics 514 corresponding to the number of the charging spots that are capable of being displayed on the map MP can be displayed on the display screen 204d. Based on the graphic 514 displayed on the display screen 204d, the user can easily find charging spots where the mobile battery or batteries 100 possessed by the user are capable of being charged.

The form of the graphic 514 may change in accordance with the length of the expected required time period in order to fully charge the mobile battery or batteries 100 possessed by the user at the charging spots indicated by the graphic 514. The information generating unit 418, for example, may change the color, the size, or the like of the graphic 514, in accordance with the length of the expected required time period.

Further, the form of the graphic 514 may change in accordance with the usage history by the user of the charging spots represented by the graphic 514. In this case, for example, in accordance with the usage frequency by the user, the information generating unit 418 may change the color, the size, or the like of the graphic 514. Only charging spots for which the usage frequency thereof by the user is comparatively high may be displayed on the display screen 204d. In accordance with this feature, the convenience for the user is improved.

The display screen 204d may be displayed on a single display screen, together with at least one from among the display screen 204a shown in FIG. 8, the display screen 204b shown in FIG. 9, and the display screen 204c shown in FIG. 16. Stated otherwise, the information providing unit 216 may further cause the graphic 514 shown in FIG. 22 to be displayed on at least one from among the display screen 204a shown in FIG. 8, the display screen 204b shown in FIG. 9, and the display screen 204c shown in FIG. 16.

As noted previously, according to the management system 16, the information concerning the charging spots where the mobile battery or batteries 100 are capable of being charged can be provided to the user.

Incidentally, it is preferable that the mobile battery or batteries 100 having a certain level of quality be provided with respect to the user. In order to improve the quality control of the mobile battery or batteries 100, the management system 16 may be configured in the following manner. In the management device 400, as noted previously, there can be provided the usage history information acquisition unit 426, and the status determination unit 428.

The usage history information acquisition unit 426 acquires usage history information. The usage history information is information indicating the usage history of the mobile battery or batteries 100. The usage history information may be appropriately stored, for example, by the storage unit 112 of the mobile battery or batteries 100. The usage history information acquisition unit 426 can acquire the usage history information via an inspection device 700.

The inspection device 700 is a device that serves to inspect the mobile battery or batteries 100. The inspection device 700 may be provided, for example, in the battery station 12 (refer also to FIG. 1). In the example shown in FIG. 1, the inspection device 700 is provided in the charger 14 that is installed in the battery station 12. In this case, the inspection device 700 can be connected, via the battery port 14a of the charger 14, to the mobile battery or batteries 100. The inspection device 700, by being connected to the mobile battery or batteries 100, is capable of reading data from the storage unit 112 of the mobile battery or batteries 100. The data which is read out from the storage unit 112 by the inspection device 700 can be supplied from the inspection device 700, via the network NW, to the management device 400. In the data that the inspection device 700 is capable of reading out from the storage unit 112, there can be included data concerning the usage history of the mobile battery or batteries 100. Accordingly, as noted previously, the usage history information acquisition unit 426 can acquire, via the inspection device 700, the usage history information.

The usage history information can include at least one from among a total usage time period information, a charging and discharging number of times information, and a warranty period information. The total usage time period information is information concerning the total usage time period of the mobile battery or batteries 100. The charging and discharging number of times information is information concerning the number of times that the mobile battery or batteries 100 are charged and discharged. The warranty period information is information concerning the warranty period of the mobile battery or batteries 100. The warranty period is a period during which a manufacturer or a seller of the mobile battery or batteries 100 guarantees the functionality, the quality, or the like of the mobile battery or batteries 100.

The usage history information acquired by the usage history information acquisition unit 426 can be stored by the storage unit 406 of the management device 400. The usage history information can be stored, in association with the identification information of the mobile battery or batteries 100, in the storage unit 406.

The status determination unit 428 determines, based on the usage history information, whether or not the mobile battery or batteries 100 are reaching a usage restricted state. The usage restricted state is one state of the mobile battery or batteries 100. More specifically, the usage restricted state is a state of the mobile battery or batteries 100 in which usage thereof should be restricted.

The status determination unit 428, based on the total usage time period information included in the usage history information, is capable of determining whether or not the mobile battery or batteries 100 are reaching the usage restricted state. For example, in the case that the total usage time period indicated by the total usage time period information reaches a predetermined usage time period threshold value, the status determination unit 428 determines that the mobile battery or batteries 100 are reaching the usage restricted state.

The status determination unit 428, based on the charging and discharging number of times information included in the usage history information, is capable of determining whether or not the mobile battery or batteries 100 are reaching the usage restricted state. For example, in the case that the number of times of charging and discharging indicated by the charging and discharging number of times information reaches a predetermined charging and discharging number of times threshold value, the status determination unit 428 determines that the mobile battery or batteries 100 are reaching the usage restricted state.

The status determination unit 428, based on the warranty period information included in the usage history information, is capable of determining whether or not the mobile battery or batteries 100 are reaching the usage restricted state. For example, in the case that the warranty period indicated by the warranty period information has expired, the status determination unit 428 determines that the mobile battery or batteries 100 are reaching the usage restricted state.

Information indicating the result of the determination made by the status determination unit 428 can be stored by the storage unit 406 of the management device 400. More specifically, the information indicating whether or not the mobile battery or batteries 100 are reaching the usage restricted state can be stored by the storage unit 406. The information indicating whether or not the mobile battery or batteries 100 are reaching the usage restricted state can be stored, in association with the identification information of the mobile battery or batteries 100, in the storage unit 406. In accordance with this feature, the operating business entity of the sharing system 10 can easily confirm whether or not the mobile battery or batteries 100 are reaching the usage restricted state. For example, the operating business entity of the sharing system 10, by accessing the management device 400 (the storage unit 406) using a non-illustrated terminal, is capable of easily confirming whether or not the mobile battery or batteries 100 are reaching the usage restricted state.

It is undesirable for the mobile battery or batteries 100 that are low in quality to be provided to the user. The quality of the mobile battery or batteries 100 can deteriorate as the total usage time period or the number of times of charging and discharging of the mobile battery or batteries 100 becomes greater. Stated otherwise, it is preferable for the usage of the mobile battery or batteries 100 to be restricted, once the total usage time period, or the number of times of charging and discharging, or the like, has become of a certain level of magnitude. It is also undesirable for the mobile battery or batteries 100 whose quality cannot be guaranteed to be provided to the user. Stated otherwise, it is also preferable for the usage of the mobile battery or batteries 100 whose warranty period has expired to be restricted. In this regard, the operating business entity of the sharing system 10 (the management system 16), based on the result of the determination made by the status determination unit 428, is capable of easily specifying the mobile battery or batteries 100 that are reaching the usage restricted state. In accordance with this feature, the aforementioned operating business entity is capable of preventing the mobile battery or batteries 100 whose usage should be restricted from being provided to the user.

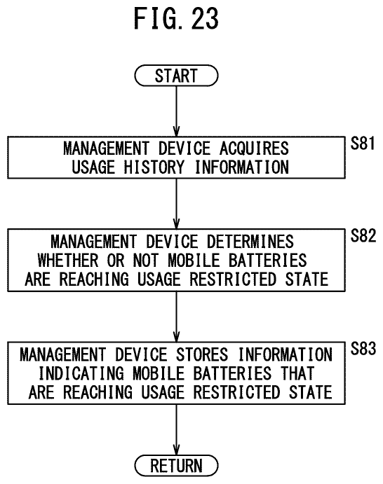

FIG. 23 is a flowchart illustrating an example of operations of the management system 16. An example of determining whether or not the mobile battery or batteries 100 are reaching the usage restricted state is shown in FIG. 23.

In step S81, the usage history information acquisition unit 426 of the management device 400 acquires the usage history information of the mobile battery or batteries 100. Next, the process transitions to step S82, whereupon the status determination unit 428 of the management device 400 determines, based on the usage history information, whether or not the mobile battery or batteries 100 are reaching the usage restricted state.

Next, the process transitions to step S83, whereupon the storage unit 406 of the management device 400 stores information indicating the mobile battery or batteries 100 that are reaching the usage restricted state. In FIG. 23, the information indicating that the mobile battery or batteries 100 are reaching the usage restricted state is information indicating the result of the determination made in step S82 by the status determination unit 428. In the storage unit 406, the information indicating the result of the determination carried out in step S82 by the status determination unit 428 can be stored in the storage unit 406 in association with the identification information of the mobile battery or batteries 100. In this manner, the operations illustrated in FIG. 23 come to an end.

Further, as noted previously, the computation unit 404 of the management device 400 can include the replacement time estimation unit 432. The replacement time estimation unit 432, based on the usage history information, estimates the replacement time of the mobile battery or batteries 100. The replacement time estimation unit 432 is capable of estimating the replacement time of the mobile battery or batteries 100 based on the usage history of the mobile battery or batteries 100. Moreover, as noted previously, the usage history information can be acquired by the usage history information acquisition unit 426.

The replacement time estimation unit 432, based on, for example, the total usage time period information included in the usage history information, is capable of estimating the replacement time of the mobile battery or batteries 100. In this case, based on the difference between the predetermined usage time period threshold value, and the total usage time period indicated by the total usage time period information, the replacement time estimation unit 432 is capable of estimating the replacement time of the mobile battery or batteries 100.

The replacement time estimation unit 432, based on the charging and discharging number of times information included in the usage history information, may estimate the replacement time of the mobile battery or batteries 100. In this case, based on the difference between a predetermined charging and discharging number of times threshold value, and the charging and discharging number of times indicated by the charging and discharging number of times information, the replacement time estimation unit 432 is capable of estimating the replacement time of the mobile battery or batteries 100.

The replacement time estimation unit 432, based on the warranty period information included in the usage history information, is capable of estimating the replacement time of the mobile battery or batteries 100. In this case, the replacement time estimation unit 432, based on the warranty period indicated by the warranty period information, is capable of estimating the replacement time of the mobile battery or batteries 100.

The information indicating the replacement time estimated by the replacement time estimation unit 432 can be stored by the storage unit 406 of the management device 400. The information indicating the replacement time estimated by the replacement time estimation unit 432 can be stored, in association with the identification information of the mobile battery or batteries 100, in the storage unit 406. The operating business entity of the sharing system 10, using the information indicating the replacement time estimated by the replacement time estimation unit 432, is capable of managing the mobile battery or batteries 100 in a planned manner. For example, the above-described operating business entity, by referring to the information indicating the replacement time estimated by the replacement time estimation unit 432, can create a procurement plan for new mobile battery or batteries 100.

Hereinafter, a description concerning the quality control of the mobile battery or batteries 100 will be further presented.

As noted previously, the inspection device 700 can be provided in the battery station 12. The inspection device 700 is capable of inspecting the mobile battery or batteries 100 that are connected to the inspection device 700. The inspection device 700 can carry out an inspection, such as a capacity measurement, a resistance measurement, or the like, with respect to the mobile battery or batteries 100 that are connected to the inspection device 700. By performing the inspection such as the capacity measurement, the resistance measurement, or the like, a degree of deterioration of the battery cells 102 of the mobile battery or batteries 100 can be detected. Information indicating the result of the inspection by the inspection device 700 can be supplied from the inspection device 700, via the network NW, to the management device 400.

The information indicating the inspection result by the inspection device 700 can be used by the maximum charging capacity determination unit 430. The maximum charging capacity determination unit 430, as noted previously, can be provided in the computation unit 404 of the management device 400. The maximum charging capacity determination unit 430, based on the inspection result by the inspection device 700, is capable of determining the maximum charging capacity of the mobile battery or batteries 100. The information indicating the maximum charging capacity determined by the maximum charging capacity determination unit 430 can be supplied, via the network NW, from the management device 400 to the charger 14 (the non-illustrated control computer). In accordance with this feature, the charger 14, within a range in which the residual capacity of the mobile battery or batteries 100 does not exceed the maximum charging capacity, is capable of carrying out charging with respect to the mobile battery or batteries 100.

The maximum charging capacity is an upper limit value of the charging capacity that is permitted when the mobile battery or batteries 100 are charged. The maximum charging capacity can change in accordance with the degree of deterioration of the battery cells 102 of the mobile battery or batteries 100. Stated otherwise, in accordance with the degree of deterioration of the battery cells 102, the standard for determining whether or not the charging with respect to the mobile battery or batteries 100 will result in excessive charging can change. Excessive charging with respect to the mobile battery or batteries 100 is undesirable. In this regard, according to the present embodiment, the maximum charging capacity determination unit 430, based on the inspection result by the inspection device 700 as described above, is capable of determining the maximum charging capacity. More specifically, according to the present embodiment, the maximum charging capacity determination unit 430 is capable of determining the maximum charging capacity in accordance with the degree of deterioration of the battery cells 102. Accordingly, it is possible to prevent excessive charging from being carried out with respect to the mobile battery or batteries 100.

Moreover, it is preferable that the inspection by the aforementioned inspection device 700 be executed in accordance with the usage history of the mobile battery or batteries 100. More specifically, it is preferable for the inspection by the inspection device 700 to be executed in accordance with the total usage time period, the charging and discharging number of times, or the warranty period of the mobile battery or batteries 100.

For example, only in the case that the total usage time period of the mobile battery or batteries 100 reaches a predetermined threshold value, the inspection device 700 may carry out the inspection with respect to the mobile battery or batteries 100. The predetermined threshold value in this case may be less than the aforementioned predetermined total usage time period threshold value. In the mobile battery or batteries 100 whose total usage time period is short, the possibility is low that the degree of deterioration of the battery cells 102 provided in the mobile battery or batteries 100 will result in a problem. Stated otherwise, the possibility is high that the inspection with respect to the mobile battery or batteries 100 whose total usage time period is short will be a needless inspection. By executing the inspection of the mobile battery or batteries 100 only in the case that the total usage time period of the mobile battery or batteries 100 has reached the predetermined threshold value, the possibility of a needless inspection being executed can be reduced.

For example, only in the case that the charging and discharging number of times of the mobile battery or batteries 100 reaches a predetermined threshold value, the inspection device 700 may carry out the inspection with respect to the mobile battery or batteries 100. The predetermined threshold value in this case may be less than the aforementioned predetermined charging and discharging number of times threshold value. In the mobile battery or batteries 100 whose charging and discharging number of times is small, the possibility is low that the degree of deterioration of the battery cells 102 provided in the mobile battery or batteries 100 will result in a problem. Stated otherwise, the possibility is high that the inspection with respect to the mobile battery or batteries 100 whose charging and discharging number of times is small will be a needless inspection. By executing the inspection of the mobile battery or batteries 100 only in the case that the charging and discharging number of times of the mobile battery or batteries 100 has reached the predetermined threshold value, the possibility of a needless inspection being executed can be reduced.

For example, only in the case that the usage period of the mobile battery or batteries 100 reaches a predetermined threshold value, the inspection device 700 may carry out the inspection with respect to the mobile battery or batteries 100. The predetermined threshold value in this case can be determined beforehand within the range of the aforementioned warranty period. In the mobile battery or batteries 100 whose usage period is short, the possibility is low that the degree of deterioration of the battery cells 102 provided in the mobile battery or batteries 100 will result in a problem. Stated otherwise, the possibility is high that the inspection with respect to the mobile battery or batteries 100 whose usage period is short will be a needless inspection. By executing the inspection of the mobile battery or batteries 100 only in the case that the usage period of the mobile battery or batteries 100 has reached the predetermined threshold value, the possibility of a needless inspection being executed can be reduced.

As noted previously, according to the management system 16, the operating business entity of the sharing system 10 can appropriately perform the quality control for the mobile battery or batteries 100.

Incidentally, from the standpoint of managing the mobile battery or batteries 100, it is preferable to appropriately adjust the number of the mobile battery or batteries 100 that are placed in the battery station 12 in accordance with the demand of the user with respect to the mobile battery or batteries 100. In order to appropriately adjust the number of the mobile battery or batteries 100 that are placed in the battery station 12, the management system 16 may be configured in the following manner. The computation unit 404 of the management device 400, as noted previously, may be equipped with the inventory deficient station determination unit 434, the requested target collection and delivery person selection unit 438, the low residual capacity battery determination unit 442, and the time period allowance determination unit 444.

The inventory deficient station determination unit 434 determines whether or not the battery station 12 is an inventory deficient station, based on information concerning a future demand for the mobile battery or batteries 100, and inventory information of the battery station 12. The inventory information indicates an inventory of the mobile battery or batteries 100 in the battery station 12. The inventory deficient station is a battery station 12 in which the inventory of the mobile battery or batteries 100 is expected to be insufficient in the future. Stated otherwise, the inventory deficient station is a battery station 12 in which the possibility is high that the demand of users intending to rent the mobile battery or batteries 100 cannot be satisfied. The information regarding the future demand for the mobile battery or batteries 100 can be generated, for example, by the aforementioned collection and delivery demand prediction unit 424. The inventory information indicating the inventory of the mobile battery or batteries 100 in the battery station 12 can be stored, for example, by the storage unit 406.

The information generating unit 418, based on the result of the determination by the inventory deficient station determination unit 434, is capable of generating information concerning the inventory deficient station. The information concerning the inventory deficient station includes, for example, information indicating an inventory deficient station position, which is the position of the inventory deficient station. Further, the information generating unit 418 can further generate delivery request information. The delivery request information is information in order to request that the collection and delivery person deliver the mobile battery or batteries 100 to the inventory deficient station. In the delivery request information, there can be included information indicating the number of the mobile battery or batteries 100 to be delivered.

The requested target collection and delivery person selection unit 438 selects a requested target collection and delivery person who is a target of a request to deliver the mobile battery or batteries 100 to the inventory deficient station. Stated otherwise, the requested target collection and delivery person selection unit 438 selects the collection and delivery person terminal 300 which serves as a transmission destination of the delivery request information. The requested target collection and delivery person selection unit 438, based on the collection and delivery person position and the inventory deficient station position, selects a collection and delivery person who is positioned within a predetermined range from the inventory deficient station. The collection and delivery person who is selected in this manner becomes the requested target collection and delivery person. The requested target collection and delivery person selection unit 438 may also select a plurality of the requested target collection and delivery persons.

The information concerning the inventory deficient station, and the delivery request information can be transmitted, via the communication unit 402, to the collection and delivery person terminal 300 possessed by the requested target collection and delivery person. Consequently, the information providing unit 316 of the collection and delivery person terminal 300 is capable of providing to the requested target collection and delivery person the information concerning the inventory deficient station, and the delivery request information.

By the information concerning the inventory deficient station being provided to the requested target collection and delivery person, the requested target collection and delivery person is capable of grasping the position of the inventory deficient station. Further, by providing the delivery request information to the requested target collection and delivery person, the requested target collection and delivery person is capable of delivering the mobile battery or batteries 100 to the inventory deficient station. Stated otherwise, an inventory replenishment of the mobile battery or batteries 100 can be carried out with respect to the inventory deficient station. In accordance with this feature, the inventory deficient station is prevented from actually reaching a state of being inventory deficient in the future. Further, it is possible to satisfy the demand of users who have the intention of renting the mobile battery or batteries 100 that are placed in the battery station 12.

The low residual capacity battery determination unit 442 determines whether or not the mobile battery or batteries 100 possessed by the collection and delivery person are low residual capacity batteries. The low residual capacity batteries are mobile batteries 100 in which the residual capacity thereof is less than a predetermined low residual capacity threshold value. The low residual capacity battery determination unit 442, based on the residual capacity information indicating the residual capacity of the mobile battery or batteries 100, determines whether or not the mobile battery or batteries 100 are low residual capacity batteries. As noted previously, the residual capacity information can be acquired by the battery information acquisition unit 416.

The time period allowance determination unit 444 determines whether or not the battery station 12 determined by the inventory deficient station determination unit 434 to be an inventory deficient station is a time period allowance possessing station. A time period allowance possessing station is an inventory deficient station for which a time period allowance, which is an allowance for which there is time to spare until reaching a state of inventory deficiency, is greater than or equal to a predetermined time period allowance threshold value. The time period allowance is capable of being grasped based on the future collection and delivery demand predicted by the collection and delivery demand prediction unit 424.

The information generating unit 418 generates delivery request information in order to request, with respect to the collection and delivery person (the requested target collection and delivery person) who possesses the low residual capacity battery or batteries, to deliver such low residual capacity battery or batteries to the time period allowance possessing station. The delivery request information can be transmitted, via the communication unit 402, to the collection and delivery person terminal 300 of the collection and delivery person who possesses the low residual capacity battery or batteries. In accordance with this feature, the information providing unit 316 provided in the collection and delivery person terminal 300 can issue a notification to the collection and delivery person of the request to deliver the battery or the batteries having the low residual capacity to the time period allowance possessing station.

The low residual capacity batteries are mobile batteries 100 for which the possibility is high of not being preferred by users intending to rent the mobile battery or batteries 100. However, the low residual capacity battery or batteries that are delivered to the time period allowance possessing station can be charged in the time period allowance possessing station. Since the time period allowance possessing station is a battery station 12 possessing a time period allowance until becoming inventory deficient, the low residual capacity battery or batteries can be sufficiently charged by utilizing such a time allowance. In accordance with this feature, it is not only possible to prevent the time period allowance possessing station from becoming inventory deficient in the future, but also to satisfy the demand of the user wishing to rent the mobile battery or batteries 100 having a sufficient residual capacity.

It is preferable that the information generating unit 418 also generate information for the purpose of restricting the delivery of the low residual capacity battery or batteries to an inventory deficient station that is not a time period allowance possessing station. The information may include, for example, information to the effect of issuing a request to the collection and delivery person not to deliver the low residual capacity battery or batteries to the inventory deficient station that is not a time period allowance possessing station. The information for the purpose of restricting the delivery of the low residual capacity battery or batteries to the inventory deficient station that is not a time period allowance possessing station can be transmitted, via the communication unit 402, to the collection and delivery person terminal 300 of the collection and delivery person possessing the low residual capacity battery or batteries. In accordance with this feature, the information providing unit 316 provided in the collection and delivery person terminal 300 can issue a notification to the collection and delivery person of the restriction on the delivery of the battery or the batteries with respect to the inventory deficient station that is not a time period allowance possessing station. By restricting the delivery of the low residual capacity battery or batteries with respect to the inventory deficient station that is not a time period allowance possessing station, it is possible to prevent such low residual capacity battery or batteries, for which the possibility is high of not being preferred by the user, from being replenished to the inventory deficient station.

Moreover, it should be noted that the information for the purpose of restricting the delivery of the low residual capacity battery or batteries to the inventory deficient station that is not a time period allowance possessing station may also be provided to a collection and delivery person who is not the requested target collection and delivery person. In accordance with this feature, it is possible to prevent the low residual capacity battery or batteries, for which the possibility is high of not being preferred by the user, from being replenished to the inventory deficient station by a collection and delivery person who is not the requested target collection and delivery person.

As noted previously, according to the present embodiment, an adjustment in the inventory of the mobile battery or batteries 100 can be appropriately carried out with respect to the inventory deficient station.

Further, as noted previously, the computation unit 404 of the management device 400 can be equipped with the inventory surplus station determination unit 436, and the delivery restricted collection and delivery person selection unit 440.

The inventory surplus station determination unit 436 determines whether or not the battery station 12 is an inventory surplus station, based on the information concerning the future demand for the mobile battery or batteries 100, and the inventory information of the battery station 12. The inventory surplus station is a battery station 12 in which the inventory of the mobile battery or batteries 100 is expected to become excessive in the future. A battery station 12 in which the inventory has become excessive is incapable of accepting a return of the mobile battery or batteries 100. Stated otherwise, the inventory surplus station is a battery station 12 in which the possibility is high that the demand of users intending to return the mobile battery or batteries 100 to the battery station 12 cannot be satisfied.

The information generating unit 418, based on the result of the determination by the inventory surplus station determination unit 436, is capable of generating information concerning the inventory surplus station. The information concerning the inventory surplus station includes, for example, information indicating an inventory surplus station position, which is the position of the inventory surplus station. Further, the information generating unit 418 can further generate delivery restriction information. The delivery restriction information is information for the purpose of restricting the delivery of the mobile battery or batteries 100 to the inventory surplus station. The delivery restriction information can include, for example, a request to the collection and delivery person to the effect of not delivering the mobile battery or batteries 100 to the inventory surplus station.

The delivery restricted collection and delivery person selection unit 440 selects a delivery restricted collection and delivery person who serves as a target of the restriction on the delivery of the mobile battery or batteries 100 to the inventory surplus station. Stated otherwise, the delivery restricted collection and delivery person selection unit 440 selects the collection and delivery person terminal 300 which serves as a transmission destination of the delivery restriction information. The delivery restricted collection and delivery person selection unit 440, based on the collection and delivery person position and the inventory surplus station position, selects a collection and delivery person who is positioned outside of a predetermined range from the inventory surplus station. The collection and delivery person selected in this manner becomes the delivery restricted collection and delivery person. The delivery restricted collection and delivery person selection unit 440 may also select a plurality of the delivery restricted collection and delivery persons.

The information concerning the inventory surplus station, and the delivery request information can be transmitted, via the communication unit 402, to the collection and delivery person terminal 300 possessed by the delivery restricted collection and delivery person. Consequently, the information providing unit 316 of the collection and delivery person terminal 300 is capable of providing to the delivery restricted collection and delivery person the information concerning the inventory surplus station, and the delivery restriction information.

By the information concerning the inventory surplus station being provided to the delivery restricted collection and delivery person, the delivery restricted collection and delivery person is capable of grasping the position of the inventory surplus station. In addition, by providing the delivery restriction information to the delivery restricted collection and delivery person, the delivery of the mobile battery or batteries 100 to the inventory surplus station can be restricted. Stated otherwise, carrying out of an inventory replenishment of the mobile battery or batteries 100 with respect to the inventory surplus station can be restricted. In accordance with this feature, the inventory surplus station is prevented from actually reaching a state of having an inventory surplus in the future. Further, it is possible to satisfy the demand of users who have the intention of returning the mobile battery or batteries 100 to the battery station 12.

Furthermore, according to the aforementioned delivery restricted collection and delivery person selection unit 440, a collection and delivery person who is positioned outside of a predetermined range from the inventory surplus station can be selected as the delivery restricted collection and delivery person. Accordingly, the information concerning the inventory surplus station, and the delivery restriction information can be provided at least to the collection and delivery person who is positioned outside of the predetermined range from the inventory surplus station. The collection and delivery person who is positioned outside of the predetermined range from the inventory surplus station, in comparison with a collection and delivery person who is positioned within the predetermined range from the inventory surplus station, will have a greater burden in order to reach the inventory surplus station. By providing the delivery restriction information to the collection and delivery person who is positioned outside of the predetermined range from the inventory surplus station, it is possible to prevent the burden imposed on such a collection and delivery person from being wasted. Moreover, the information concerning the inventory surplus station, and the delivery restriction information may also be provided at least to a collection and delivery person who is within the predetermined range from the inventory surplus station. In accordance with this feature, it is possible to suppress the carrying out of an inventory replenishment of the mobile battery or batteries 100 with respect to the inventory surplus station, by the collection and delivery person who is positioned within the predetermined range from the inventory surplus station. Accordingly, the inventory surplus station can be prevented from actually reaching a state of having an inventory surplus in the future.

As noted previously, according to the present embodiment, an adjustment in the inventory of the mobile battery or batteries 100 can be appropriately carried out with respect to the inventory surplus station.

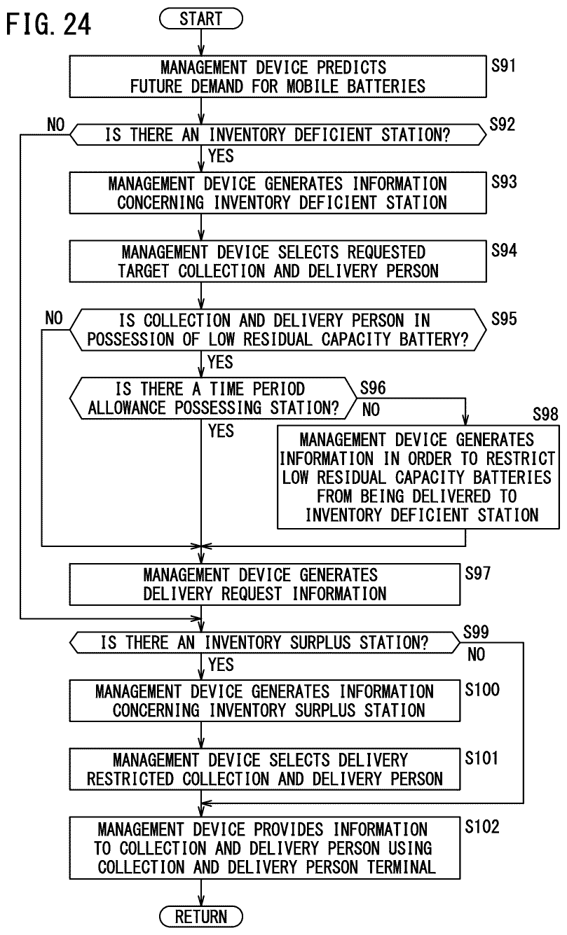

FIG. 24 is a flowchart illustrating an example of operations of the management system. FIG. 24 shows an example of a case in which the supplying of information in order to appropriately deploy the mobile battery or batteries 100 is carried out with respect to the collection and delivery person.

In step S91, the collection and delivery demand prediction unit 424 of the management device 400 predicts a future demand for the mobile battery or batteries 100.

In step S92, the inventory deficient station determination unit 434 of the management device 400 determines whether or not there is a battery station 12 that corresponds to the inventory deficient station.

In the case that there is such an inventory deficient station, the process transitions to step S93, whereupon the information generating unit 418 of the management device 400 generates the information concerning the inventory deficient station. The information concerning the inventory deficient station can include information indicating the inventory deficient station position.

Next, the process transitions to step S94, whereupon the requested target collection and delivery person selection unit 438 of the management device 400 selects the requested target collection and delivery person.

Next, the process transitions to step S95, whereupon the low residual capacity battery determination unit 442 of the management device 400 determines whether or not the mobile battery or batteries 100 possessed by the collection and delivery person correspond to the low residual capacity battery or batteries. More specifically, the low residual capacity battery determination unit 442 determines whether or not the collection and delivery person is in possession of the low residual capacity battery or batteries.

In the case that the collection and delivery person is in possession of the low residual capacity battery or batteries, the process proceeds to step S96, whereupon the time period allowance determination unit 444 of the management device 400 determines whether or not there is an inventory deficient station corresponding to the time period allowance possessing station.

In the case that there is a time period allowance possessing station, the process proceeds to step S97, whereupon the information generating unit 418 of the management device 400 generates the delivery request information. The information generating unit 418 generates the delivery request information in order to request that the requested target collection and delivery person deliver the low residual capacity battery or batteries to the time period allowance possessing station. The information generating unit 418 may further generate information for the purpose of restricting the delivery of the low residual capacity battery or batteries to the inventory deficient station that is not a time period allowance possessing station.

Moreover, in the above-described step S95, in the case that the collection and delivery person is determined not to be in possession of a low residual capacity battery or batteries, the process also transitions to step S97, whereupon the information generating unit 418 of the management device 400 generates the delivery request information.

In the case it is determined in step S96 that there is not a time period allowance possessing station, step S98 can be executed. In step S98, the information generating unit 418 generates information for the purpose of restricting the delivery of the low residual capacity battery or batteries to the inventory deficient station.

The above-described step S97 can also be executed in the case that step S98 is executed. In this case, in step S97, the information generating unit 418 can generate the delivery request information in order to request that the requested target collection and delivery person deliver to the inventory deficient station the mobile battery or batteries 100 other than the low residual capacity battery or batteries.

In the case it is determined in the above-described step S92 that there is not an inventory deficient station, or alternatively, in the case that step S97 is completed, the process transitions to step S99. In step S99, the inventory surplus station determination unit 436 of the management device 400 determines whether or not there is a battery station 12 that corresponds to the inventory surplus station.

In the case that there is such an inventory surplus station, the process transitions to step S100, whereupon the information generating unit 418 generates the information concerning the inventory surplus station. The information concerning the inventory surplus station can include information indicating the inventory surplus station position.

Next, the process transitions to step S101, whereupon the delivery restricted collection and delivery person selection unit 440 of the management device 400 selects the delivery restricted collection and delivery person.

Next, the process transitions to step S102, whereupon the information providing unit 316 of the collection and delivery person terminal 300 provides the information to the collection and delivery person. In this manner, the operations illustrated in FIG. 24 come to an end.

Moreover, in step S102, in accordance with the results of the determinations made in step S91 to step S101 described above, the information provided to the collection and delivery person differs. For example, in accordance with the result of the determination as to whether or not there is an inventory deficient station (step S92), the determination in step S102 as to whether or not the information concerning the inventory deficient station is provided to the collection and delivery person (the requested target collection and delivery person) differs. Further, in accordance with the execution result of step S99, the determination in step S102 as to whether or not the information concerning the inventory surplus station is provided to the collection and delivery person (the delivery restricted collection and delivery person) differs. In the case that neither one from among the inventory deficient station nor the inventory surplus station exists, step S102 can be skipped.

Incidentally, as noted previously, there is a high possibility that the low residual capacity battery or batteries will not be preferred by the user. However, from the standpoint of suppressing the deterioration of the mobile battery or batteries 100, it is preferable that the charging and discharging number of times of the mobile battery or batteries 100 be suppressed. Accordingly, from the standpoint of suppressing the deterioration of the mobile battery or batteries 100, if the mobile battery or batteries can be used by the user without charging them, it is preferable for them to be used by the user as much as possible, even if the low residual capacity battery or batteries exist.

In order for the low residual capacity battery or batteries to be used by the user, the management system 16 may be configured in the following manner. The information generating unit 418 of the management device 400 generates information which in the present embodiment is also referred to as low residual capacity battery information. The low residual capacity battery information is information concerning the low residual capacity battery or batteries that can be provided to the user. The low residual capacity battery information can be generated based on a low residual capacity battery position, which is the position of the low residual capacity battery or batteries, and the user position, which is the position of the user.

The low residual capacity battery position can be acquired by the aforementioned position information acquisition unit 412. The position information acquisition unit 412 is capable of acquiring, as the low residual capacity battery position, the position of the collection and delivery person who is in possession of the low residual capacity battery or batteries. Further, the position information acquisition unit 412 is capable of acquiring, as the low residual capacity battery position, the position of the battery station 12 in which the low residual capacity battery or batteries are placed. Furthermore, the position information acquisition unit 412 may acquire the low residual capacity battery position, based on the positioning result by the positioning unit 106 that is provided in the mobile battery or batteries 100 (the low residual capacity battery or batteries).

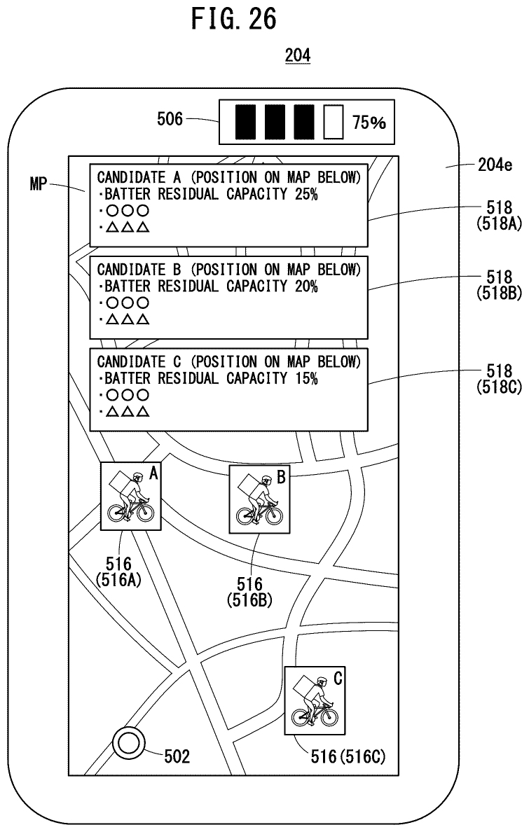

The low residual capacity battery information can be transmitted, via the communication unit 402, to the user terminal 200. Consequently, the information providing unit 216 of the user terminal 200 is capable of providing the low residual capacity battery information to the user. For example, the information providing unit 216, together with causing the map MP to be displayed on the display unit 204 of the user terminal 200, is capable of causing a graphic 516 indicating the low residual capacity battery position to be displayed on the map MP (refer also to FIG. 26).

As noted previously, the computation unit 404 of the management device 400 can be equipped with the residual capacity information acquisition unit 448, and the mobile battery selection unit 450.

The residual capacity information acquisition unit 448 acquires information indicating the residual capacity of the mobile device battery. The mobile device battery is a battery that is provided in the mobile device possessed by the user. The mobile device battery can be included in the personal belongings of the user. The mobile device possessed by the user, for example, is the user terminal 200, although the present invention is not necessarily limited to this feature. The residual capacity information acquisition unit 448, for example, communicates with the mobile device, and thereby acquires the information indicating the residual capacity of the mobile device battery.

The mobile battery selection unit 450 selects the mobile battery or batteries 100 that can be provided to the user, in accordance with the residual capacity of the mobile device battery. For example, in the case that the residual capacity of the mobile device battery is greater than or equal to a predetermined threshold value, the mobile battery selection unit 450 selects the low residual capacity battery or batteries as the mobile battery or batteries 100 that can be provided to the user. On the other hand, in the case that the residual capacity of the mobile device battery is less than the predetermined threshold value, the mobile battery selection unit 450 selects a mobile battery or batteries 100 other than the low residual capacity battery or batteries as the mobile battery or batteries 100 that can be provided to the user.

The information providing unit 216 of the user terminal 200, in accordance with the selection result by the mobile battery selection unit 450, can cause the information that is provided to the user to be changed. For example, in the case that the mobile battery selection unit 450 has selected the low residual capacity battery or batteries, the information providing unit 216 causes the low residual capacity battery information to be displayed on the display unit 204, more so than the information other than the low residual capacity battery information. Further, for example, in the case that the mobile battery selection unit 450 has selected the low residual capacity battery or batteries, the information providing unit 216 causes the low residual capacity battery information to be displayed on the display unit 204, in a manner so that the low residual capacity battery information appears more prominently than the information other than the low residual capacity battery information. In accordance with this feature, the possibility that the user will refer to the low residual battery capacity information can be made higher. As a result, it is possible to encourage the user to make use of the low residual capacity battery or batteries.

In addition, according to the present embodiment, in the case that the residual capacity of the mobile device battery is greater than or equal to the predetermined threshold value, the mobile battery selection unit 450 selects the low residual capacity battery or batteries. In the case that the residual capacity of the battery of the mobile device that is the personal belonging of the user is greater than or equal to the predetermined threshold value, the possibility is high that the user will not require that the mobile battery or batteries 100 be sufficiently charged. In this regard, according to the present embodiment, with respect to such a user for which the possibility is high that the user will not require the mobile battery or batteries 100 to be fully charged, the user can be encouraged to make use of the low residual capacity battery or batteries. Further, in the case that the residual capacity of the battery of the mobile device that is the personal belonging of the user is less than the predetermined threshold value, the possibility is high that the user would desire for the mobile battery or batteries 100 to be sufficiently charged. Stated otherwise, concerning the user for which the residual capacity of the mobile device battery that is the personal belonging of the user is less than the predetermined threshold value, the possibility is high that the user will not require the low residual capacity battery or batteries. In this regard, according to the present embodiment, with respect to such a user for which the possibility is high that the user will not require the low residual capacity battery or batteries, encouraging of the user to make use of the low residual capacity battery or batteries is avoided.

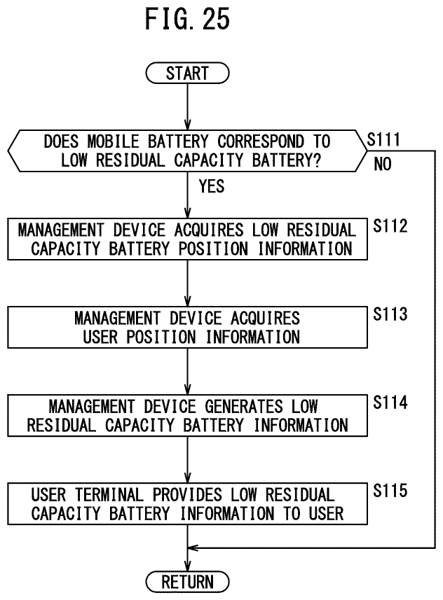

FIG. 25 is a flowchart illustrating an example of operations of the management system. An example of a case in which the low residual capacity battery capacity information is provided to the user is shown in FIG. 25.

In step S111, the low residual capacity battery determination unit 442 of the management device 400 determines whether or not the mobile battery or batteries 100 correspond to the low residual capacity battery or batteries. The residual capacity information capacity information indicating the residual capacity of the mobile battery or batteries 100 can be acquired, for example, by the aforementioned battery information acquisition unit 416. Based on the acquisition result by the battery information acquisition unit 416, the low residual capacity battery determination unit 442 determines that the mobile battery or batteries 100 whose residual capacity is less than the aforementioned low residual capacity threshold value are the low residual capacity battery or batteries.

In the case that the mobile battery or batteries 100 to be determined in step S111 are the low residual capacity battery or batteries, the process transitions to step S112 and step S113. In step S112, the position information acquisition unit 412 of the management device 400 acquires the low residual capacity battery position information indicating the position of the low residual capacity battery or batteries. In step S113, the position information acquisition unit 412 acquires the user position information indicating the user position.

Next, the process transitions to step S114, whereupon the information generating unit 418 of the management device 400 generates the low residual capacity battery information. The information generating unit 418, based on the user position information and the low residual capacity battery position information, generates the low residual capacity battery information. Information concerning the low residual capacity battery or batteries that are positioned within the predetermined range from the user position is included in the low residual capacity battery information.

Next, the process transitions to step S115, whereupon the information providing unit 216 of the user terminal 200 provides to the user the low residual capacity battery information. The low residual capacity battery information can be transmitted, via the communication unit 402 of the management device 400, to the user terminal 200. In this manner, the operations illustrated in FIG. 25 come to an end. Moreover, in step S111, in the case it is determined that the mobile battery or batteries 100 do not correspond to the low residual capacity battery or batteries, the operations illustrated in FIG. 25 also come to an end.

FIG. 26 is a diagram illustrating an example of a display on the display unit 204 of the user terminal 200.

The information providing unit 216 of the user terminal 200 that has received the low residual capacity battery information is capable of causing there to be displayed on the display unit 204, for example, a display screen 204e illustrated in FIG. 26. The display screen 204e is capable of being displayed on the display unit 204, for example, in the case that the aforementioned mobile battery selection unit 450 has selected the low residual capacity battery or batteries. The map MP is capable of being displayed on the display screen 204e. The graphic 502 indicating the user position can further be displayed on the display screen 204e.

The graphic 516 indicating the position of the low residual capacity battery or batteries can further be displayed on the display screen 204e. The graphic 516 of FIG. 26 indicates, as the low residual capacity battery position, the position of the collection and delivery person who is in possession of the low residual capacity battery or batteries. A plurality of the graphics 516 (516A to 516C) can be displayed on the display screen 204e.

Display data 518 that is based on the low residual capacity battery information can further be displayed on the display screen 204e. The display data 518 indicates, for example, the residual capacity of the low residual capacity battery or batteries. However, the display data 518 is not necessarily limited to this feature. For example, the display data 518 may further indicate the time period required for the delivery in the case that the user has requested the delivery of the low residual capacity battery or batteries, the cost in the case of using the low residual capacity battery or batteries, or the like. The display data 518 can be appropriately generated by the information generating unit 418.

A plurality of the display data 518 (518A to 518C) can be displayed on the display screen 204e. For example, in FIG. 26, the position of the low residual capacity battery or batteries that are shown in the display data 518A is indicated by the graphic 516A. The position of the low residual capacity battery or batteries that are shown in the display data 518B is indicated by the graphic 516B. The position of the low residual capacity battery or batteries that are shown in the display data 518C is indicated by the graphic 516C.

As noted previously, by providing the user with the low residual capacity battery information, the user can be encouraged to make use of the low residual capacity battery or batteries. By the user using the low residual capacity battery or batteries, it is possible to suppress the charging and discharging number of times of the low residual capacity battery or batteries.

Further, as noted previously, the computation unit 404 of the management device 400 can be equipped with the bonus granting unit 446. The bonus granting unit 446 grants a bonus to the user who has used the low residual capacity battery or batteries. Such a bonus, for example, is a special service provided only to a user who has used the low residual capacity battery or batteries, although the present invention is not particularly limited to this feature. In the above-described display data 518, there may be included information indicating the bonus that is to be granted to the user in the case that the low residual capacity battery or batteries indicated in the display data 518 are used. The information concerning the bonus that is granted to the user by the bonus granting unit 446 can be stored in the storage unit 406 in association with the user identification information, which is the identification information of the user.

By granting the bonus to the user who has used the low residual capacity battery or batteries, the motivation of the user with respect to making use of the low residual capacity battery or batteries can be enhanced. More specifically, the bonus granting unit 446 can further encourage the user to make use of the low residual capacity battery or batteries.

Incidentally, it is undesirable for the mobile battery or batteries 100 that have been charged to be left unused. Further, from the standpoint of suppressing the deterioration of the mobile battery or batteries 100, it is also undesirable for the mobile battery or batteries 100 to remain in a state of being excessively charged for an extended period of time.

In order to prevent the mobile battery or batteries 100 from remaining in an excessively charged state for an extended period of time, the management system 16 may be configured in the following manner. The information generating unit 418 of the management device 400 generates information, which in the present embodiment, is also referred to as high residual capacity battery information. The high residual capacity battery information is information concerning the high residual capacity battery or batteries that can be provided to the user. The high residual capacity batteries are mobile batteries 100 in which the residual capacity thereof is greater than or equal to a predetermined high residual capacity threshold value. The high residual capacity threshold value is greater than the aforementioned low residual capacity threshold value. The high residual capacity threshold value, for example, is a maximum charging capacity of the mobile battery or batteries 100, although the present invention is not necessarily limited to this feature. The high residual capacity battery information can be generated based on a high residual capacity battery position, which is the position of the high residual capacity battery or batteries, and the user position, which is the position of the user.

The high residual capacity battery position can be acquired by the position information acquisition unit 412. The position information acquisition unit 412 is capable of acquiring, as the high residual capacity battery position, the position of the collection and delivery person who is in possession of the high residual capacity battery or batteries. Further, the position information acquisition unit 412 is capable of acquiring, as the high residual capacity battery position, the position of the battery station 12 in which the high residual capacity battery or batteries are placed. Furthermore, the position information acquisition unit 412 may acquire the high residual capacity battery position, based on the positioning result by the positioning unit 106 that is provided in the mobile battery or batteries 100 (the high residual capacity battery or batteries).

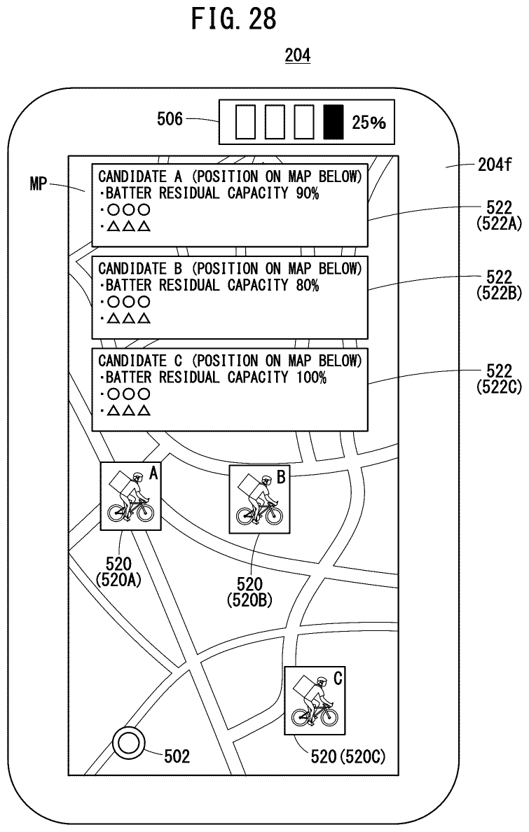

The high residual capacity battery information can be transmitted, via the communication unit 402, to the user terminal 200. Consequently, the information providing unit 216 of the user terminal 200 is capable of providing the high residual capacity battery information to the user. For example, the information providing unit 216, together with causing the map MP to be displayed on the display unit 204 of the user terminal 200, is capable of causing a graphic 520 indicating the high residual capacity battery position to be displayed on the map MP (refer also to FIG. 28).

Further, as noted previously, the computation unit 404 of the management device 400 can be equipped with the time-series data acquisition unit 454, and the long time period high residual capacity battery determination unit 456.

The time-series data acquisition unit 454 acquires time-series data in relation to the residual capacity of the mobile battery or batteries 100. The time-series data acquisition unit 454 can acquire the time-series data in relation to the residual capacity of the high residual capacity battery or batteries. The time-series data that is acquired can be stored by the storage unit 406.

The long time period high residual capacity battery determination unit 456 determines whether or not the high residual capacity battery or batteries correspond to long time period high residual capacity battery or batteries. The long time period high residual capacity battery or batteries are high residual capacity battery or batteries in which a state in which the residual capacity thereof is greater than or equal to the high residual capacity threshold value continues for greater than or equal to a long time period threshold value.

The information generating unit 418 generates the long time period high residual capacity battery information, based on the user position information, and the position of the long time period high residual capacity battery or batteries. The long time period high residual capacity battery information is information concerning the long time period high residual capacity battery or batteries that can be provided to the user. Stated otherwise, the long time period high residual capacity battery information is information, from among the high residual capacity battery information, concerning the long time period high residual capacity battery or batteries. Accordingly, the long time period high residual capacity battery information can be transmitted, via the communication unit 402, to the user terminal 200. Further, the long time period high residual capacity battery information can be provided to the user by the information providing unit 216.

Moreover, as noted previously, the information providing unit 216 of the user terminal 200, in accordance with the selection result by the mobile battery selection unit 450, can cause the information that is provided to the user to be changed. In consideration of this feature, in the case that the residual capacity of the mobile device battery is less than the predetermined threshold value, the mobile battery selection unit 450 may select the high residual capacity battery or batteries. In accordance with this feature, in the case that the residual capacity of the mobile device battery is less than the predetermined threshold value, the information providing unit 216, for example, causes there to be displayed on the display unit 204 the high residual capacity battery information, more than the information other than the high residual capacity battery information. In the case that the residual capacity of the mobile device battery is less than the predetermined threshold value, the information providing unit 216, for example, can cause there to be displayed on the display unit 204 the high residual capacity battery information, in a manner so that the high residual capacity battery information appears more prominently than the information other than the high residual capacity battery information.

In other words, in the case that the residual capacity of the battery of the mobile device that is the personal belonging of the user is less than the predetermined threshold value, the possibility is high that the user would require that the mobile battery or batteries 100 be sufficiently charged. In this regard, according to the present embodiment, with respect to such a user for which the possibility is high that the user will require the mobile battery or batteries 100 to be fully charged, the user can be encouraged to make use of the high residual capacity battery or batteries. Further, in the case that the residual capacity of the battery of the mobile device that is the personal belonging of the user is greater than or equal to the predetermined threshold value, the possibility is high that the user will not require that the mobile battery or batteries 100 be sufficiently charged. Stated otherwise, concerning the user for which the residual capacity of the mobile device battery that is the personal belonging of the user is greater than or equal to the predetermined threshold value, the possibility is high that the user will not require the high residual capacity battery or batteries. In this regard, according to the present embodiment, with respect to such a user for which the possibility is high that the user will not require the high residual capacity battery or batteries, encouraging of the user to make use of the high residual capacity battery or batteries is avoided.

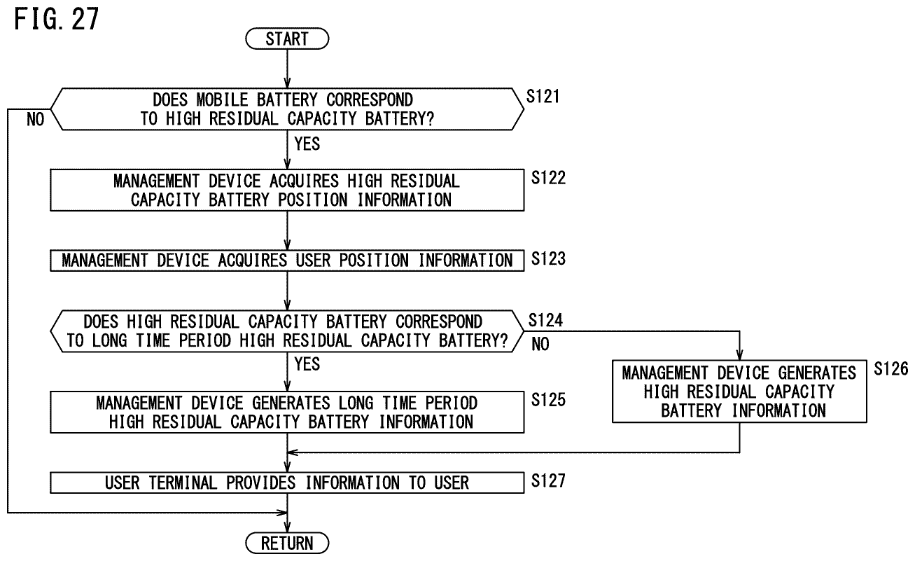

FIG. 27 is a flowchart illustrating an example of operations of the management system. In FIG. 27, an example of a case is shown in which the high residual capacity battery information, and the long time period high residual capacity battery information are provided as appropriate to the user.

In step S121, the high residual capacity battery determination unit 452 of the management device 400 determines whether or not the mobile battery or batteries 100 correspond to the high residual capacity battery or batteries. The residual capacity information capacity information indicating the residual capacity of the mobile battery or batteries 100 can be acquired, for example, by the aforementioned battery information acquisition unit 416. Based on the acquisition result by the battery information acquisition unit 416, the high residual capacity battery determination unit 452 determines that the mobile battery or batteries 100 whose residual capacity is greater than or equal to the aforementioned high residual capacity threshold value are the high residual capacity battery or batteries.

In the case that the mobile battery or batteries 100 to be determined in step S121 are the high residual capacity battery or batteries, the process transitions to step S122 and step S123. In step S122, the position information acquisition unit 412 of the management device 400 acquires the high residual capacity battery position information indicating the position of the high residual capacity battery or batteries. In step S123, the position information acquisition unit 412 acquires the user position information indicating the user position.

Next, the process transitions to step S124, whereupon the long time period high residual capacity battery determination unit 456 of the management device 400 determines whether or not the high residual capacity battery or batteries correspond to the long time period high residual capacity battery or batteries. In the case that the high residual capacity battery or batteries are the long time period high residual capacity battery or batteries, step S125 is executed. In the case that the high residual capacity battery or batteries are not the long time period high residual capacity battery or batteries, step S126 is executed.

In step S125, the information generating unit 418 of the management device 400 generates the long time period high residual capacity battery information. The information generating unit 418 generates the long time period high residual capacity battery information, based on the user position information, and the long time period high residual capacity battery position information. The information concerning the long time period high residual capacity battery or batteries that are positioned within the predetermined range from the user position is included in the long time period high residual capacity battery information.

In step S126, the information generating unit 418 of the management device 400 generates the high residual capacity battery information. The information generating unit 418 generates the high residual capacity battery information, based on the user position information, and the high residual capacity battery position information. The information concerning the high residual capacity battery or batteries that are positioned within the predetermined range from the user position is included in the high residual capacity battery information.

When step S125 or step S126 is completed, step S127 is started. In step S127, the information providing unit 216 of the user terminal 200 provides information to the user. In the case that step S125 is executed, then in step S127, the long time period high remaining capacity battery information is provided to the user. In the case that step S126 is executed, then in step S127, the high residual capacity battery information is provided to the user. The high residual capacity battery information or the long time period high residual capacity battery information can be transmitted, via the communication unit 402 of the management device 400, to the user terminal 200. In this manner, the operations illustrated in FIG. 27 come to an end. Moreover, in step S121, in the case it is determined that there are not any high residual capacity battery or batteries, the operations illustrated in FIG. 27 also come to an end.

FIG. 28 is a diagram illustrating an example of a display on the display unit 204 of the user terminal 200.

The information providing unit 216 of the user terminal 200 that has received the high residual capacity battery information, and the long time period high residual capacity battery information can cause there to be displayed on the display unit 204, for example, a display screen 204f illustrated in FIG. 28. The display screen 204f is capable of being displayed on the display unit 204, for example, in the case that the aforementioned mobile battery selection unit 450 has selected the high residual capacity battery or batteries. The map MP is capable of being displayed on the display screen 204f. The graphic 502 indicating the user position can further be displayed on the display screen 204f.

The graphic 520 can further be displayed on the display screen 204f. The graphic 520 indicates the high residual capacity battery position (the long time period high residual capacity battery position). The graphic 520 of FIG. 28 indicates, as the high residual capacity battery position, the position of the collection and delivery person who is in possession of the high residual capacity battery or batteries. A plurality of the graphics 520 (520A to 520C) can be displayed on the display screen 204f. Moreover, the graphic 520 may be changed, in accordance with whether it shows the position of the long time period high residual capacity battery or batteries, or the position of the high residual capacity batteries that are not the long time period high residual capacity battery or batteries.

On the display screen 204f, display data 522 can further be displayed based on the high residual capacity battery information (the long time period high residual capacity battery information). The display data 522 indicates, for example, the residual capacity of the high residual capacity battery or batteries (the long time period high residual capacity battery or batteries). However, the display data 522 is not necessarily limited to this feature. For example, the display data 522 may further indicate the time period required for the delivery in the case that the user has requested the delivery of the high residual capacity battery or batteries (the long time period high residual capacity battery or batteries), the cost in the case of using the high residual capacity battery or batteries, or the like. Further, the display data 522 may further indicate whether or not the high residual capacity battery or batteries indicated by the display data 522 correspond to the long time period high residual capacity battery or batteries. The display data 522 can be appropriately generated by the information generating unit 418.

A plurality of the display data 522 (522A to 522C) can be displayed on the display screen 204f. For example, in FIG. 28, the position of the high residual capacity battery or batteries that are shown in the display data 522A is indicated by the graphic 520A. The position of the high residual capacity battery or batteries that are shown in the display data 522B is indicated by the graphic 520B. The position of the high residual capacity battery or batteries that are shown in the display data 522C is indicated by the graphic 520C.

The display screen 204e (FIG. 26) and the display screen 204f (FIG. 28) may be combined. For example, the graphic 516 indicating the position of the low residual capacity battery or batteries, and the graphic 520 indicating the position of the high residual capacity battery or batteries (the long time period high residual capacity battery position) may be displayed together on the display unit 204. The display data 518 concerning the low residual capacity battery or batteries, and the display data 522 concerning the high residual capacity battery position (the long time period high residual capacity battery position) may be displayed together on the display unit 204.

As noted previously, according to the present embodiment, the management system 16 is capable of providing to the user the information concerning the high residual capacity battery or batteries (the long time period high residual capacity battery or batteries). In accordance with this feature, the user can be encouraged to make use of the high residual capacity battery or batteries (the long time period high residual capacity battery or batteries). By the user being encouraged to make use of the high residual capacity battery or batteries (the long time period high residual capacity battery or batteries), the deterioration of the mobile battery or batteries 100 can be suppressed.

Incidentally, the aforementioned battery station 12 can be used as an activity base for the collection and delivery person. For example, the battery station 12 can be provided as a waiting area (a resting location) for the collection and delivery person. In accordance with this feature, the battery station 12 can be used as a rest facility by the collection and delivery person. Further, the battery station 12 can also be equipped with constituent parts capable of being used by the collection and delivery person. The constituent parts can be appropriately provided in the battery station 12, for example, by the operating business entity that operates the sharing system 10. A constituent part that can be provided in the battery station 12 for the collection and delivery person, for example, is a moving body (such as a bicycle or the like) that can be loaned to the collection and delivery person. The constituent part that can be provided in the battery station 12 for the collection and delivery person is not necessarily limited to being a moving body. The battery station 12 can be equipped with supplies, consumable items, and the like that can be used by the collection and delivery person. The supplies may be rain gear (an umbrella, a raincoat) that can be used by the collection and delivery person, for example, at a time when it is raining. Further, the supplies may also be a communication device (a router) or the like. The supplies are not necessarily limited to being these items. The consumable items, for example, are beverages that the collection and delivery person can drink at the time of taking a rest or the like, although the present invention is not necessarily limited to this feature.

As will be discussed hereinafter, the management system 16 can support and assist the activities of the collection and delivery person, by encouraging the collection and delivery person to make use of the aforementioned rest facility, the constituent parts, and the like.

As noted previously, the computation unit 404 of the management device 400 is equipped with the operating status information acquisition unit 458, the rest necessity determination unit 460, and the provided information selection unit 462.

The operating status information acquisition unit 458 acquires the operating status information. The operating status information is information concerning the operating status of the collection and delivery person. The operating status information includes, for example, collection and delivery person movement information. The collection and delivery person movement information indicates at least one of a movement distance of the collection and delivery person, and a movement time period of the collection and delivery person. Moreover, it should be noted that the content of the operating status information is not necessarily limited to being the collection and delivery person movement information. For example, the operating status information may include information concerning a number of requests achieved by the collection and delivery person.

The rest necessity determination unit 460, based on the operating status information, determines whether or not a rest needs to be taken by the collection and delivery person. For example, the rest necessity determination unit 460 determines, based on the operating status information (the collection and delivery person movement information), whether or not the distance, the time period, or the like that the collection and delivery person has moved without taking a rest has exceeded a predetermined threshold value. In this case, if the distance, the time period, or the like that the collection and delivery person has moved without taking a rest has exceeded the predetermined threshold value, the rest necessity determination unit 460 can determine that it is necessary for the collection and delivery person to take a rest. Further, in the case that the number of incidents that the collection and delivery person has processed continuously without taking a rest has exceeded a predetermined number of incidents, the rest necessity determination unit 460 can also determine that it is necessary for the collection and delivery person to take a rest.

In the case that the rest necessity determination unit 460 has determined that it is necessary for the collection and delivery person to be made to take a rest, the information generating unit 418 generates rest taking recommendation information. The rest taking recommendation information is information for the purpose of recommending that the collection and delivery person take a rest. The rest taking recommendation information includes, for example, information for causing a message in order to encourage the collection and delivery person to take a rest to be displayed on the display unit 304 of the collection and delivery person terminal 300.

The rest taking recommendation information can be transmitted, via the communication unit 402, to the collection and delivery person terminal 300. Consequently, the information providing unit 316 of the collection and delivery person terminal 300 is capable of providing the rest taking recommendation information to the collection and delivery person. More specifically, the management system 16 can encourage the collection and delivery person to take a rest.

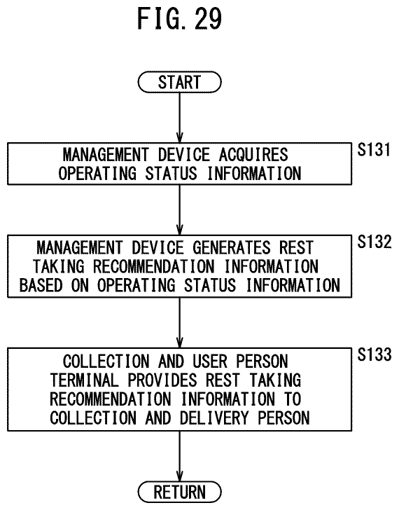

FIG. 29 is a flowchart illustrating an example of operations of the management system. An example of a case in which the rest taking recommendation information is provided to the collection and delivery person is shown in FIG. 29.

In step S131, the operating status information acquisition unit 458 of the management device 400 acquires the operating status information. As noted previously, the operating status information is information concerning the operating status of the collection and delivery person.

Next, the process transitions to step S132, whereupon the information generating unit 418 of the management device 400, based on the operating status information, generates the rest taking recommendation information. The rest taking recommendation information is information to recommend that the collection and delivery person take a rest. The generated rest taking recommendation information can be transmitted, via the communication unit 402 of the management device 400, to the collection and delivery person terminal 300.

Next, the process transitions to step S133, whereupon the information providing unit 316 of the collection and delivery person terminal 300 provides the rest taking recommendation information to the collection and delivery person. More specifically, the rest taking recommendation information is provided to the collection and delivery person using the collection and delivery person terminal 300. In this manner, the operations illustrated in FIG. 29 come to an end.

In the aforementioned step S132, the information generating unit 418 preferably causes rest facility information to be included in the rest taking recommendation information. The rest facility information is information indicating a facility that can be used by the collection and delivery person to take a rest. The facility that can be used by the collection and delivery person to take a rest, for example, is the battery station 12 as described above, although the present invention is not necessarily limited to this feature. A coffee shop, a tea shop, or the like may also be indicated by the rest facility information. The rest facility information can be stored beforehand by the storage unit 406.

By using the collection and delivery person position information, the information generating unit 418 can cause the rest facility information indicating a facility corresponding to the collection and delivery person position to be included in the rest taking recommendation information. The information generating unit 418, for example, can cause the rest facility information indicating a facility that is positioned within the predetermined range from the collection and delivery person position to be included in the rest taking recommendation information. The collection and delivery person position information, as noted previously, can be acquired by the position information acquisition unit 412.

Moreover, using a future position of the collection and delivery person, the information generating unit 418 may also cause the rest facility information indicating a facility corresponding to the collection and delivery person to be included in the rest taking recommendation information. In the following description, the future position of the collection and delivery person is also referred to as a future collection and delivery person position. The future collection and delivery person position can be predicted by the future position prediction unit 414. The future position prediction unit 414, based on an action plan of the collection and delivery person, can predict the future position of the collection and delivery person. The action plan of the collection and delivery person can be transmitted as appropriate by the collection and delivery person to the management device 400 using the collection and delivery person terminal 300. Further, the action plan of the collection and delivery person can be grasped based on the content of the collection and delivery request for the mobile battery or batteries 100 that the collection and delivery person has received. Further, based on a current behavior of the collection and delivery person, the future position prediction unit 414 may predict the future position of the collection and delivery person. For example, in the case that the collection and delivery person is using a train, the future position of the collection and delivery person can be predicted based on a timetable or the like for the train. Further, for example, in the case that the collection and delivery person is walking on a road, the future position of the collection and delivery person can be predicted based on map information concerning the road, a movement speed of the collection and delivery person, and the direction of movement of the collection and delivery person. Further, based on schedule information of the collection and delivery person, the future position prediction unit 414 may predict the future position of the collection and delivery person. The schedule information can be stored beforehand in the storage unit 312 that is provided in the collection and delivery person terminal 300.

The collection and delivery person terminal 300 is equipped with the operation unit 302. The operation unit 302 may accept an operation made by the collection and delivery person in order to indicate to the management system 16 an intention to take a rest. Such an expression of intent can be transmitted, via the communication unit 308 of the collection and delivery person terminal 300, to the management device 400. The provided information selection unit 462, in response to such an expression of intent, can select the rest facility information indicating a facility that can be used by the collection and delivery person to take a rest. For example, as noted previously, the rest facility information is stored in the storage unit 406. The storage unit 406 can store information indicating a plurality of the rest facilities. The provided information selection unit 462, based on the collection and delivery person position information, is capable of selecting the rest facility information indicating a facility within the predetermined range from the collection and delivery person position. The rest facility information selected by the provided information selection unit 462 can be transmitted, via the communication unit 402, to the collection and delivery person terminal 300. In accordance with this feature, the rest facility information can be provided to the collection and delivery person in response to an operation received by the operation unit 302.

Further, as noted previously, the collection and delivery environment information acquisition unit 464 is provided in the management device 400. The collection and delivery environment information acquisition unit 464 acquires collection and delivery environment information. The collection and delivery environment information is information concerning the collection and delivery environment of the collection and delivery person. More specifically, the collection and delivery environment information includes, for example, at least one of weather information, road surface information, and communication environment information. The weather information is information concerning a weather condition when the collection and delivery person carries out the collection and delivery of the mobile battery or batteries 100. The road surface information is information concerning a road surface condition when the collection and delivery person carries out the collection and delivery of the mobile battery or batteries 100. The communication environment information is information concerning the communication environment when the collection and delivery person carries out the collection and delivery of the mobile battery or batteries 100. The collection and delivery environment information acquisition unit 464, for example, using the Internet, acquires the collection and delivery environment information (the weather information, the road surface information, and the communication environment information).

The provided information selection unit 462 selects constituent part information based on the collection and delivery environment information, the collection and delivery person position information, and constituent part position information. The constituent part information is information that indicates constituent parts (supplies, consumable items) that can be used by the collection and delivery person. The constituent part position information is information indicating a location where the constituent parts are provided. Stated otherwise, the constituent part position information indicates the position of the constituent parts. The constituent part information and the constituent part position information can be stored beforehand by the storage unit 406. The storage unit 406 is capable of storing the constituent part information and the constituent part position information in association with each other.

The provided information selection unit 462, for example, as will be described next, is capable of selecting the constituent part information. The provided information selection unit 462 determines, based on the weather information, whether or not the weather will be rainy when the collection and delivery person is carrying out the collection and delivery of the mobile battery or batteries 100. In the case that the weather will be rainy when the collection and delivery person is carrying out the collection and delivery of the mobile battery or batteries 100, the provided information selection unit 462 selects, from among the constituent parts positioned within the predetermined range from the collection and delivery person position, the constituent part information indicating a constituent part (for example, rain gear) that the collection and delivery person can use in rainy weather.

The constituent part information selected by the provided information selection unit 462, and the constituent part position information indicating the position of the constituent parts according to the constituent part information can be transmitted, via the communication unit 402, to the collection and delivery person terminal 300. In accordance with this feature, the information providing unit 316 of the collection and delivery person terminal 300 is capable of providing to the collection and delivery person the constituent part information in accordance with the collection and delivery environment information. More specifically, the management system 16 can encourage the collection and delivery person to make use of the constituent parts in accordance with the collection and delivery environment information.

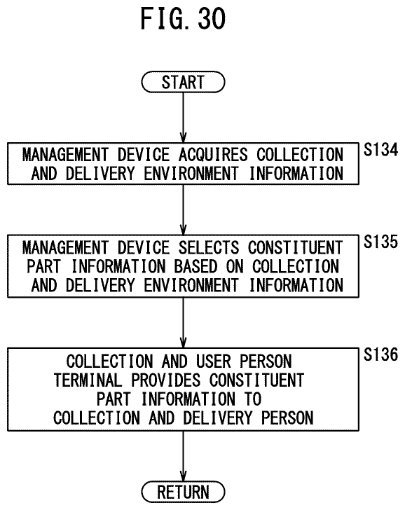

FIG. 30 is a flowchart illustrating an example of operations of the management system. An example of a case in which the constituent part information in accordance with the collection and delivery environment is provided to the collection and delivery person is shown in FIG. 30.

In step S134, the collection and delivery environment information acquisition unit 464 of the management device 400 acquires the collection and delivery environment information. As noted previously, the collection and delivery environment information is information concerning the collection and delivery environment of the collection and delivery person.

Next, the process transitions to step S135, whereupon the provided information selection unit 462 of the management device 400, based on the collection and delivery environment information, selects the constituent part information. As noted previously, the constituent part information is information indicating the constituent parts that can be used by the collection and delivery person. The selected constituent part information can be transmitted, via the communication unit 402 of the management device 400, to the collection and delivery person terminal 300.

Next, the process transitions to step S136, whereupon the information providing unit 316 of the collection and delivery person terminal 300 provides the constituent part information to the collection and delivery person. More specifically, the constituent part information is provided to the collection and delivery person using the collection and delivery person terminal 300. In this manner, the operations illustrated in FIG. 30 come to an end.

Further, as noted previously, the computation unit 404 of the management device 400 includes the malfunction information acquisition unit 466. The malfunction information acquisition unit 466 acquires malfunction information. The malfunction information is information concerning a malfunction of the moving body that is used by the collection and delivery person. The malfunction information is appropriately transmitted by the collection and delivery person to the management device 400 using the collection and delivery person terminal 300.

The provided information selection unit 462, based on the malfunction information, the collection and delivery person position information, and the constituent part position information (constituent part for repair position information), selects the constituent part information (constituent part for repair information). The constituent part for repair information is information that indicates constituent parts for repair. The constituent parts for repair are constituent parts that can be used by the collection and delivery person in order to repair the moving body. The constituent part for repair position information is information indicating a location where the constituent parts for repair are provided. The constituent parts for repair can be provided, for example, as supplies at the battery station 12. The constituent part for repair position information can indicate the position of the battery station 12 where the constituent parts for repair are provided.

The provided information selection unit 462 selects, for example, the constituent part for repair information which indicates the constituent parts for repair that are positioned within the predetermined range from the collection and delivery person position.

The constituent part for repair information selected by the provided information selection unit 462, and the constituent part for repair position information indicating the position of the constituent part for repair relating to the constituent part for repair information can be transmitted, via the communication unit 402, to the collection and delivery person terminal 300. In accordance with this feature, the information providing unit 316 of the collection and delivery person terminal 300 is capable of providing to the collection and delivery person the constituent part for repair information in accordance with the malfunction information. More specifically, the management system 16 can encourage the collection and delivery person to make use of the constituent part for repair in accordance with a malfunctioning state of the moving body.

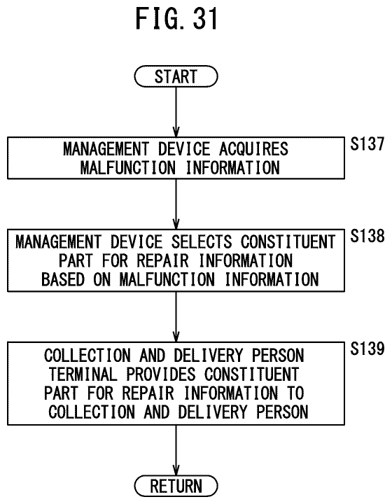

FIG. 31 is a flowchart illustrating an example of operations of the management system. An example of a case in which the constituent part for repair information in accordance with the malfunctioning state of the moving body is provided to the collection and delivery person is shown in FIG. 31.

In step S137, the malfunction information acquisition unit 466 of the management device 400 acquires the malfunction information. As noted previously, the malfunction information is information concerning a malfunction of the moving body that is used by the collection and delivery person.

Next, the process transitions to step S138, whereupon the provided information selection unit 462 of the management device 400, based on the malfunction information, selects the constituent part for repair information. As noted previously, the constituent part for repair information is information which indicates the constituent parts for repair that are constituent parts that can be used by the collection and delivery person. The selected constituent part for repair information can be transmitted, via the communication unit 402 of the management device 400, to the collection and delivery person terminal 300.

Next, the process transitions to step S139, whereupon the information providing unit 316 of the collection and delivery person terminal 300 provides the constituent part for repair information to the collection and delivery person. More specifically, the constituent part for repair information is provided to the collection and delivery person using the collection and delivery person terminal 300. In this manner, the operations illustrated in FIG. 31 come to an end.

As described above, the management system 16 is capable of supporting and assisting the activities of the collection and delivery person.

Moreover, as noted previously, the user terminal 200 is equipped with the operation unit 202. The user, using the operation unit 202, may issue a notification to the management device 400 that the user desires for a discretionary award to be granted to the collection and delivery person. The discretionary reward is a reward that can be granted to the collection and delivery person at the user's discretion in relation to the collection and delivery of the mobile battery or batteries 100. The discretionary reward may be a consumable item. As noted previously, the consumable items, for example, are beverages that the collection and delivery person can drink at the time of taking a rest or the like, although the present invention is not necessarily limited to this feature. A user may desire to grant such a discretionary reward to a collection and delivery person who, for example, has provided satisfactory service with respect to the user.

In the case that a notification from the user is made using the user terminal 200 to the effect that the user desires to grant a discretionary reward to the collection and delivery person, the control unit 408 of the management device 400 may transmit to the collection and delivery person terminal 300 discretionary reward information in accordance with the content of such a notification. The discretionary reward information is information concerning the discretionary reward. The discretionary reward information, for example, indicates a consumable item that the user desires to be granted to the collection and delivery person.

The information providing unit 316 of the collection and delivery person terminal 300 that has received the discretionary reward information is capable of providing the discretionary reward information to the collection and delivery person. In accordance with this feature, the collection and delivery person can be made aware that the discretionary reward will be granted to the collection and delivery person. As a result, the motivation of the collection and delivery person can be heightened.

Incidentally, as noted previously, in the sharing system 10, the individual who uses the mobile battery or batteries 100 is the user, and the individual who collects and delivers the mobile battery or batteries 100 to the user is the collection and delivery person.

However, there are cases in which the collection and delivery of the mobile battery or batteries 100 can be carried out more efficiently if the user collects and delivers the mobile battery or batteries 100, rather than having the collection and delivery person collect and deliver the mobile battery or batteries 100.

In consideration of this feature, the information generating unit 418 provided in the management device 400 generates the delivery request information in order to make a request to the user to deliver the mobile battery or batteries 100. The information generating unit 418, for example, in the case that the number of users within the predetermined region has become greater than or equal to a user number threshold value, generates the delivery request information in order to make a request to the user to deliver the mobile battery or batteries 100 to within the predetermined region.

The determination as to whether or not the number of users within the predetermined region is greater than or equal to the user number threshold value can be carried out by the computation unit 404 (for example, the control unit 408). The number of users within the predetermined region can be acquired, for example, based on the user position information. The user position information can be acquired by the position information acquisition unit 412.

The information generating unit 418 can cause there to be included, in the delivery request information, the information indicating the position of the battery station 12. The battery station 12 in this case is the battery station 12 in which there are placed the mobile battery or batteries 100 that are capable of being delivered within the predetermined region. Further, the information generating unit 418 is capable of causing there to be included, in the delivery request information, for example, the information indicating the position of the delivery request information. More specifically, the information generating unit 418 can cause there to be included, in the delivery request information, the information indicating the position of the predetermined region. Furthermore, the information generating unit 418 can cause there to be included, in the delivery request information, the information indicating the number of the mobile battery or batteries 100 that are to be delivered to the delivery destination.

As noted previously, the management device 400 is equipped with the delivery request information distribution unit 478. In the case that the number of users within the predetermined region has become greater than or equal to the user number threshold value, the delivery request information distribution unit 478 distributes the delivery request information, via the communication unit 402, to the user terminal 200. At least the user terminal 200 possessed by the user who is positioned within the predetermined distance from the battery station 12 in which the mobile battery or batteries 100 that are capable of being delivered within the predetermined region are placed can be included in the delivery target of the delivery request information. A plurality of the user terminals 200 can receive the delivery request information.

The information providing unit 216 provided in the user terminal 200 that has received the delivery request information is capable of providing the delivery request information to the user. In accordance with this feature, the management system 16 can make a request to the user to deliver the mobile battery or batteries 100 within the predetermined region.

As noted previously, in the delivery request information, there can be included the information indicating the battery station 12. Further, in the delivery request information, there can be included the information indicating the position of the delivery destination. Furthermore, in the delivery request information, there can be included the information indicating the number of the mobile battery or batteries 100 that are to be delivered to the delivery destination. Taking into consideration these items of information that are included in the delivery request information, the user can consider whether or not to accept the delivery request.

The user who wishes to accept the delivery request according to the delivery request information can use the user terminal 200, and can thereby make a response with respect to the management device 400 to the effect that the user is capable of accepting the delivery request. The management device 400, with respect to the user who has made the response to the effect that the user is capable of accepting the delivery request according to the delivery request information, can formally request the delivery of the mobile battery or batteries 100.

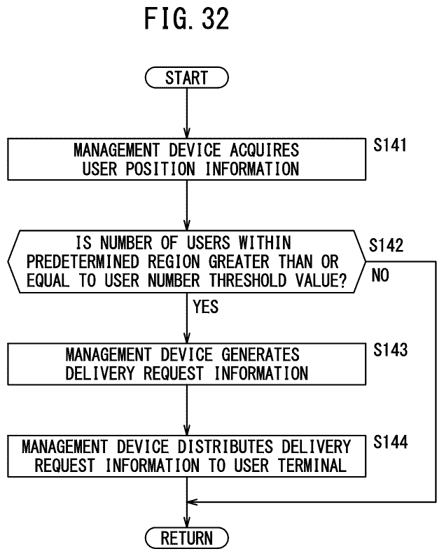

FIG. 32 is a flowchart illustrating an example of operations of the management system. FIG. 32 shows an example of a case in which a request is made with respect to the user to deliver a mobile battery or batteries 100.

In step S141, the position information acquisition unit 412 of the management device 400 acquires the user position information.

Next, the process transitions to step S142, whereupon the control unit 408 of the management device 400 determines whether or not the number of users within the predetermined region has become greater than or equal to the user number threshold value. The number of users within the predetermined region can be acquired, for example, based on the user position information. In the case that the number of users within the predetermined region is greater than or equal to the user number threshold value, step S143 is initiated. In the case that the number of users within the predetermined region is less than the user number threshold value, the operations in FIG. 32 come to an end.

In step S143, the information generating unit 418 of the management device 400 generates the delivery request information.

Next, the process transitions to step S144, whereupon the delivery request information distribution unit 478 of the management device 400 distributes the delivery request information to the user terminal 200. The delivery request information distribution unit 478 distributes the request information to the user terminal 200 possessed by the user who is positioned within the predetermined distance from the battery station 12 in which the mobile battery or batteries 100 that are capable of being delivered within the predetermined region are placed. In this manner, the operations illustrated in FIG. 32 come to an end.

Moreover, it should be noted that the determination in step S142 may be carried out based on the future user position predicted by the future position prediction unit 414. More specifically, the number of users within the predetermined region may be grasped based on the future user positions.

The user can possess the mobile device. The mobile device can be connected to the mobile battery or batteries 100. The users can possess a plurality of the mobile devices. More specifically, the number of users positioned within the predetermined range need not necessarily coincide with the number of the mobile devices possessed by the users who are positioned within the predetermined range. In consideration of this feature, in step S142, the control unit 408 may determine whether or not the number of the mobile devices possessed by the users is greater than or equal to a predetermined device number threshold value within the predetermined range. More specifically, in step S142, the control unit 408 may determine at least one of whether or not the number of users within the predetermined range is greater than or equal to the predetermined user number threshold value, and whether or not the number of mobile devices within the predetermined range is greater than or equal to a predetermined device number threshold value.

In this case, in step S141, the position information acquisition unit 412 acquires as necessary the mobile device position information indicating the position of the mobile device. For example, in the case that the user is in possession of a mobile device other than the user terminal 200, the position information acquisition unit 412 acquires, in addition to the information indicating the position of the user terminal 200 (the user position information), the mobile device position information. The position information acquisition unit 412 is capable of tracking the position of the mobile device, for example, by the user (the user terminal 200) providing beforehand to the management device 400 the identification information of the mobile device. In accordance with this feature, the position information acquisition unit 412 is capable of acquiring the mobile device position information. The storage unit 406 is capable of storing the identification information of the user in association with the identification information of the mobile device possessed by the user.

In step S144, the delivery request information distribution unit 478 distributes the delivery request information to the user terminal 200 that is positioned within the predetermined distance from the battery station 12. The user who is positioned within the predetermined distance from the battery station 12 has a smaller burden in order to reach the battery station 12 than a user who is positioned outside of the predetermined distance from the battery station 12. Stated otherwise, the management system 16 can make a request for the delivery of the mobile battery or batteries 100 to the user who has a relatively small burden in order to reach the battery station 12.

In step S144, based on the action plan of the user, the delivery request information distribution unit 478 may select the user (the user terminal 200) that serves as the distribution target of the delivery request information. In that case, the delivery request information distribution unit 478, for example, together with selecting the user who is positioned within the predetermined distance from the battery station 12, selects the user who is scheduled to pass by the battery station 12. In accordance with this feature, it is possible to suppress the impact that is imparted to the action plan of the user for whom the request for the mobile battery or batteries 100 was made with respect to the user. It is more preferable for the delivery request information distribution unit 478 to select the user who, together with being positioned within the predetermined distance from the battery station 12, is also scheduled to enter within the predetermined region via the battery station 12. In accordance with this feature, it is possible to further suppress the impact that is imparted to the action plan of the user for whom the request for the mobile battery or batteries 100 was made with respect to the user. In this case, the information indicating the action plan of the user can be transmitted beforehand, via the user terminal 200, to the management device 400, by the user who has the intention of accepting the delivery request for the mobile battery or batteries 100, although the present invention is not necessarily limited to this feature.

As described above, according to the present embodiment, the management system 16 is capable of making a request with respect to a certain user for the delivery of the mobile battery or batteries 100. In accordance with this feature, for example, even in the case that it is difficult for the collection and delivery person to deliver the mobile battery or batteries 100, the mobile battery or batteries 100 can be delivered by the user.

Moreover, regardless of whether or not the delivery request to within the predetermined region has actually been carried out, the delivery request information may be distributed to the user terminal 200. In accordance with this feature, the user who has become in need of the mobile battery or batteries 100 after the mobile battery or batteries 100 have been delivered to within the predetermined region, can use the mobile battery or batteries 100 that have already been delivered to within the predetermined region.

Further, as noted previously, the mobile battery or batteries 100 can be accommodated in the facility 20 such as the battery holder or the like. In consideration of this feature, for example, the battery holder, which is capable of accommodating the mobile battery or batteries 100 that can be delivered to within the predetermined range, may be installed beforehand at a location where it is estimated that people who are headed to within the predetermine range will pass. In accordance with this feature, for example, the user who is headed to within the predetermined range, can collect the mobile battery or batteries 100 that are accommodated in the battery holder, and can deliver the mobile battery or batteries 100 to another user who is within the predetermined range. Hereinafter, an explanation concerning this point will be described in more detail.

As noted previously, the management device 400 (the computation unit 404) is equipped with the people flow data acquisition unit 480, the holder position determination unit 482, and the delivery destination information providing unit 484.

The people flow data acquisition unit 480 acquires people flow data. The people flow data is data that is acquired based on the movement of people. The people flow data acquisition unit 480 can acquire the people flow data supplied from a business entity that carries out an operation of providing the people flow data, although the present invention is not necessarily limited to this feature. The people flow data acquisition unit 480 may grasp the people flow, for example, based on the position information of the user. Further, the people flow data acquisition unit 480 may grasp the people flow, for example, based on the position information of the collection and delivery person.

The holder position determination unit 482, based on the people flow data acquired by the people flow data acquisition unit 480, detects the flow of people arriving within the predetermined region. Such a flow of people, for example, is a flow of people along a road that reaches within the predetermined range. In the case that there are a plurality of roads that reach within the predetermined range, a plurality of the flow of people can occur that reach within the predetermined range.

The holder position determination unit 482, in accordance with the flow of people, determines the installation position of the battery holder. It is preferable that the flow of people, which is determined while taking into consideration the determination of the installation position of the battery holder, be restricted to a certain extent. For example, the flow of people, who are positioned up to the predetermined distance from the predetermined region, can be taken into consideration when determining the installation position of the battery holder. Since the flow of people, which is taken into consideration when determining the installation position of the battery holder, is restricted to a certain extent, the processing burden can be suppressed when the holder position determination unit 482 determines the installation position of the battery holder.

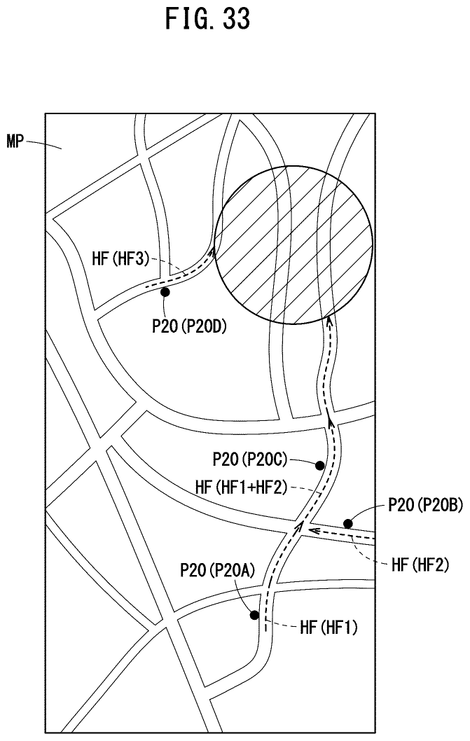

FIG. 33 is a diagram illustrating the flow of people HF arriving within the predetermined region, and the installation positions P20 of the battery holder. The map MP, and a plurality of the flows of people HF (HF1 to HF3) are shown schematically in FIG. 33. The hatched portion represents the predetermined region.

The holder position determination unit 482, in accordance with the flow of people HF, determines the installation position P20 of the battery holder. More specifically, the holder position determination unit 482, in accordance with the flow of people HF, is capable of determining a plurality of installation positions P20 for the battery holders. For example, the holder position determination unit 482 is capable of determining the installation positions P20 of the battery holders on passage routes of the plurality of the flows of people HF illustrated in FIG. 33. In this case, as shown in FIG. 33, the installation positions P20 (P20A to P20D) can be determined on each of the passage route of the flow of people HF1, the passage route of the flow of people HF2, and the passage route of the flow of people HF3, and the passage routes of the flow of people HF1+HF2. Further, the holder position determination unit 482 is capable of determining the plurality of installation positions P20 of the battery holders on the passage route of a single flow of people HF.

However, taking into consideration the burden on a worker who installs the mobile battery or batteries 100 at the installation positions P20 described below, it is preferable that the number of the installation positions P20, which are determined by the holder position determination unit 482, be limited to the minimum necessary. In consideration of this limitation, the installation positions P20 of the battery holders may be determined in accordance with the plurality of the flows of people HF arriving in a plurality of the predetermined regions. For example, in the example shown in FIG. 33, the flow of people HF1 and the flow of people HF2 merge prior to reaching the predetermined region. In this case, the holder position determination unit 482 can determine, as an installation position P20C of the battery holder, the location where the flow of people HF1 and the flow of people HF2 reach after having merged with each other. In this case, the holder position determination unit 482 can omit the installation position P20A positioned on the route through which only the flow of people HF1 passes, and the installation position P20B positioned on the path through which only the flow of people HF2 passes.

If carried out in this manner, the number of the installation positions P20 can be suppressed. Moreover, the holder position determination unit 482 may determine, as the installation positions P20 of the battery holders, from among the plurality of the flows of people HF who arrive within the predetermined region, locations through which the flow of people HF, which is greater than or equal to a predetermined number of people threshold value, passes while arriving within the predetermined range. Further, from among the plurality of the flows of people HF who arrive within the predetermined region, the holder position determination unit 482 may determine, as the installation position P20 of the battery holder, a location through which the flow of people HF containing a maximum number of people passes. In these cases as well, the number of the installation positions P20 can be suppressed.

The installation positions P20 of the battery holders, which are determined by the holder position determination unit 482, for example, are notified to a non-illustrated terminal that is possessed by the operating business entity that operates the sharing system 10. In accordance with this feature, the operating business entity is capable of carrying out an operation of installing the battery holders at the installation positions P20 that were determined by the holder position determination unit 482.

Moreover, it should be noted that the battery holders, which are installed at the installation positions P20 that are determined by the holder position determination unit 482, can be equipped with a non-illustrated display unit (display device), although the present invention is not necessarily limited to this feature. The significance of providing such a display unit in the battery holders will be described later.

The mobile battery or batteries 100 that can be delivered within the predetermined range are accommodated in the battery holders, which are installed at the installation positions P20 that are determined by the holder position determination unit 482. The operation of accommodating the mobile battery or batteries 100 in the battery holders can be performed, for example, when the battery holders are installed, although the present invention is not necessarily limited to this feature.

The delivery destination information providing unit 484 provides delivery destination information to the battery holder. The delivery destination information is information that indicates the delivery destination (the predetermined region) of the mobile battery or batteries 100 that are accommodated in the battery holder. In accordance with this feature, the battery holder is capable of displaying the delivery destination of the mobile battery or batteries 100 on a non-illustrated display unit provided on the battery holder. Accordingly, the people included in the flow of people HF passing through the installation positions P20 can easily confirm the delivery destination of the mobile battery or batteries 100.

If carried out in this manner, the mobile battery or batteries 100 that are accommodated in the battery holder, together with being capable of being collected by a person who is headed within the predetermined range, can be delivered to the delivery destination.

Incidentally, the mobile battery or batteries 100 can be charged prior to being placed in the battery station 12. Carrying out of charging with respect to the mobile battery or batteries 100 can be performed, for example, at an electrical power generating facility 22 (refer also to FIG. 1), although the present invention is not necessarily limited to this feature. The electrical power generating facility 22 is equipped with electrical power generating equipment in order to generate the electrical power using, for example, renewable energy. More specifically, in the electrical power generating facility 22, there can be carried out, for example, solar power generation, vibrational power generation, and the like. The electrical power generating facility 22 can be installed appropriately throughout the city. The mobile battery or batteries 100 can be charged using the electrical power obtained by the electrical power generating facility 22.

The mobile battery or batteries 100 that were charged at the electrical power generating facility 22, by being placed in the battery station 12, can be used by a user who visits the battery station 12. The mobile battery or batteries 100 that were charged by the electrical power generating facility 22 are collected, for example, by the collection and delivery person. The mobile battery or batteries 100 that were collected by the collection and delivery person are transported by the collection and delivery person to the battery station 12.

Incidentally, there may be a case in which it is reasonable for the mobile battery or batteries 100 that have been charged by the electrical power generating facility 22 to be collected by the user, and for the mobile battery or batteries 100 to be transported by the user to the battery station 12. In order to efficiently distribute the mobile battery or batteries 100 that are charged by the electrical power generating facility 22, the management system 16 may be configured in the following manner. As noted previously, the management device 400 is equipped with the charging status information acquisition unit 468, and the collection request information distribution unit 470.

The charging status information acquisition unit 468 acquires the charging status information. The charging status information is information indicating the charging status at the electrical power generating facility 22 which, together with being capable of generating electricity, is capable of charging the mobile battery or batteries 100. The charging status information indicates, for example, whether or not the charging of the mobile battery or batteries 100 is completed. The charging status information can be provided as appropriate to the management device 400 from the electrical power generating facility 22.

The information generating unit 418, based on the charging status information acquired by the charging status information acquisition unit 468, generates the collection request information. The collection request information is information in order to make a request to the user for the collection of the mobile battery or batteries 100 from the electrical power generating facility 22. The information generating unit 418 generates the collection request information, for example, in the case that the charging status information indicates that the charging of all of the mobile battery or batteries 100 that are placed in the electrical power generating facility 22 has been completed.

The information generating unit 418 can cause there to be included, in the collection request information, the information indicating the position of the electrical power generating facility 22. Further, the information generating unit 418 can include in the collection request information, information indicating the number of the mobile battery or batteries 100 that are capable of being collected from the electrical power generating facility 22.

The collection request information distribution unit 470 distributes the collection request information, via the communication unit 402, to the user terminal 200. In this case, the user terminal 200, which is positioned within the predetermined distance from the electrical power generating facility 22, can be included at least in the distribution target of the collection request information. A plurality of the user terminals 200 can receive the collection request information.

The information providing unit 216 provided in the user terminal 200 that has received the collection request information is capable of providing the collection request information to the user. In accordance with this feature, the management system 16 can make a request to the user for the collection of the mobile battery or batteries 100 from the electrical power generating facility 22.

As noted previously, in the collection request information, there can be included the information indicating the electrical power generating facility 22. Further, in the collection request information, there can be included the information indicating the number of the mobile battery or batteries 100 to be collected. Taking into consideration these items of information that are included in the collection request information, the user can consider whether or not to accept the collection request.

The user who wishes to accept the collection request according to the collection request information can use the user terminal 200, and can thereby make a response to the management device 400 to the effect that the user is capable of accepting the collection request. The management device 400, with respect to the user who has made the response to the effect that the user is capable of accepting the collection request according to the collection request information, can formally request the collection of the mobile battery or batteries 100.

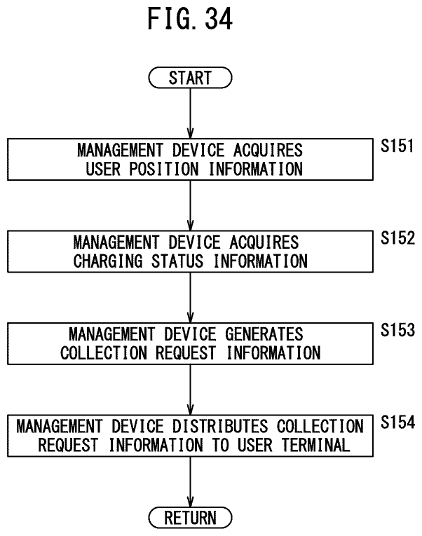

FIG. 34 is a flowchart illustrating an example of operations of the management system. In FIG. 34, an example is shown in which the operations of the management system concerning the collection request made with respect to the user for the mobile battery or batteries 100 are shown.

In step S151, the position information acquisition unit 412 of the management device 400 acquires the user position information. Further, in step S152, the charging status information acquisition unit 468 of the management device 400 acquires the charging status information.

Next, the process transitions to step S153, whereupon the information generating unit 418 of the management device 400, based on the charging status information, generates the collection request information.

Next, the process transitions to step S154, whereupon the collection request information distribution unit 470 of the management device 400 distributes to the user terminal 200 the collection request information. The collection request information distribution unit 470 distributes the collection request information to the user terminal 200 (the user) that is positioned within the predetermined distance from the electrical power generating facility 22. In this manner, the operations illustrated in FIG. 34 come to an end.

In step S154, the collection request information distribution unit 470 distributes the collection request information to the user terminal 200 that is positioned within the predetermined distance from the electrical power generating facility 22. The user who is positioned within the predetermined distance from the electrical power generating facility 22 has a smaller burden in order to reach the electrical power generating facility 22 than a user who is positioned outside of the predetermined distance from the electrical power generating facility 22. Stated otherwise, the management system 16 can make a request for the collection of the mobile battery or batteries 100 to the user who has a relatively small burden in order to reach the electrical power generating facility 22.

In step S154, based on the action plan of the user, the collection request information distribution unit 470 may select the user (the user terminal 200) that serves as the distribution target of the collection request information. In that case, the collection request information distribution unit 470, for example, together with setting the position within the predetermined distance from the electrical power generating facility 22, selects the user who is scheduled to pass by the electrical power generating facility 22. In accordance with this feature, it is possible to suppress the impact that is imparted to the action plan of the user for whom the request for the mobile battery or batteries 100 was made with respect to the user. It is more preferable that the collection request information distribution unit 470, together with setting the position within the predetermined distance from the electrical power generating facility 22, select the user who is scheduled to pass by the electrical power generating facility 22, and to enter within the predetermined region. In accordance with this feature, it is possible to further suppress the impact that is imparted to the action plan of the user for whom the request for the mobile battery or batteries 100 was made with respect to the user. In this case, the information indicating the action plan of the user can be transmitted beforehand, via the user terminal 200, to the management device 400, by the user who has the intention of accepting the collection request for the mobile battery or batteries 100, although the present invention is not necessarily limited to this feature.

The information generating unit 418 may generate the delivery request information in order to request that the user deliver to the battery station 12 the mobile battery or batteries 100 that were collected from the electrical power generating facility 22. In this case, in the delivery request information, there can be included information indicating the position of the battery station 12 to which the mobile battery or batteries 100 will be delivered. Such delivery request information can be transmitted, by the delivery request information distribution unit 478, to the user terminal 200. In this case, the delivery request information distribution unit 478 can transmit the delivery request information to the user terminal 200 of the user who has accepted the collection request.

Moreover, it should be noted that the information generating unit 418 is capable of determining, based on the action plan of the user, the battery station 12 to which the mobile battery or batteries 100 collected by the user will be delivered. The information generating unit 418, for example, together with being capable of identifying, based on the action plan of the user, the battery station 12 that the user is scheduled to pass by, is capable of setting the battery station 12 that was identified as the delivery destination. In accordance with this feature, it is possible to suppress the impact that is imparted to the action plan of the user for whom the request for the mobile battery or batteries 100 was made with respect to the user.

As described above, according to the present embodiment, the management system 16 is capable of making a request to the user for the collection of the mobile battery or batteries 100. In accordance with this feature, for example, even in the case that it is difficult for the collection and delivery person to collect the mobile battery or batteries 100 from the electrical power generating facility 22, the mobile battery or batteries 100 can be collected by the user.

Incidentally, there is a possibility that the usage demands for the mobile battery or batteries 100 in the vicinity of a battery station 12 that is not in operation may become higher. In such a case, by causing the battery station 12 that is not in operation to be placed in operation, the convenience for the user and the collection and delivery person can be improved. In order to enhance the convenience for the collection and delivery person, the management system 16 may be configured in the following manner. As noted previously, the management device 400 is equipped with the usage demand information acquisition unit 472, and the operating instruction notification unit 474.

The usage demand information acquisition unit 472 acquires usage demand information. The usage demand information is information indicating usage demands for the mobile battery or batteries 100.

The usage demand information acquisition unit 472, for example, based on the number of users within the predetermined range from the battery station 12, is capable of acquiring the usage demand information, which indicates the usage demands for the mobile battery or batteries 100 within the predetermined range from the battery station 12. More specifically, the greater the number of users who are positioned in the vicinity of the battery station 12 is, the greater the demand for the usage of the mobile battery or batteries 100 in the vicinity of the battery station 12 can be. The usage demand information acquisition unit 472, based on the user positions, is capable of grasping the number of users who are within the predetermined range from the battery station 12. As noted previously, the user position information indicating the user position can be acquired by the position information acquisition unit 412. The usage demand information acquisition unit 472, based on the future user positions, is capable of grasping the number of users who are within the predetermined range from the battery station 12. As noted previously, the future user position can be predicted by the future position prediction unit 414.

The operating instruction notification unit 474, based on the usage demand information, issues an operating instruction notification. The operating instruction notification is a notification in order to instruct the battery station 12 to operate. The operating instruction notification unit 474 determines, for example, whether or not the number of users within the predetermined range from the battery station 12 is greater than or equal to the predetermined user number threshold value. In the case that the number of users within the predetermined range from the battery station 12 is greater than or equal to the predetermined user number threshold value, the operating instruction notification unit 474 carries out the issuance of the operating instruction notification to the battery station 12. The operating instruction notification can be carried out, for example, using a message, an image, a sound, or the like.

The operating instruction notification can be carried out, via a predetermined communication line, with respect to a predetermined communication terminal. The communication terminal, for example, is a personal computer, a telephone, or the like that is provided in the battery station 12, although the present invention is not necessarily limited to this feature. The communication terminal may be a portable mobile terminal possessed by a management person who manages the battery station 12.

By the operating instruction notification being notified to the battery station 12 that is not in operation, the battery station 12 can be made to start operating. By starting the operation of the battery station 12 in a region in which the usage demands have become high, the convenience for the user can be improved. For example, the user can visit the battery station 12 whose operation has been started, and can rent the mobile battery or batteries 100.

Information indicating whether or not the battery station 12 is in operation can be appropriately collected, via the communication unit 402, by the control unit 408 of the management device 400, and together therewith, the information can be stored as appropriate in the storage unit 406. Further, it is possible to omit the transmission of the operating instruction notification to the battery station 12 that is in operation.

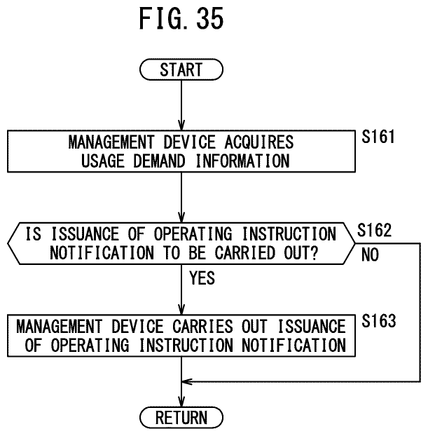

FIG. 35 is a flowchart illustrating an example of operations of the management system 16. FIG. 35 shows an example in which an operating instruction is carried out with respect to the battery station 12.

In step S161, the usage demand information acquisition unit 472 of the management device 400 acquires the usage demand information indicating the usage demands for the mobile battery or batteries 100 within the predetermined range from the battery station 12. As noted previously, the usage demand information indicating the usage demands for the mobile battery or batteries 100 within the predetermined range from the battery station 12 can be acquired based on the number of users within the predetermined range from the battery station 12. In order for the usage demand information acquisition unit 472 to grasp the number of users, in step S161, the position information acquisition unit 412 can appropriately acquire the user position information.

Next, the process transitions to step S162, whereupon the operating instruction notification unit 474 of the management device 400 determines whether or not to carry out the issuance of the operating instruction notification. This determination can be carried out based on whether or not the usage demands for the mobile battery or batteries 100 within the predetermined range from the battery station 12 have become higher to a certain extent. Specifically, for example, in the case that the number of users within the predetermined range from the battery station 12 is greater than or equal to the user number threshold value, the operating instruction notification unit 474 can determine to carry out the issuance of the operating instruction notification.

In the case that it is determined in step S162 to carry out the issuance of the operating instruction notification, the process transitions to step S163, whereupon the operating instruction notification unit 474 carries out the issuance of the operating instruction notification. If step S163 is completed, or by it being determined in step S162 that the issuance of the operating instruction is not to be carried out, the operations in FIG. 35 come to an end.

The usage demand information acquisition unit 472, in step S161, may acquire the usage demand information based on the number of the mobile devices within the predetermined range from the battery station 12. In that case, in step S161, the position information acquisition unit 412 can appropriately acquire the mobile device position information indicating the positions of the mobile devices that are positioned within the predetermined range from the battery station 12. In accordance with this feature, the usage demand information acquisition unit 472 is capable of grasping the number of the mobile devices that are within the predetermined range from the battery station 12.

In this case, the operating instruction notification unit 474 may determine in step S162 whether or not the number of the mobile devices within the predetermined range from the battery station 12 is greater than or equal to a predetermined mobile device number threshold value. In such a case, if the number of the mobile devices within the predetermined range from the battery station 12 is greater than or equal to the mobile device number threshold value, step S163 can be initiated. In the case that the number of the mobile devices in the future within the predetermined range from the battery station 12 is greater than or equal to the mobile device number threshold value, step S163 can also be initiated. The mobile devices in the future can be predicted, by the future position prediction unit 414, based on the action plans of the users. Stated otherwise, since the mobile devices are possessed by the users, the mobile devices necessarily move together with the users. Accordingly, based on the action plans of the users, the future positions of the mobile devices possessed by the users can be predicted.

Further, in a region in which there are a large number of the collection and delivery persons, the usage demands for the mobile battery or batteries 100 can become higher. Accordingly, the usage demand information acquisition unit 472, in step S161, may acquire the usage demand information based on the number of the collection and delivery persons within the predetermined range from the battery station 12. In that case, in step S161, the position information acquisition unit 412 can appropriately acquire the collection and delivery person position information indicating the positions of the collection and delivery persons who are positioned within the predetermined range from the battery station 12. In accordance with this feature, the usage demand information acquisition unit 472 is capable of grasping the number of the collection and delivery persons within the predetermined range from the battery station 12. The usage demand information acquisition unit 472 may use the future collection and delivery person position, and may thereby grasp the number of the collection and delivery persons within the predetermined range from the battery station 12. The future collection and delivery person position can be predicted by the future position prediction unit 414.

In step S162, the operating instruction notification unit 474 may determine whether or not the number of the collection and delivery persons within the predetermined range from the battery station 12 is greater than or equal to the predetermined collection and delivery person number threshold value. In that case, if the number of the collection and delivery persons within the predetermined range from the battery station 12 is greater than or equal to the collection and delivery number person threshold value, step S163 is initiated. In the case that the number of the collection and delivery persons in the future within the predetermined range from the battery station 12 is greater than or equal to the collection and delivery person number threshold value, step S163 can also be initiated.

In step S161, the usage demand information acquisition unit 472, based on the collection and delivery history of the mobile battery or batteries 100, may acquire the usage demand information. As noted previously, the collection and delivery history of the mobile battery or batteries 100 can be stored in the storage unit 406. The collection and delivery history indicates a history concerning the collection and delivery of the mobile battery or batteries 100 carried out with respect to the user. The usage demand information is capable of being acquired, based on the collection and delivery history that is carried out within the predetermined region from the battery station 12.

As described above, the management system 16 of the present embodiment is capable of managing the battery station 12 in accordance with the usage demands of the mobile battery or batteries 100. In accordance with this feature, convenience for the collection and delivery person can be improved.

Incidentally, as one aspect of the battery station 12, there is a feature that the battery station is a mobile station 24 (refer to FIG. 1). The mobile station 24 is a battery station 12 that is capable of moving. By the battery station 12 itself being capable of moving, the convenience for the user who wishes to use the battery station 12 can be improved.

The mobile station 24 can be equipped with a moving body 26 and a battery holder 28 (refer also to FIG. 1). The moving body 26, for example, is a vehicle such as a bicycle or the like, although the present invention is not necessarily limited to this feature. The battery holder 28 retains a plurality of the mobile battery or batteries 100. The battery holder 28 may be provided with a charger in order to charge the mobile battery or batteries 100. The battery holder 28, for example, is of a box-like shape that is capable of storing a plurality of the mobile battery or batteries 100, although the present invention is not necessarily limited to this feature.

Concerning the charging of the mobile battery or batteries 100, the mobile station 24 may be equipped with a non-illustrated electrical power generating device that generates electrical power in order to charge the mobile battery or batteries 100. The electrical power generating device, for example, generates electrical power using a rotational force of the wheels of a vehicle that serves as the moving body 26, although the present invention is not necessarily limited to this feature.

The mobile station 24 may further be equipped with a communication device 30. The communication device 30 performs communications via the network NW. The communication device 30 may be equipped with a positioning sensor such as a GNSS sensor or the like. In accordance with this feature, the communication device 30 is capable of acquiring mobile station position information indicating the position of the mobile station 24. Further, the communication device 30 can transmit as appropriate the mobile station position information to the management device 400. The mobile station position information that is transmitted to the management device 400 can be acquired by the position information acquisition unit 412. The communication device 30 in FIG. 1 is provided in the battery holder 28, although the present invention is not necessarily limited to this feature.

The mobile station 24 can operate as a battery station 12 while moving. However, it is not desirable for the mobile station 24 to move randomly within a region where the usage demands for the mobile battery or batteries 100 is low. Concerning this feature, as noted previously, the management device 400 can be equipped with the operating location notification unit 476.

The operating location notification unit 476, based on the usage demand information indicating the usage demands for the mobile battery or batteries 100, issues a notification to the mobile station 24 of the operating location of the mobile station 24. More specifically, for example, the operating location notification unit 476 issues a notification, with respect to the communication terminal possessed by a staff member in charge of managing the mobile station 24, of operating location information that indicates the operating location of the mobile station 24. Consequently, the operating location information can be displayed on the display screen provided on the communication terminal possessed by the staff member. In the following description, such a notification is also referred to as an operating location notification.

The usage demand information can be acquired by the usage demand information acquisition unit 472. In the case that the operating location notification unit 476 is made to carry out the operating location notification, the usage demand information acquisition unit 472 acquires the usage demand information indicating the usage demands for the mobile battery or batteries 100 within the predetermined range. In this case, the predetermined range, for example, is a range based on a point that is determined beforehand as a candidate for the installation position. However, the usage demand information acquisition unit 472 may also acquire, from the position (the current position) of the mobile station 24, the usage demand information indicating the usage demands for the mobile battery or batteries 100 within the predetermined range.

The operating location information may indicate a point at which the mobile station 24 is stopped, or may indicate a range of movement of the mobile station 24. In the case that the operating location information indicates a point, the mobile station 24 can stop moving, and together therewith, can operate as the battery station 12 at that point. In the case that the operating location information indicates a range of movement, the movement of the mobile station 24 can be restricted to within such a range of movement. The range of movement may be the same or may be different from the predetermined range used by the usage demand information acquisition unit 472 in order to acquire the usage demand information.

As noted previously, the usage demand information acquisition unit 472 is capable of acquiring the usage demand information based on the number of users, the number of the collection and delivery persons, the number of mobile devices, and the like within the predetermined range. In order for the usage demand information acquisition unit 472 to be made to generate the usage demand information, the position information acquisition unit 412 can appropriately acquire the user position information, the collection and delivery person position information, and the mobile device position information.

The usage demand information acquisition unit 472, based on the future user position, may grasp the number of users in the future within the predetermined range. The usage demand information acquisition unit 472, based on the future collection and delivery person position, may grasp the number of the collection and delivery persons within the predetermined range. The usage demand information acquisition unit 472, based on the future position of the mobile device, may grasp the number of the collection and delivery persons within the predetermined range. As noted previously, the future positions of the user, the collection and delivery person, and the mobile device can be predicted by the future position prediction unit 414.

In the case that the number of users within the predetermined range is greater than or equal to the predetermined user number threshold value, the operating location notification unit 476 can issue a notification of a reference point within the predetermined range as the operating location. As noted previously, the reference point is a candidate for the installation location, or alternatively, the position of the mobile station 24. The user number threshold value that is used by the operating location notification unit 476, and the user number threshold value that is used by the aforementioned operating instruction notification unit 474 may be different values.

Also, in the case that the number of the mobile devices within the predetermined range is greater than or equal to the predetermined mobile device number threshold value, the operating location notification unit 476 can issue a notification of the aforementioned reference point as the operating location. The mobile device number threshold value that is used by the operating location notification unit 476, and the mobile device number threshold value that is used by the aforementioned operating instruction notification unit 474 may be different values.

Also, in the case that the number of the collection and delivery persons within the predetermined range is greater than or equal to the predetermined collection and delivery person number threshold value, the operating location notification unit 476 can issue a notification of the aforementioned reference point as the operating location. The collection and delivery person number threshold value that is used by the operating location notification unit 476, and the collection and delivery person number threshold value that is used by the aforementioned operating instruction notification unit 474 may be different values.

The mobile station 24 moves to the operating location notified by the operating location notification unit 476, and can be used by a user in the vicinity of the operating location. The mobile station 24, by moving to the operating location that was notified by the operating location notification unit 476, is capable of being used by the user in the vicinity of such an operating location. As noted previously, since the mobile station 24 is capable of moving, the mobile station 24 can be easily moved to the operating location that is notified by the operation location notification unit 476.

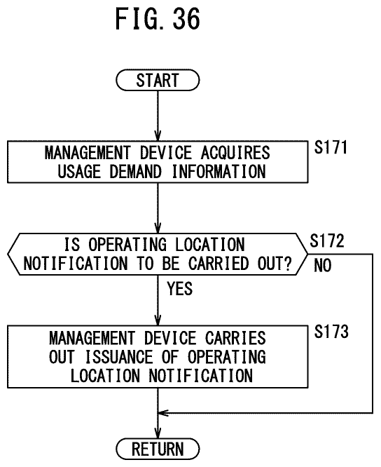

FIG. 36 is a flowchart illustrating an example of operations of the management system 16. In FIG. 36, an example is shown of the operations of the management system 16 concerning the notification of the operating location to the mobile station 24.

In step S171, the usage demand information acquisition unit 472 of the management device 400 acquires the usage demand information indicating the usage demands for the mobile battery or batteries 100 within the predetermined range. As noted previously, the usage demand information indicating the usage demands for the mobile battery or batteries 100 within the predetermined range can be acquired based on the number of users within the predetermined range. In order for the usage demand information acquisition unit 472 to grasp the number of users, in step S171, the position information acquisition unit 412 can appropriately acquire the user position information.

Next, the process transitions to step S172, whereupon the operating location notification unit 476 of the management device 400 determines whether or not to carry out the notification of the operating instruction notification. This determination can be carried out based on whether or not the usage demands for the mobile battery or batteries 100 within the predetermined range have become higher to a certain extent. Specifically, for example, in the case that the number of users within the predetermined range is greater than or equal to the user number threshold value, the operating location notification unit 476 can determine to carry out the issuance of the operating location notification.

In step S172, in the case it is determined that the operating location notification is to be performed, the process transitions to step S173, whereupon the operating location notification unit 476 issues a notification with respect to the mobile station 24 of the operating location. If step S173 is completed, or by it being determined in step S172 that the notification of the operating location is not to be issued, the operations in FIG. 36 come to an end.

The usage demand information acquisition unit 472, in step S171, may acquire the usage demand information based on the number of the mobile devices within the predetermined range. In this case, the operating location notification unit 476 may determine in step S172 whether or not the number of the mobile devices within the predetermined range is greater than or equal to a predetermined mobile device number threshold value. In such a case, if the number of the mobile devices within the predetermined range is greater than or equal to the mobile device number threshold value, step S173 can be initiated. In the case that the number of the mobile devices in the future within the predetermined range is greater than or equal to the mobile device number threshold value, step S173 can also be initiated.

Further, the usage demand information acquisition unit 472, in step S171, may acquire the usage demand information based on the number of the collection and delivery persons within the predetermined range. In that case, in step S171, the position information acquisition unit 412 can appropriately acquire the collection and delivery person position information indicating the positions of the collection and delivery persons who are positioned within the predetermined range. In accordance with this feature, the usage demand information acquisition unit 472 is capable of grasping the number of the collection and delivery persons within the predetermined range. The usage demand information acquisition unit 472 may use the future collection and delivery person position, and may thereby grasp the number of the collection and delivery persons within the predetermined range.

In step S172, the operating location notification unit 476 may determine whether or not the number of the collection and delivery persons within the predetermined range is greater than or equal to the predetermined collection and delivery person number threshold value. In that case, if the number of the collection and delivery persons within the predetermined range is greater than or equal to the collection and delivery number person threshold value, step S173 is initiated. In the case that the number of the collection and delivery persons in the future within the predetermined range is greater than or equal to the collection and delivery person number threshold value, step S173 can also be initiated.

In step S171, the usage demand information acquisition unit 472, based on the collection and delivery history of the mobile battery or batteries 100, may acquire the usage demand information. As noted previously, the collection and delivery history of the mobile battery or batteries 100 can be stored in the storage unit 406. The collection and delivery history indicates a history concerning the collection and delivery of the mobile battery or batteries 100 carried out with respect to the user. The usage demand information is capable of being acquired, based on the collection and delivery history that is carried out within the predetermined region.

As described above, the management system 16 is capable of managing the mobile station 24, which is the battery station 12 that is capable of moving. The management system 16 can instruct the mobile battery or batteries 100 to operate in locations where the usage demands therefor are high. In accordance with this feature, the convenience for the user can be improved.

### [Exemplary Modifications]

Exemplary modifications of the above-described embodiment will be described below. However, descriptions which overlap or are duplicative with those of the above-described embodiment will be omitted as appropriate in the following description. Unless otherwise specified, constituent elements that have already been described in the above-described embodiment are designated by the same reference numerals as in the above-described embodiment.

### (Exemplary Modification 1)

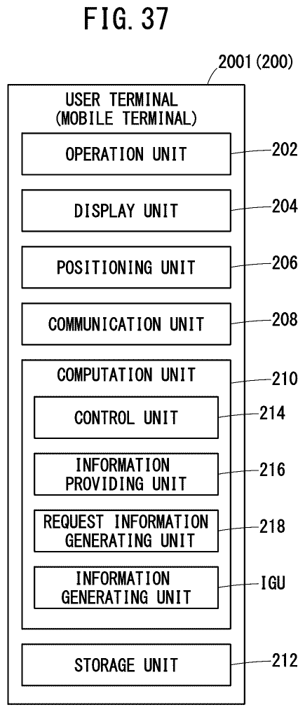

FIG. 37 is a block diagram showing the user terminal 200 (a user terminal 2001) according to an exemplary modification 1.

The user terminal 2001 is equipped with an information generating unit IGU. The information generating unit IGU is capable of generating at least a portion of the various information generated by the information generating unit 418 of the management device 400 according to the above-described embodiment. In that case, at least a portion of the functions of the information generating unit 418 may be omitted.

For example, the information generating unit IGU is capable of generating the aforementioned collection and delivery person information. As noted previously, the collection and delivery person information is generated based on the user position information and the collection and delivery person position information. The information generating unit IGU of the user terminal 2001, by the positioning unit 206 of the user terminal 200, is capable of acquiring the user position information. The collection and delivery person position information can be supplied from the position information acquisition unit 412 of the management device 400, via the communication unit 402, to the information generating unit IGU.

Moreover, it should be noted that the information that is capable of being generated by the information generating unit IGU of the user terminal 2001 is not necessarily limited to being the collection and delivery person information. For example, the aforementioned charging spot information or the like may also be generated by the information generating unit IGU. All of the various information generated by the information generating unit 418 in the above-described embodiment may be generated by the information generating unit IGU of the user terminal 2001. In that case, the information generating unit 418 of the management device 400 can be omitted.

### (Exemplary Modification 2)

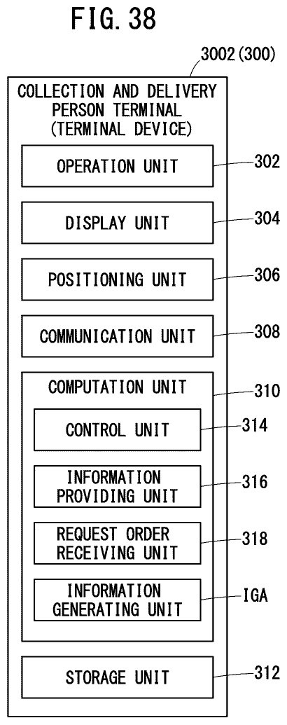

FIG. 38 is a block diagram showing the collection and delivery person terminal 300 (a collection and delivery person terminal 3002) according to an exemplary modification 2.

The collection and delivery person terminal 3002 is equipped with an information generating unit IGA. The information generating unit IGA is capable of generating at least a portion of the various information generated by the information generating unit 418 of the management device 400 according to the above-described embodiment. In that case, at least a portion of the functions of the information generating unit 418 may be omitted.

For example, the information generating unit IGA is capable of generating the aforementioned user information. As noted previously, the user information can be generated based on the collection and delivery person position information and the user position information. The information generating unit IGA of the collection and delivery person terminal 3002, by the positioning unit 306 of the collection and delivery person terminal 300, is capable of acquiring the collection and delivery person position information. The user position information can be supplied from the position information acquisition unit 412 of the management device 400, via the communication unit 402, to the information generating unit IGA.

Moreover, it should be noted that the information that is capable of being generated by the information generating unit IGA of the collection and delivery person terminal 3002 is not necessarily limited to being the user information. For example, the aforementioned past demand information or the like may also be generated by the information generating unit IGA. All of the various information generated by the information generating unit 418 in the above-described embodiment may be generated by the information generating unit IGA of the collection and delivery person terminal 3002. In that case, the information generating unit 418 of the management device 400 can be omitted.

### (Combination of Plurality of Exemplary Modifications)

The plurality of exemplary modifications described above may be appropriately combined within a range that does not result in any inconsistency.

### Modified Embodiments

Moreover, the present invention is not necessarily limited to the above-described embodiment, but various configurations can be adopted therein without departing from the essence and gist of the present invention.

The user terminal 200 is not necessarily limited to being a smart phone. The user terminal 200 may be a tablet terminal or a wearable terminal. Similarly, the collection and delivery person terminal 300 is not necessarily limited to being a smart phone. The collection and delivery person terminal 300 may be a tablet terminal or a wearable terminal.

In the case that a user who has a plan to receive the mobile battery or batteries 100 comes into close proximity to the mobile battery or batteries 100, the notification unit 118 may control the speaker of the lighting unit 104, and may thereby cause a sound to be emitted from the speaker. Consequently, the user is capable of recognizing the position of the mobile battery or batteries 100. Further, in the case that a collection person who has a plan to collect the mobile battery or batteries 100 comes into close proximity to the mobile battery or batteries 100, the notification unit 118 may control the lighting unit 104, and may thereby cause a sound to be emitted from the speaker. Consequently, the collection person is capable of recognizing the position of the mobile battery or batteries 100.

The management device 400 may be realized by a plurality of computers working together in cooperation.

The information generating unit 418 may generate the collection and delivery information, based on the user position information and the collection and delivery person position information acquired by the position information acquisition unit 412.

The information generating unit 418 may generate the user information, based on the information indicating the future user position predicted by the future position prediction unit 414, and the collection and delivery person position information acquired by the position information acquisition unit 412.

The information generating unit 418 may generate the route candidate information, based on the future user position, the collection and delivery person position information, and the map information.

In the case that the collection and delivery request for the mobile battery or batteries 100 is received by the collection and delivery person, the information generation unit 418 may generate, based on the user position, the collection and delivery person position, and the map information, recommended route information, which is information concerning a collection and delivery route for the mobile battery or batteries 100. The information providing unit 316 of the collection and delivery person terminal 300 is capable of providing the recommended route information that was generated to the collection and delivery person. In accordance with this feature, the collection and delivery person is capable of grasping the collection and delivery route that the collection and delivery person can use in order to collect and deliver the mobile battery or batteries 100. Moreover, the collection and delivery route indicated by the recommended route information may be the same route as the candidate collection and delivery route provided to the collection and delivery person prior to the collection and delivery person accepting the order for the collection and delivery of the mobile battery or batteries 100.

The route candidate information or the recommended route information may be provided to the user by the information providing unit 216 of the user terminal 200. In this case, the route candidate information or the recommended route information is transmitted to the user terminal 200 from the management device 400. The information providing unit 216 causes there to be displayed on the display unit 204 the route candidate information, and the recommended route information that were received by the user terminal 200. In accordance with this feature, the user is capable of grasping the collection and delivery route used by the collection and delivery person who collects and delivers the mobile battery or batteries 100 with respect to the user.

The information providing unit 216 of the user terminal 200 may further provide to the user the information indicating the residual capacity of the mobile battery or batteries 100 possessed by the user. The user terminal 200, for example, is capable of communicating with the management device 400, and thereby acquiring the information indicating the residual capacity of the mobile battery or batteries 100 possessed by the user. The information providing unit 216, by causing graphics, text, and the like to be displayed on the display unit 204, is capable of providing to the user the information indicating the residual capacity of the mobile battery or batteries 100 possessed by the user. The information indicating the residual capacity of the mobile battery or batteries 100 possessed by the user can be used by the user in order to determine whether or not the collection and delivery of the mobile battery or batteries 100 is necessary. Moreover, the information providing unit 216 may provide to the user by using voice the information indicating the residual capacity of the mobile battery or batteries 100 possessed by the user.

The information providing unit 216 may further provide to the user the information indicating the future residual capacity, which is the residual capacity of the mobile battery or batteries 100 possessed by the user at the future user position. The future residual capacity can be predicted, for example, based on the battery information of the mobile battery or batteries 100, and the action plan of the user. The information indicating the future residual capacity can be displayed, by the information providing unit 216, on the display unit 204 of the user terminal 200. For example, the information indicating the future residual capacity can be further displayed on the display screen 204a (FIG. 8), the display screen 204b (FIG. 9), and the like. A processor provided in the user terminal 200, the management device 400, and the like is capable of predicting the residual capacity of the mobile battery or batteries 100 at the future user position, although the present invention is not necessarily limited to this feature. The information indicating the residual capacity at the future user position of the mobile battery or batteries 100 possessed by the user can be used by the user in order to determine whether or not the collection and delivery of the mobile battery or batteries 100 is necessary.

In the case that the collection and delivery person has delivered the mobile battery or batteries 100 to the delivery location, the information providing unit 216 of the user terminal 200 may further display on the display unit 204 information indicating that the mobile battery or batteries 100 have been delivered by the collection and delivery person to the delivery location. In accordance with this feature, the user is capable of grasping that the mobile battery or batteries 100 have been placed in the delivery location. In this case, the collection and delivery person, after having placed the mobile battery or batteries 100 in the delivery location, operates the collection and delivery person terminal 300, and thereby transmits a notification to the management device 400 to the effect that the mobile battery or batteries 100 have been placed in the delivery location. In the case that the management device 400 has received such a notification, the information generating unit 418 generates information indicating that the mobile battery or batteries 100 have been placed in the delivery location by the collection and delivery person. The generated information is transmitted by the communication unit 402 to the user terminal 200.

In the case that the user has received the mobile battery or batteries 100 that were placed in the delivery location, the information providing unit 316 of the collection and delivery person terminal 300 may further display, on the display unit 304, information indicating that the mobile battery or batteries 100 have been received by the user. In accordance with this feature, the collection and delivery person is capable of grasping that the user has received the mobile battery or batteries 100. In this case, the user, after having received the mobile battery or batteries 100, operates the user terminal 200, and thereby transmits a notification to the management device 400 to the effect that the mobile battery or batteries 100 have been received. In the case that the management device 400 has received such a notification, the information generating unit 418 generates information indicating that the mobile battery or batteries 100 have been received by the user. The generated information is transmitted by the communication unit 402 to the collection and delivery person terminal 300.

In the case that the user hands over the mobile battery or batteries 100 to the collection and delivery person, the information providing unit 316 of the collection and delivery person terminal 300 can further display on the display unit 304 information indicating that the mobile battery or batteries 100 have been placed by the user in the collection location. In accordance with this feature, the collection and delivery person is capable of grasping that the mobile battery or batteries 100 have been placed in the collection location. In this case, the user, after having placed the mobile battery or batteries 100 in the collection location, operates the user terminal 200, and thereby transmits a notification to the management device 400 to the effect that the mobile battery or batteries 100 have been placed in the collection location. In the case that the management device 400 has received such a notification, the information generating unit 418 generates information indicating that the mobile battery or batteries 100 have been placed by the user in the collection location. The generated information is transmitted by the communication unit 402 to the collection and delivery person terminal 300.

In the case that the user has placed the mobile battery or batteries 100 in the collection location, the information providing unit 216 of the user terminal 200 may further display on the display unit 204 information indicating that the mobile battery or batteries 100 have been collected by the collection and delivery person from the collection location. In accordance with this feature, the user is capable of grasping that the mobile battery or batteries 100 have been collected. In this case, the collection and delivery person, after having collected the mobile battery or batteries 100, operates the collection and delivery person terminal 300, and thereby transmits a notification to the management device 400 to the effect that the mobile battery or batteries 100 have been collected. In the case that the management device 400 has received such a notification, the information generating unit 418 generates information indicating that the mobile battery or batteries 100 have been collected by the collection and delivery person. The generated information is transmitted by the communication unit 402 to the user terminal 200.

The information providing unit 216 of the user terminal 200 may further provide to the user, information indicating the residual capacity of the mobile device battery at the future user position. The mobile device battery is a battery that is provided in a mobile device that is charged using the mobile battery or batteries 100 possessed by the user. The information indicating the residual capacity of the mobile device battery at the future user position can be generated, based on the information indicating the current residual capacity of the mobile device battery, and the information indicating the future user position. The future user position can be predicted by the aforementioned future position prediction unit 414. The information indicating the current residual capacity of the mobile device battery can be acquired by the user terminal 200. The residual capacity of the mobile device battery at the future user position may be predicted by the user terminal 200 (the computation unit 210), or may be predicted by the management device 400 (the computation unit 404).

The information providing unit 216 of the user terminal 200 may carry out the function of providing the information to the user not only by using graphics, but also by using, for example, text displayed in a pop-up window that is displayed on the display unit 204. Similarly, the information providing unit 316 of the collection and delivery person terminal 300 may carry out the function of providing the information to the collection and delivery person not only by using graphics, but also by using, for example, text displayed in a pop-up window that is displayed on the display unit 304.

In the case that the user is moving, it can be difficult for the user to observe the display unit 204. For example, the user cannot observe the display unit 204 while driving a vehicle. In consideration of this feature, the information providing unit 216 of the user terminal 200 may provide to the user, by using voice, various information such as the collection and delivery person information and the like. For example, the information providing unit 216 may issue a notification to the user, by using voice, of the position of the collection and delivery person who is within the predetermined range from the user. In accordance with this feature, the user is capable of grasping the position of the collection and delivery person without observing the display unit 204. Whether or not the user is moving can be determined, based on changes in the user position, by the user terminal 200 (the computation unit 210) or the management device 400 (the computation unit 404). The user terminal 200 or the management device 400 may determine whether or not the user is moving, based on detection signals from a vibration sensor, an acceleration sensor, or the like that is appropriately provided in the user terminal 200.

In the case that the collection and delivery person is moving, it can be difficult for the collection and delivery person to observe the display unit 304. For example, the collection and delivery person cannot observe the display unit 304 while driving a vehicle. In consideration of this feature, the information providing unit 316 of the collection and delivery person terminal 300 may provide to the collection and delivery person, by using voice, various information such as the user information and the like. For example, the information providing unit 316 may issue a notification to the collection and delivery person, by using voice, of the position of the user who is within the predetermined range from the collection and delivery person. In accordance with this feature, the collection and delivery person is capable of grasping the position of the user without observing the display unit 304. Whether or not the collection and delivery person is moving can be determined, based on changes in the collection and delivery person position, by the collection and delivery person terminal 300 (the computation unit 310) or the management device 400 (the computation unit 404). The collection and delivery person terminal 300 or the management device 400 may determine whether or not the collection and delivery person is moving, based on detection signals from a vibration sensor, an acceleration sensor, or the like that is appropriately provided in the collection and delivery person terminal 300.

The suggestion unit 420 may suggest not only the meeting location where the user and the collection and delivery person are intended to meet, but also a merging and meeting time for the user and the collection and delivery person. For example, the suggestion unit 420, based on the user position information indicating the user position, and the information indicating the meeting location, estimates an expected travel time period until the user arrives at the meeting location. Further, the suggestion unit 420, based on the collection and delivery person position information indicating the collection and delivery person position, and the information indicating the meeting location, estimates an expected travel time period until the collection and delivery person arrives at the meeting location. The suggestion unit 420, based on the estimated travel time period until the user arrives at the meeting location, and the estimated travel time period until the collection and delivery person arrives at the meeting location, estimates a time when the user and the collection and delivery person are capable of merging and meeting together. The suggestion unit 420 can suggest to the user and the collection and delivery person the estimated time as the merging and meeting time. Information indicating the merging and meeting time suggested by the suggestion unit 420 is provided to the user by the information providing unit 216 of the user terminal 200. Further, the information indicating the merging and meeting time suggested by the suggestion unit 420 is provided to the collection and delivery person by the information providing unit 316 of the collection and delivery person terminal 300.

The inspection device 700 need not necessarily be provided in the charger 14. For example, the inspection device 700 may be a personal battery checker that is possessed by the collection and delivery person or the user. The inspection device 700 may be provided at the charging spot.

The status determination unit 428 may determine, based on the inspection result by the inspection device 700, whether or not the mobile battery or batteries 100 are reaching the usage restricted state. For example, as noted previously, by performing the inspection such as the capacity measurement, the resistance measurement, or the like, the degree of deterioration of the battery cells 102 of the mobile battery or batteries 100 can be detected. The information indicating the degree of deterioration can be included in the information indicating the inspection result by the inspection device 700. In the case that the degree of deterioration of the battery cells 102 of the mobile battery or batteries 100 reaches a predetermined degree of deterioration threshold value, the status determination unit 428 can determine that the mobile battery or batteries 100 are reaching the usage restricted state.

The replacement time estimation unit 432, based on the inspection result by the inspection device 700, may estimate the replacement time of the mobile battery or batteries 100. For example, as noted previously, the information indicating the degree of deterioration of the battery cells 102 of the mobile battery or batteries 100 can be included in the information indicating the inspection result by the inspection device 700. In this case, the replacement time estimation unit 432 can estimate, based on a difference between the degree of deterioration of the battery cells 102 of the mobile battery or batteries 100 and the predetermined degree of deterioration threshold value, the replacement time of the mobile battery or batteries 100.

Data concerning the usage history of the mobile battery or batteries 100 may be transmitted, via the network NW, from the communication unit 108 of the mobile battery or batteries 100 to the management device 400. In this case, the usage history information acquisition unit 426 may acquire as the usage history information at least a portion of the aforementioned data received by the management device 400.

There can be, respectively, a case in which the inventory deficient station determination unit 434 determines that an inventory deficient station does not exist, and cases in which the inventory surplus station determination unit 436 determines that an inventory surplus station does not exist. In this case, depending on the result of the determination made by each of the inventory deficient station determination unit 434 and the inventory surplus station determination unit 436, information concerning either one of the inventory deficient station or the inventory surplus station is provided to the collection and delivery person.

As noted previously, the battery station 12 can be equipped with constituent parts (supplies, consumable items) that can be used by the collection and delivery person. Constituent parts of this type may be provided in the mobile station 24. In accordance therewith, the convenience for the collection and delivery person as well as the user can be achieved by the mobile station 24.

The operating location notification unit 476 may issue an operating location notification not only to the communication terminal possessed by a staff member, but also to the communication device 30. The operating location information received by the communication device 30 can be displayed, for example, on a non-illustrated display device provided in the mobile station 24.

### Invention that can be Grasped from the Embodiment

A description will be given below concerning the inventions capable of being grasped from the above-described embodiment and the exemplary modifications.

<1> The management system (16) that manages the delivery of the mobile battery (100) configured to be shared by the plurality of users includes the management device (400), the mobile terminal (200) configured to communicate with the management device and be possessed by each of the users, and the terminal device (300) configured to communicate with the management device, and be possessed by the delivery person who carries out the delivery of the mobile battery, wherein the management system includes the position information acquisition unit (412) provided in the management device and configured to acquire the delivery person position information which is information indicating the delivery person position which is the position of the delivery person, the information generating unit (418) configured to generate, based on the user position which is the position of at least one of the users, and the delivery person position, the delivery person information, which is information concerning the delivery person who is capable of carrying out the delivery of the mobile battery to the one of the users, and the information providing unit (216) provided in the mobile terminal and configured to provide to the one of the users the delivery person information generated by the information generating unit.

<2> In the above-described management system (16), the delivery person information may be information concerning the delivery person who is positioned within the predetermined range from the user position and is capable of carrying out the delivery of the mobile battery.

<3> In the above-described management system (16), the information providing unit may further provide to the one of the users, the information indicating the residual capacity of the mobile battery possessed by the one of the users who is in possession of the mobile terminal.

<4> In the above-described management system (16), the information providing unit, based on the residual capacity of the mobile battery possessed by the one of the users, may provide to the one of the users the delivery person information.

<5> In the above-described management system (16), the information providing unit, in the case that the residual capacity of the mobile battery possessed by the one of the users has become less than or equal to the predetermined residual capacity threshold value, may provide to the one of the users the delivery person information.

<6> In the above-described management system (16), the information providing unit may further provide to the one of the users, the information indicating the number of the mobile batteries possessed by the delivery person.

<7> In the above-described management system (16), the information providing unit may further provide to the one of the users, the information indicating the residual capacity of the mobile battery possessed by the delivery person.

<8> In the above-described management system (16), there may further be provided the future position prediction unit (414) configured to predict the future position which is the user position in the future, wherein, based on the future position and the delivery person position, the information generating unit may generate the delivery person information.

<9> In the above-described management system (16), the information providing unit may further provide to the one of the users, the information indicating the residual capacity at the future position of the mobile battery possessed by the one of the users who is in possession of the mobile terminal.

<10> In the above-described management system (16), the information providing unit may further provide to the one of the users, based on the user position, the information concerning the charging spot at which the mobile battery is configured to be charged, the mobile battery being possessed by the one of the users who is in possession of the mobile terminal.

<11> In the above-described management system (16), the information providing unit may further provide to the one of the users, the required time period information indicating the time period required to charge the mobile battery in the case that the mobile battery possessed by the one of the users is charged at the charging spot.

<12> In the above-described management system (16), the position information acquisition unit may further acquire the information indicating the device position which is the position of the device to which the electrical power is configured to be supplied by the mobile battery, the mobile terminal may be possessed by the one of the users who is the management person who manages the device, the information generating unit, based on the device position and the delivery person position, may generate the information concerning the delivery person who is capable of carrying out the delivery of the mobile battery that is configured to supply the electrical power to the device, and the information providing unit may provide to the management person, the information concerning the delivery person who is capable of delivering the mobile battery that is configured to supply the electrical power to the device.

<13> In the above-described management system (16), the information concerning the delivery person who is capable of carrying out the delivery of the mobile battery that is configured to supply the electrical power to the device may be information concerning the delivery person who is positioned within the predetermined range from the device position, and capable of carrying out the delivery of the mobile battery.

<14> In the above-described management system (16), there may further be provided the battery information acquisition unit (416) configured to acquire the information indicating the residual capacity of the mobile battery that is configured to supply the electrical power to the device, wherein the information providing unit may further provide to the management person the information concerning the residual capacity of the mobile battery that is configured to supply the electrical power to the device.

<15> In the above-described management system (16), there may further be provided the suggestion unit (420) configured to suggest to the one of the users, based on the user position and the delivery person position, the delivery location for the mobile battery that is delivered by the delivery person.

<16> In the above-described management system (16), there may further be provided the future position prediction unit (414) configured to predict the future position which is the user position in the future, wherein the suggestion unit, based on the future position and the delivery person position, may suggest to the one of the users the delivery location of the mobile battery that is delivered by the delivery person.

<17> In the above-described management system (16), the suggestion unit may be configured to further suggest to the one of the users the time for reception of the mobile battery that is delivered by the delivery person.

<18> In the above-described management system (16), there may further be provided the suggestion unit (420) configured to suggest to the one of the users, based on the user position, the battery station (12) at which the mobile battery is configured to be received by the one of the users.

<19> In the above-described management system (16), there may further be provided the future position prediction unit (414) configured to predict the future position which is the user position in the future, wherein the suggestion unit, based on the future position, may suggest to the one of the users the battery station at which the mobile battery is configured to be received by the one of the users.

<20> In the above-described management system (16), the suggestion unit, based on the operating status of the battery station, may suggest to the one of the users the battery station at which the mobile battery is configured to be received by the one of the users.

<21> In the above-described management system (16), there may further be provided the suggestion unit (420) configured to suggest to the one of the users, based on the user position and the delivery person position, the facility (20) at which the mobile battery that is delivered by the delivery person is configured to be received by the one of the users.

<22> In the above-described management system (16), there may further be provided the future position prediction unit (414) configured to predict the future position which is the user position in the future, wherein the suggestion unit, based on the future position and the delivery person position, may suggest to the one of the users the facility at which the mobile battery that is delivered by the delivery person is configured to be received by the one of the users.

<23> In the above-described management system (16), the position information acquisition unit may further acquire the user position information which is the information indicating the user position, and the information generating unit may be provided in the management device, and generate the delivery person information based on the user position information and the delivery person position information.

<24> In the above-described management system (16), the information generating unit may be provided in the mobile terminal, and generate the delivery person information based on the user position and the delivery person position information supplied from the management device.

<25> The management device (400) configured to manage the delivery of the mobile battery (100) configured to be shared by the plurality of users, includes the position information acquisition unit (412) configured to acquire the user position information which is the information indicating the user position which is the position of at least one of the users, and the delivery person position information which is the information indicating the delivery person position which is the position of the delivery person who carries out the delivery of the mobile battery, the information generating unit (418) configured to generate, based on the user position information and the delivery person position information, the delivery person information, which is the information concerning the delivery person who is capable of carrying out the delivery of the mobile battery to the one of the users, and the communication unit (402) configured to communicate with the mobile terminal (200) possessed by each of the users, and communicate with the terminal device (300) possessed by the delivery person, wherein the communication unit transmits to the mobile terminal the delivery person information generated by the information generating unit.

<26> The management method of managing the delivery of the mobile battery (100) configured to be shared by the plurality of users, includes the step (S1) of acquiring the delivery person position information which is the information indicating the delivery person position which is the position of the delivery person who carries out the delivery of the mobile battery, the step (S3) of generating, based on the information indicating the user position which is the position of at least one of the users, and the delivery person position information, the delivery person information, which is the information concerning the delivery person who is capable of carrying out the delivery of the mobile battery to the one of the users, and the step (S5) of providing the delivery person information to the one of the users using the mobile terminal (200) possessed by the one of the users.

1. A management system that manages a delivery of a mobile battery configured to be shared by a plurality of users, comprising:
a management device;
a mobile terminal configured to communicate with the management device and be possessed by each of the users; and
a terminal device configured to communicate with the management device and be possessed by a delivery person who carries out the delivery of the mobile battery;
wherein the management device comprises one or more first processors that execute computer-executable instructions stored in a first memory;
the mobile terminal comprises one or more second processors that execute computer-executable instructions stored in a second memory;
the one or more first processors execute the computer-executable instructions stored in the first memory to cause the management device to:
acquire delivery person position information which is information indicating a delivery person position which is a position of the delivery person;
the one or more first processors execute the computer-executable instructions stored in the first memory to cause the management device to, or the one or more second processors execute the computer-executable instructions stored in the second memory to cause the mobile terminal to:
generate, based on a user position which is a position of at least one of the users, and the delivery person position, delivery person information, which is information concerning the delivery person who is capable of carrying out the delivery of the mobile battery to the one of the users; and
the one or more second processors execute the computer-executable instructions stored in the second memory to cause the mobile terminal to:
provide to the one of the users the delivery person information generated by the information generating unit.

2. The management system according to claim 1, wherein the delivery person information is information concerning the delivery person who is positioned within a predetermined range from the user position and is capable of carrying out the delivery of the mobile battery.

3. The management system according to claim 1, wherein the one or more first processors cause the management device to further provide to the one of the users, information indicating a residual capacity of the mobile battery possessed by the one of the users who is in possession of the mobile terminal.

4. The management system according to claim 1, wherein the one or more second processors cause the mobile terminal to, based on the residual capacity of the mobile battery possessed by the one of the users, provide to the one of the users the delivery person information.

5. The management system according to claim 4, wherein the one or more second processors cause the mobile terminal to, in a case that the residual capacity of the mobile battery possessed by the one of the users has become less than or equal to a predetermined residual capacity threshold value, provide to the one of the users the delivery person information.

6. The management system according to claim 1, wherein the one or more second processors cause the mobile terminal to further provide to the one of the users, information indicating a number of the mobile batteries possessed by the delivery person.

7. The management system according to claim 1, wherein the one or more second processors cause the mobile terminal to further provide to the one of the users, information indicating a residual capacity of the mobile battery possessed by the delivery person.

8. The management system according to claim 1,
wherein the one or more first processors cause the management device to predict a future position which is the user position in future;
wherein the one or more first processors cause the management device to, or the one or more second processors cause the mobile terminal to, based on the future position and the delivery person position, generate the delivery person information.

9. The management system according to claim 8, wherein the one or more second processors cause the mobile terminal to further provide to the one of the users, information indicating a residual capacity at the future position of the mobile battery possessed by the one of the users who is in possession of the mobile terminal.

10. The management system according to claim 1, wherein the one or more second processors cause the mobile terminal to further provide to the one of the users, based on the user position, information concerning a charging spot at which the mobile battery is configured to be charged, the mobile battery being possessed by the one of the users who is in possession of the mobile terminal.

11. The management system according to claim 10, wherein the one or more second processors cause the mobile terminal to further provide to the one of the users, required time period information indicating a time period required to charge the mobile battery in a case that the mobile battery possessed by the one of the users is charged at the charging spot.

12. The management system according to claim 1, wherein:
the one or more first processors cause the management device to further acquire information indicating a device position which is a position of device to which electrical power is configured to be supplied by the mobile battery;
the mobile terminal is possessed by the one of the users who is a management person who manages the device;
the one or more first processors cause the management device to, or the one or more second processors cause the mobile terminal to, based on the device position and the delivery person position, generate information concerning the delivery person who is capable of carrying out the delivery of the mobile battery that is configured to supply electrical power to the device;
the terminal device comprises one or more third processors that execute computer-executable instructions stored in a third memory; and
the one or more third processors execute the computer-executable instructions stored in the third memory to cause the terminal device to: provide to the management person, information concerning the delivery person who is capable of delivering the mobile battery that is configured to supply the electrical power to the device.

13. The management system according to claim 12, wherein the information concerning the delivery person who is capable of carrying out delivery of the mobile battery that is configured to supply the electrical power to the device is information concerning the delivery person who is positioned within a predetermined range from the device position, and capable of carrying out the delivery of the mobile battery.

14. The management system according to claim 12, wherein the one or more first processors cause the management device to:
to acquire information indicating a residual capacity of the mobile battery that is configured to supply the electrical power to the device;
wherein the one or more third processors cause the terminal device to: further provide to the management person information concerning the residual capacity of the mobile battery that is configured to supply the electrical power to the device.

15. The management system according to claim 1, wherein the one or more first processors cause the management device to suggest to the one of the users, based on the user position and the delivery person position, a delivery location for the mobile battery that is delivered by the delivery person.

16. The management system according to claim 15, wherein the one or more first processors cause the management device to predict a future position which is the user position in future; and
based on the future position and the delivery person position, suggest to the one of the users the delivery location of the mobile battery that is delivered by the delivery person.

17. The management system according to claim 15, wherein the one or more first processors cause the management device to further suggest to the one of the users a time for reception of the mobile battery that is delivered by the delivery person.

18. The management system according to claim 1, wherein the one or more first processors cause the management device to suggest to the one of the users, based on the user position, a battery station at which the mobile battery is configured to be received by the one of the users.

19. The management system according to claim 18,
wherein the one or more first processors cause the management device to predict a future position which is the user position in future; and
based on the future position, suggest to the one of the users the battery station at which the mobile battery is configured to be received by the one of the users.

20. The management system according to claim 18, wherein the one or more first processors cause the management device to, based on an operating status of the battery station, suggest to the one of the users the battery station at which the mobile battery is configured to be received by the one of the users.

21. The management system according to claim 1, wherein one or more first processors cause the management device to suggest to the one of the users, based on the user position and the delivery person position, a facility at which the mobile battery that is delivered by the delivery person is configured to be received by the one of the users.

22. The management system according to claim 21, wherein one or more first processors cause the management device to predict a future position which is the user position in future;
based on the future position and the delivery person position, suggest to the one of the users the facility at which the mobile battery that is delivered by the delivery person is configured to be received by the one of the users.

23. The management system according to claim 1, wherein the one or more first processors cause the management device to:
further acquire user position information which is information indicating the user position; and
generate the delivery person information based on the user position information and the delivery person position information.

24. The management system according to claim 1, wherein the one or more second processors cause the mobile terminal to generate the delivery person information based on the user position and the delivery person position information supplied from the management device.

25. A management device configured to manage a delivery of a mobile battery configured to be shared by a plurality of users, the management device comprising
one or more processors that execute computer-executable instructions stored in a memory, the one or more processors execute the computer-executable instructions stored in the memory to cause the management device to:
acquire user position information which is information indicating a user position which is a position of at least one of the users, and delivery person position information which is information indicating a delivery person position which is a position of a delivery person who carries out the delivery of the mobile battery; and
generate, based on the user position information and the delivery person position information, delivery person information, which is information concerning the delivery person who is capable of carrying out the delivery of the mobile battery to the one of the users;
wherein the management device further comprises a communication device configured to communicate with a mobile terminal possessed by each of the users, and communicate with a terminal device possessed by the delivery person; and
wherein the one or more processors cause the management device to, via the communication device, transmit to the mobile terminal the delivery person information.

26. A management method of managing a delivery of a mobile battery configured to be shared by a plurality of users, the management method comprising:
acquiring delivery person position information which is information indicating a delivery person position which is a position of a delivery person who carries out the delivery of the mobile battery;
generating, based on information indicating a user position which is a position of at least one of the users, and the delivery person position information, delivery person information, which is information concerning the delivery person who is capable of carrying out the delivery of the mobile battery to the one of the users; and
providing the delivery person information to the one of the users using a mobile terminal possessed by the one of the users.
